(19) United States
(12) Patent Application Publication
(10) Pub. No.: US 2009/0102296 A1
(43) Pub. Date: Apr. 23, 2009

(54) Powering cell phones and similar devices using RF energy harvesting

(75) Inventors: Charles E. Greene, Cabot, PA (US); Daniel W. Harrist, Carnegie, PA (US); Michael Thomas McElhinny, Port Vue, PA (US)

Correspondence Address: Ansel M. Schwartz;Attorney at Law, Suite 304, 201 N. Craig Street, Pittsburgh, PA, 15213, US

(73) Assignee: Powercast Corporation

(21) Appl. No.: 12/005,696

(22) Filed: Dec. 28, 2007

Related U.S. Application Data
(60) Provisional application No. 60/878,816, filed on Jan. 5, 2007.

(51) Int. Cl. H02J 17/00

(52) U.S. Cl. 307/149

(57) ABSTRACT

A device for receiving wireless power includes a point of reception, wherein the point of reception is positionable in at least a first position and a second position. A method for receiving wireless power. The method includes the steps of positioning a point of reception in contact with a housing to a first position. There is the step of receiving wireless power at the point of reception and providing it to a power harvester in the housing. There is the step of converting the wireless power to usable DC with the power harvester. There is the step of providing the usable DC to core components in the housing. There is the step of using the DC by the core components. There is the step of repositioning the point of reception to a second position. There is the step of receiving wireless power at the point of reception at the second position and providing it to the power harvester. There is the step of converting the wireless power received by the point of reception in the second position to usable DC with the power harvester. There is the step of providing the usable DC to the core components in the housing. There is the step of using the DC by the core components.

### FIELD OF THE INVENTION

The present invention is related to the wireless powering of devices. More specifically, the present invention is related to the wireless powering of devices, namely cell phones and the like, with a power harvester.

### BACKGROUND OF THE INVENTION

As processor capabilities have expanded and power requirements have decreased there has been an ongoing explosion of devices that operate completely independent of wires or power cords. These “untethered” devices range from cell phones, and wireless keyboards to building sensors and active RFID tags.

Engineers and designers of these untethered devices continue to have to deal with the limitations of portable power sources, primarily batteries as the key design parameter. While performance of processors and portable devices have been doubling every 18-24 months driven by Moore's law, battery technology in terms of capacity has only been growing at measly 6% per year. Even with power conscious designs and the latest in battery technology, many devices do not provide the lifetime cost and maintenance requirements for applications that require a large number of untethered devices such as logistics, and building automation. Today's devices that need two-way communication require scheduled maintenance every three to 18 months to replace or recharge the device's power source (typically a battery). One-way devices simply broadcasting their status (one-way) such as automated utility meter readers have a better battery life, typically requiring replacement within 10 years. For both device types, scheduled power-source maintenance is costly and disruptive to the entire system that a device is intended to monitor and/or control. Unscheduled maintenance trips are even more costly and disruptive. On a macro level, the relatively high cost associated with the internal battery also reduces the practical, or economically viable, number of devices that can be deployed.

The ideal solution to the power problem for untethered devices is a device or system that can collect and harness sufficient energy from the external environment. The harnessed energy would then either directly power an untethered device or augment a battery or other storage component. Directly powering an untethered device enables the device to be constructed without the need for a battery. Augmenting a storage component could be along two lines: 1) increasing the overall life of the device or 2) by providing more power to the device to increase the functionality of the device. The other parameters for an ideal solution is that the harnessing device could be used in a wide range of environments including harsh and sealed environments (e.g. nuclear reactors), would be inexpensive to produce, would be safe for humans, and would have a minimal effect on the basic size, weight and other physical characteristics of the untethered device.

### BRIEF SUMMARY OF THE INVENTION

The present invention pertains to a device for receiving wireless power. The device comprises a point of reception, wherein the point of reception is positionable in at least a first position and a second position.

The present invention pertains to a method for receiving wireless power. The method comprises the steps of positioning a point of reception in contact with a housing to a first position. There is the step of receiving wireless power at the point of reception and providing it to a power harvester in the housing. There is the step of converting the wireless power to usable DC with the power harvester. There is the step of providing the usable DC to the core components in the housing. There is the step of using the DC by the core components. There is the step of repositioning the point of reception to a second position. There is the step of receiving wireless power at the point of reception at the second position and providing it to the power harvester. There is the step of converting the wireless power received by the point of reception in the second position to usable DC with the power harvester. There is the step of providing the usable DC to the core component in the housing. There is the step of using the DC by the core components.

The present invention pertains to an apparatus for an application. The apparatus comprises a core device preferably having an integrated circuit for the application. The apparatus comprises a power harvester connected to the core device to power the core device.

The present invention pertains to an apparatus for an application. The apparatus comprises a core device having an integrated circuit for the application. The apparatus comprises means for receiving energy wirelessly and providing power from the energy to the core device to power the integrated circuit of the core device. The receiving means is connected to the core device.

The present invention pertains to a method for an application. The method comprises the steps of converting RF energy into usable energy. There is the step of preferably powering an integrated circuit of the core device with the usable energy.

This invention pertains to a technique that uses radio frequency (RF) energy as a source of energy to directly power or augment a power storage component in an untethered device. The present invention meets the requirements described in the previous “Background of the Invention” section.

Traditional RF receiving devices have focused on maximizing selectivity of the frequency to isolate and to be coherent without interference from other sources. In contrast, while this methodology operates at a specific frequency or range of frequencies, the device accepts any interference to supplement the output power of the device. Also, the research related to power harvesting that uses RF energy as a source has primarily focused on devices in close proximity of the source. In most cases, prior research assumed a dedicated or directed source of RF to power the device.

It is an object of this invention to provide a method and apparatus to
1. remotely energize an untethered device without using direct wiring
2. power or augment the life of the power storage component so it matches the life of the device and, ultimately, powers the off-grid device with or without the use of batteries
3. allow untethered devices to be virtually maintenance free
4. provide augmentation for other energy harvesting technologies (solar, piezoelectric, etc.)
5. provide backup power to tethered devices

It is a further object of this invention to directly power or augment a power storage component in an untethered device in conjunction with other power harvesting technologies and storage elements.

With this method and apparatus a device's power storage components do not require replacement, thus enabling the device to be permanently placed off-grid, where it may be physically impractical, costly, or dangerous (due to a harsh environment) to provide maintenance.

For devices on-grid (tethered) or with reliable power sources, RF power harvesting can be used as a backup in case the primary power source is lost.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 is a block diagram of the RF Power Harvesting block used to directly supply power to the Core Device Components.

FIG. 2 is a block diagram of the RF Power Harvesting block in communication with a Power Regulation and/or Power Storage Circuit.

FIG. 3 is a block diagram of the RF Power Harvesting block in communication with a Power Regulation and/or Power Storage Circuit and used to supply power to the Core Device Components.

FIG. 4 is a block diagram of the RF Power Harvesting block in communication with a Power Regulation and/or Power Storage Circuit.

FIG. 5 is a block diagram of the RF Power Harvesting block in communication with a Power Regulation and/or Power Storage Circuit and used to supply power to the Core Device Components.

FIG. 6 is a block diagram of the RF Power Harvesting block in communication with a Power Regulation and/or Power Storage Circuit and the Power Storage block and used to supply power to the Core Device Components.

FIG. 7 is a block diagram of the RF Power Harvesting block in communication with a Power Regulation and/or Power Storage Circuit and the Power Storage block.

FIG. 8 is a block diagram of the RF Power Harvesting block in communication with the Power Storage block.

FIG. 9 is a block diagram of the RF Power Harvesting block in communication with the Power Storage block and used to supply power to the Core Device Components.

FIG. 10 is a block diagram of the RF Power Harvesting block in communication with a Power Regulation and/or Power Storage Circuit.

FIG. 11 is a block diagram of the RF Power Harvesting block in communication with a Power Regulation and/or Power Storage Circuit and used to supply power to the Core Device Components.

FIG. 12 is a block diagram of the RF Power Harvesting block in communication with a Power Regulation and/or Power Storage Circuit and Power Storage block.

FIG. 13 is a block diagram of the RF Power Harvesting block in communication with a Power Regulation and/or Power Storage Circuit.

FIG. 14 is a block diagram of the RF Power Harvesting block in communication with a Power Regulation and/or Power Storage Circuit and Power Storage block and used to supply power to the Core Device Components.

FIG. 15 is a block diagram of the RF Power Harvesting block in communication with a Power Regulation and/or Power Storage Circuit and Power Storage block and used to supply power to the Core Device Components.

FIG. 16 is a block diagram of the RF Power Harvesting block in communication with a Power Regulation and/or Power Storage Circuit and used to supply power to the Core Device Components.

FIG. 17 is a block diagram of the RF Power Harvesting block in communication with a Power Regulation and/or Power Storage Circuit and Power Storage block.

FIG. 18 is a block diagram of the RF Power Harvesting block supplying power to the Power Storage Charger.

FIG. 19 is a block diagram of the RF Power Harvesting block supplying power to the Power Storage Charger and the RF Power Harvesting block in communication with the Power Storage block.

FIG. 20 is a block diagram of the RF Power Harvesting block supplying power to the Power Storage Charger and the Core Device Components.

FIG. 21 is a block diagram of the RF Power Harvesting block supplying power to the Power Storage Charger and the Core Device Components and the RF Power Harvesting block in communication with the Power Storage block.

FIG. 22 is a block diagram of the RF Power Harvesting block in communication with a Power Regulation and/or Power Storage Circuit.

FIG. 23 is a block diagram of the RF Power Harvesting block in communication with a Power Regulation and/or Power Storage Circuit.

FIG. 24 is a block diagram of the RF Power Harvesting block in communication with a Power Regulation and/or Power Storage Circuit and the Power Storage block.

FIG. 25 is a block diagram of the RF Power Harvesting block in communication with a Power Regulation and/or Power Storage Circuit and used to supply power to the Core Device Components.

FIG. 26 is a block diagram of the RF Power Harvesting block in communication with a Power Regulation and/or Power Storage Circuit.

FIG. 27 is a block diagram of the RF Power Harvesting block in communication with a Power Regulation and/or Power Storage Circuit and the Power Storage block.

FIG. 28 is a block diagram of the RF Power Harvesting block in communication with a Power Regulation and/or Power Storage Circuit and the RF Power Harvesting block supplying power to the Core Device Components.

FIG. 29 is a block diagram of the RF Power Harvesting block in communication with a Power Regulation and/or Power Storage Circuit.

FIG. 30 is a block diagram of the RF Power Harvesting block in communication with a Power Regulation and/or Power Storage Circuit and Power Storage block and used to supply power to the Core Device Components.

FIG. 31 is a block diagram of the RF Power Harvesting block in communication with a Power Regulation and/or Power Storage Circuit and the Power Storage block.

FIG. 32 is a block diagram of the RF Power Harvesting block in communication with a Power Regulation and/or Power Storage Circuit and used to supply power the Core Device Components.

FIG. 33 is a block diagram of the RF Power Harvesting block in communication with a Power Regulation and/or Power Storage Circuit and the Power Storage block and used to supply power to the Core Device Components.

FIG. 34 is a block diagram of the RF Power Harvesting block in communication with a Power Regulation and/or Power Storage Circuit and Power Storage block.

FIG. 35 is a block diagram of the RF Power Harvesting block in communication with a Power Regulation and/or Power Storage Circuit and used to supply power to the Core Device Components.

FIG. 36 is a block diagram of the RF Power Harvesting block in communication with a Power Regulation and/or Power Storage Circuit and the Power Storage block and used to supply power to the Core Device Components.

FIG. 37 is a block diagram of the RF Power Harvesting block in communication with a Power Regulation and/or Power Storage Circuit and Power Storage block and used to supply power to the Core Device Components.

FIG. 38 is a block diagram of the RF Power Harvesting block in communication with a Power Regulation and/or Power Storage Circuit and supplies power to the Power Storage Charger.

FIG. 39 is a block diagram of the RF Power Harvesting block in communication with a Power Regulation and/or Power Storage Circuit and supplies power to the Power Storage Charger.

FIG. 40 is a block diagram of the RF Power Harvesting block in communication with a Power Regulation and/or Power Storage Circuit and the Power Storage block and supplies power to the Power Storage Charger.

FIG. 41 is a block diagram of the RF Power Harvesting block in communication with a Power Regulation and/or Power Storage Circuit and used to supply power to the Core Device Components and supplies power to the Power Storage Charger.

FIG. 42 is a block diagram of the RF Power Harvesting block in communication with a Power Regulation and/or Power Storage Circuit and supplies power to the Power Storage Charger.

FIG. 43 is a block diagram of the RF Power Harvesting block in communication with a Power Regulation and/or Power Storage Circuit and the Power Storage block and supplies power to the Power Storage Charger.

FIG. 44 is a block diagram of the RF Power Harvesting block in communication with a Power Regulation and/or Power Storage Circuit and the RF Power Harvesting block supplying power to the Core Device Components and supplies power to the Power Storage Charger.

FIG. 45 is a block diagram of the RF Power Harvesting block in communication with a Power Regulation and/or Power Storage Circuit and supplies power to the Power Storage Charger.

FIG. 46 is a block diagram of the RF Power Harvesting block in communication with a Power Regulation and/or Power Storage Circuit and Power Storage block and used to supply power to the Core Device Components and supplies power to the Power Storage Charger.

FIG. 47 is a block diagram of the RF Power Harvesting block in communication with a Power Regulation and/or Power Storage Circuit and the Power Storage block and supplies power to the Power Storage Charger.

FIG. 48 is a block diagram of the RF Power Harvesting block in communication with a Power Regulation and/or Power Storage Circuit and used to supply power the Core Device Components and supplies power to the Power Storage Charger.

FIG. 49 is a block diagram of the RF Power Harvesting block in communication with a Power Regulation and/or Power Storage Circuit and the Power Storage block and used to supply power to the Core Device Components and supplies power to the Power Storage Charger.

FIG. 50 is a block diagram of the RF Power Harvesting block in communication with a Power Regulation and/or Power Storage Circuit and Power Storage block and supplies power to the Power Storage Charger.

FIG. 51 is a block diagram of the RF Power Harvesting block in communication with a Power Regulation and/or Power Storage Circuit and used to supply power to the Core Device Components and supplies power to the Power Storage Charger.

FIG. 52 is a block diagram of the RF Power Harvesting block in communication with a Power Regulation and/or Power Storage Circuit and the Power Storage block and used to supply power to the Core Device Components and supplies power to the Power Storage Charger.

FIG. 53 is a block diagram of the RF Power Harvesting block in communication with a Power Regulation and/or Power Storage Circuit and Power Storage block and used to supply power to the Core Device Components and supplies power to the Power Storage Charger.

FIG. 54 is a block diagram of the RF Power Harvesting block using Antenna A to directly supply power to the Core Device Components.

FIG. 55 is a block diagram of the RF Power Harvesting block using Antenna A to supply power to the Power Regulation, Storage and/or Storage Charging block.

FIG. 56 is a block diagram of the RF Power Harvesting block using Antenna A to supply power to the Power Regulation, Storage and/or Storage Charging block and used to supply power to the Core Device Components.

FIG. 57 is a block diagram of the RF Power Harvesting block used to directly supply power to the Core Device Components.

FIG. 58 is a block diagram of the RF Power Harvesting block used to supply power to the Power Regulation, Storage and/or Storage Charging block.

FIG. 59 is a block diagram of the RF Power Harvesting block used to supply power to the Power Regulation, Storage and/or Storage Charging block and used to supply power to the Core Device Components.

FIG. 60 is a block diagram of the RF Power Harvesting block used to directly supply power to the Core Device Components.

FIG. 61 is a block diagram of the RF Power Harvesting block used to directly supply power to the Core Device Components and in communication with the Alternative Power Sources block.

FIG. 62 is a block diagram of the RF Power Harvesting block in communication with the Alternative Power Sources block and used to directly supply power to the Core Device Components.

FIG. 63 is a block diagram of the RF Power Harvesting block in communication with the Alternative Power Sources block.

FIG. 64 is a block diagram of the RF Power Harvesting block in communication with the Power Regulation, Storage and/or Storage Charging block.

FIG. 65 is a block diagram of the RF Power Harvesting block in communication with the Power Regulation, Storage and/or Storage Charging block.

FIG. 66 is a block diagram of the RF Power Harvesting block in communication with the Power Regulation, Storage and/or Storage Charging block and the Alternative Power Sources block.

FIG. 67 is a block diagram of the RF Power Harvesting block in communication with the Power Regulation, Storage and/or Storage Charging block.

FIG. 68 is a block diagram of the RF Power Harvesting block in communication with the Power Regulation, Storage and/or Storage Charging block and the Alternative Power Sources block.

FIG. 69 is a block diagram of the RF Power Harvesting block in communication with the Alternative Power Sources block and Power Regulation, Storage and/or Storage Charging block.

FIG. 70 is a block diagram of the RF Power Harvesting block in communication with the Alternative Power Sources block and Power Regulation, Storage and/or Storage Charging block.

FIG. 71 is a block diagram of the Alternative Power Sources block.

FIG. 72 is a block diagram of the RF Power Harvesting block in communication with the Alternative Power Sources block.

FIG. 73 is a block diagram of the RF Power Harvesting block in communication with the Alternative Power Sources block.

FIG. 74 is a block diagram of the RF Power Harvesting block used to supply power to the Core Device Components.

FIG. 75 is a block diagram of the RF Power Harvesting block used to supply power to the Core Device Components.

FIG. 76 is a block diagram of the RF Power Harvesting block used to supply power to the Core Device Components and in communication with the Alternative Power Sources block.

FIG. 77 is a block diagram of the RF Power Harvesting block used to supply power to the Core Device Components.

FIG. 78 is a block diagram of the RF Power Harvesting block used to supply power to the Core Device Components and in communication with the Alternative Power Sources block.

FIG. 79 is a block diagram of the RF Power Harvesting block used to supply power to the Core Device Components and in communication with the Alternative Power Sources block.

FIG. 80 is a block diagram of the RF Power Harvesting block used to supply power to the Core Device Components and in communication with the Alternative Power Sources.

FIG. 81 is a block diagram of the RF Power Harvesting block used to supply power to the Core Device Components and in communication with the Power Regulation, Storage and/or Storage Charging block.

FIG. 82 is a block diagram of the RF Power Harvesting block used to supply power to the Core Device Components and in communication with the Power Regulation, Storage and/or Storage Charging block.

FIG. 83 is a block diagram of the RF Power Harvesting block used to supply power to the Core Device Components and in communication with the Power Regulation, Storage and/or Storage Charging block and the Alternative Power Sources block.

FIG. 84 is a block diagram of the RF Power Harvesting block used to supply power to the Core Device Components and in communication with the Power Regulation, Storage and/or Storage Charging block.

FIG. 85 is a block diagram of the RF Power Harvesting block used to supply power to the Core Device Components and in communication with the Power Regulation, Storage and/or Storage Charging block and the Alternative Power Sources block.

FIG. 86 is a block diagram of the RF Power Harvesting block used to supply power to the Core Device Components and in communication with the Alternative Power Sources block and Power Regulation, Storage and/or Storage Charging block.

FIG. 87 is a block diagram of the RF Power Harvesting block used to supply power to the Core Device Components and in communication with the Alternative Power Sources block and Power Regulation, Storage and/or Storage Charging block.

FIG. 88 is a block diagram of the entire power system for the device.

FIG. 89 is a block diagram of a power harvesting block used to supply power to a core device having a sensor.

FIG. 90 is a block diagram of a power harvesting block used to supply power to a core device having a computer peripheral.

FIG. 91(a) is a perspective view illustration of a first embodiment of a cell phone according to the present invention.

FIG. 91(b) is a side view illustration of the first embodiment of the cell phone.

FIG. 92 is a side view illustration of a second embodiment of a cell phone according to the present invention.

FIG. 93 is a perspective view illustration of a third embodiment of a cell phone according to the present invention.

FIG. 94(a) is a front view illustration of a fourth embodiment of a cell phone according to the present invention.

FIG. 94(b) is a side view illustration of the fourth embodiment of the cell phone.

FIG. 95(a) is a front view illustration of a fifth embodiment of a cell phone according to the present invention.

FIG. 95(b) is a side view illustration of the fifth embodiment of the cell phone.

FIG. 96 is an illustration of a sixth embodiment of a cell phone according to the present invention.

FIG. 97 is an illustration of a first embodiment hinge of a seventh embodiment of a cell phone according to the present invention.

FIGS. 98(a) and (b) are side view illustrations of a second embodiment hinge of a seventh embodiment of a cell phone according to the present invention.

FIG. 99 is an illustration of a third embodiment hinge of a seventh embodiment of a cell phone according to the present invention.

### DETAILED DESCRIPTION OF THE INVENTION

A complete understanding of the invention will be obtained from the following description when taken in connection with the accompanying drawing figures wherein like reference characters identify like parts throughout.

There is shown an apparatus 10 for an application. The apparatus 10 comprises a core device 22 preferably having an integrated circuit for the application. The apparatus 10 comprises a power harvester 20 connected to the core device 22 to power the core device 22.

The apparatus 10 preferably includes an alternative power source 24 connected to the core device 22 to power the core device 22 in conjunction with the power harvester 20. Preferably, the apparatus 10 includes a power regulator 26 and/or power storage circuit 28 connected to the power harvester 20. The apparatus 10 preferably includes a power storage charger 30 connected to the power harvester 20. Preferably, the apparatus 10 includes a power storage connected to the power harvester 20.

Preferably, the core device 22 includes a memory connected to the integrated circuit and to the power harvester 20 to power memory.

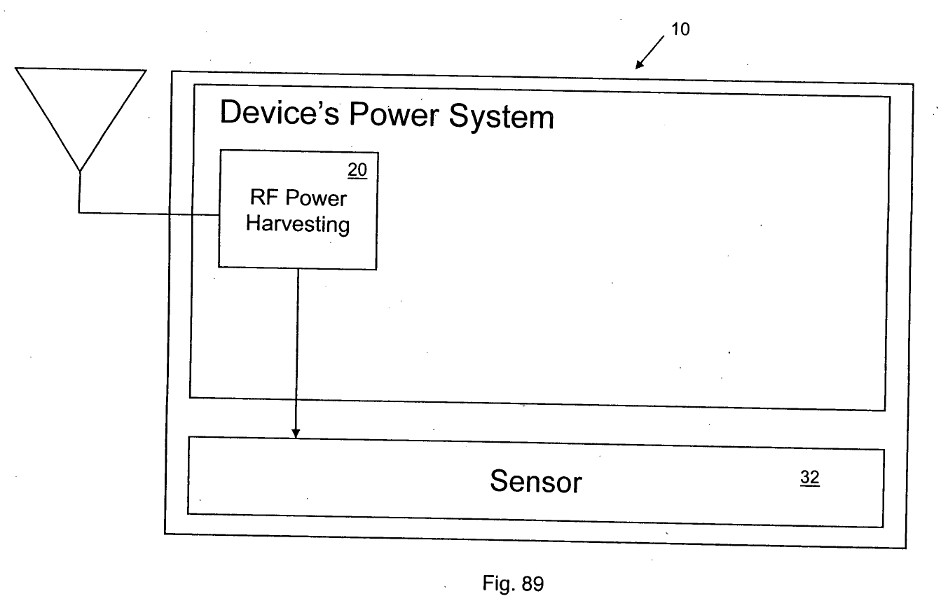

The core device 22 can include a sensor 32, as shown in FIG. 89. The sensor 32 can include a proximity sensor, an intrusion sensor, an environmental sensor, a chemical sensor, a biological sensor, a sensor in contact with an automobile, an occupancy sensor, a motion sensor, a position sensor, a metal detector, or a sensor 32 in contact with an aircraft. The sensor 32 can include an alarm connected with the power harvester 20 to power the alarm, a display connected with the power harvester 20 to power the display, a sensor 32 disposed in a building, an industrial automation sensor, a sensor 32 in contact with an elevator, a temperature sensor, a fire sensor, an accelerometer, or a level sensor.

The sensor 32 can include a gas level sensor, a fluid level sensor, a light level sensor, a flow sensor, or a gas flow sensor, a fluid flow sensor, a light flow sensor, or a plasma flow sensor.

The sensor 32 can include a pressure sensor, a gas pressure sensor or a fluid pressure sensor, a fluid pressure sensor, a light sensor, an infrared light sensor, an ultraviolet light sensor, an x-ray sensor, a cosmic ray sensor, a visible light sensor, or a gamma ray sensor, a stress sensor, a strain sensor, a depth sensor, or an electrical characteristic sensor.

The sensor 32 includes a voltage sensor, a current sensor, a viscosity sensor, an acoustical sensor, a sound sensor, a listening sensor, a thickness sensor, a density sensor, a surface quality sensor, a volume sensor, a physical sensor, a mass sensor, a weight sensor, a conductivity sensor, a distance sensor, an orientation sensor, or a vibration sensor.

The sensor 32 can include a radioactivity sensor, a field strength sensor, an electric field sensor or a magnetic field sensor, a smoke detector, a carbon monoxide detector, a radon detector, an air quality sensor, a humidity sensor, a glass breakage sensor, or a break beam detector. The sensor can include a thermal energy sensor, an electromagnetic sensor, a mechanical sensor, an optical sensor, a radiation sensor, a sensor in contact with a vehicle, or a water craft.

The present invention pertains to an apparatus 10 for an application. The apparatus 10 comprises a core device 22 having an integrated circuit for the application. The apparatus 10 comprises means for receiving energy wirelessly and providing power from the energy to the core device 22 to power the integrated circuit of the core device 22. The receiving means is connected to the core device 22. Preferably, the core device 22 includes means for sensing.

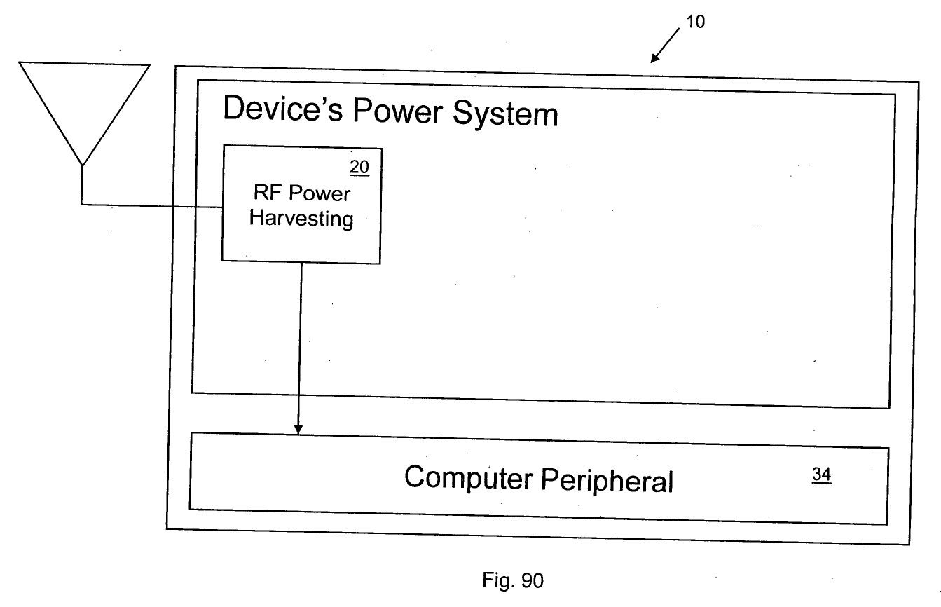

Alternatively, the core device 22 can include a computer peripheral 34, as shown in FIG. 90. The computer peripheral 34 can include a handheld game, a gaming system, a game controller, a controller, a keyboard, a mouse, a computer terminal, computer storage, or computer equipment.

The present invention pertains to a method for an application. The method comprises the steps of converting rf energy into usable energy. There is the step of preferably powering an integrated circuit of the core device 22 with the usable energy.

Preferably, there is the step of regulating the usable energy provided to the core device 22. There is preferably the step of storing the usable energy. Preferably, there is the step of providing power to the core device 22 from an alternative power source 24 in conjunction with the usable energy.

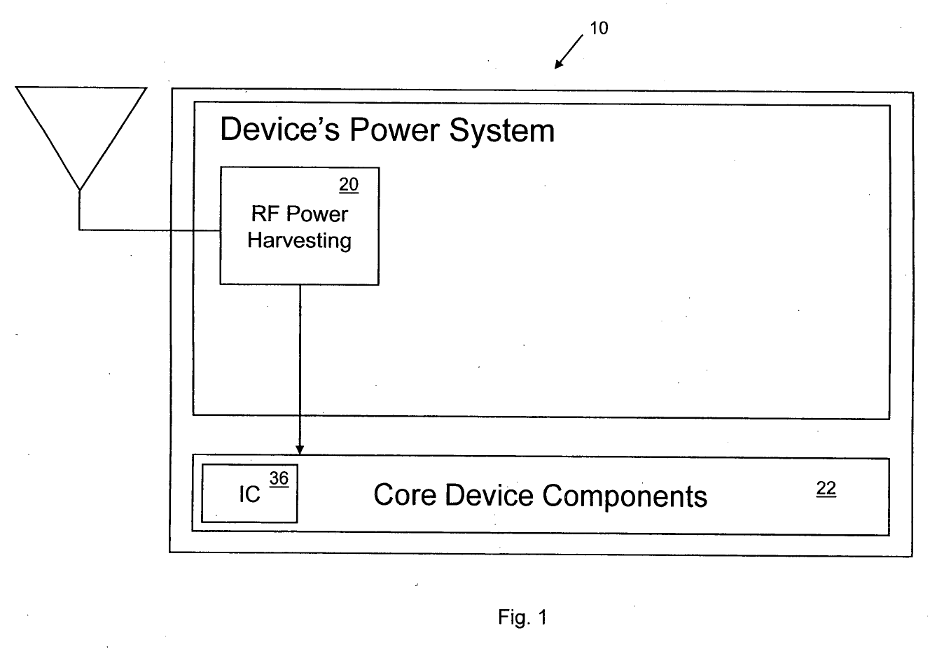

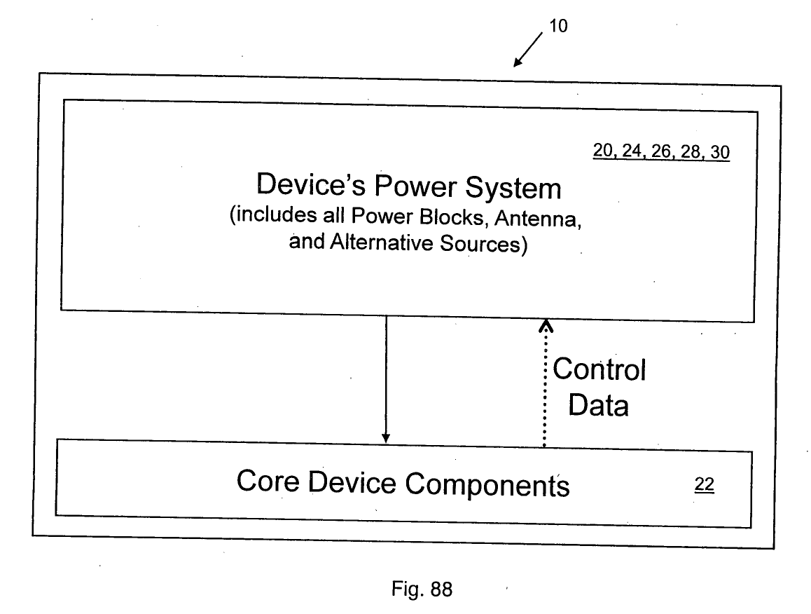

The present invention can be implemented in numerous ways. Most of these ways are depicted in FIGS. 1-88. These figures contain multiple blocks that are configured in multiple ways. In the figures, an arrow represents the flow of power unless otherwise stated. Single-headed (one-way) arrows represent that the power is flowing from one block to another. The single-headed arrow may represent multiple wires that provide power from one block to multiple parts in the other block. Two-headed (two-way) arrows represent a single wire that can have power flow in either direction or multiple wires each having power flow in a single direction. As an example, a two-headed arrow between the RF Power Harvesting block and the Power Regulation and/or Power Storage circuit 28 block can represent a single wire that allows harvested power to flow into a storage device such as a capacitor. The same block diagram can also represent two wires between the two blocks with the first wire allowing harvested power to flow into a voltage regulator 26. The second wire can allow the regulated voltage to feedback to the RF Power Harvesting block to provide power to internal components such as transistors to increase the performance of the RF Power Harvesting block. Each block is described in detail below. Each block represents the functionality described below associated with it. For instance, the RF power harvesting block describes a power harvester 20, and the power regulation block describes a power regulator 26.

RF Power Harvesting Block

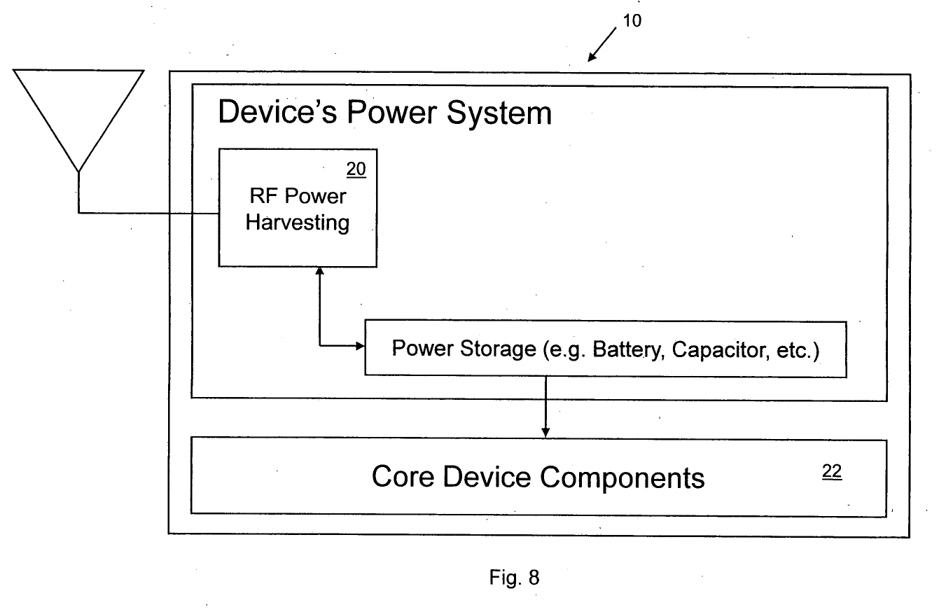

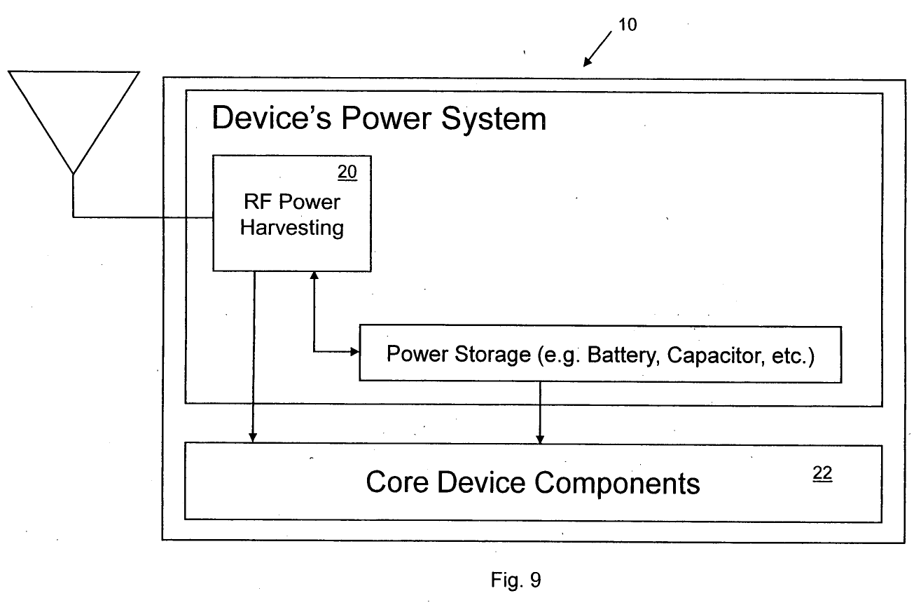

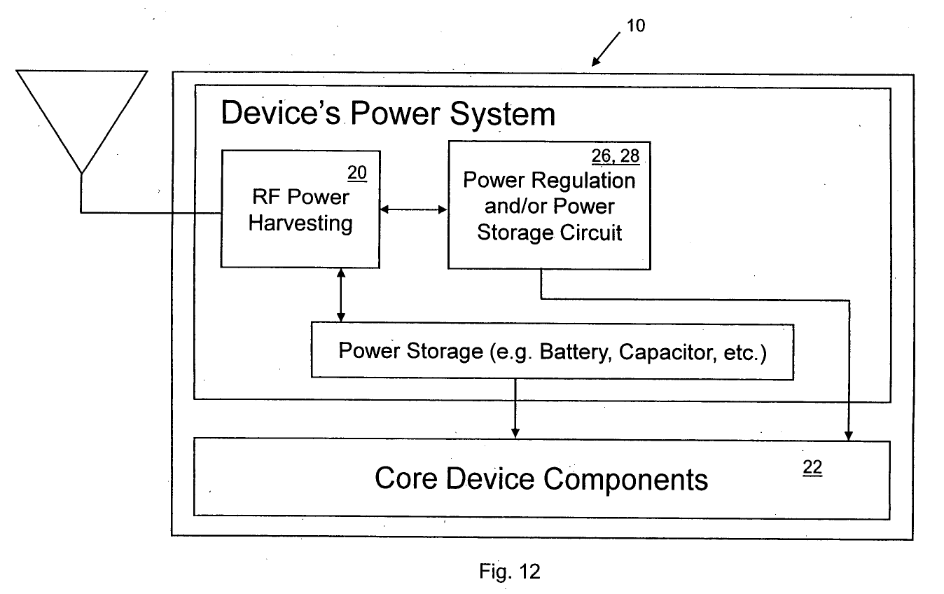

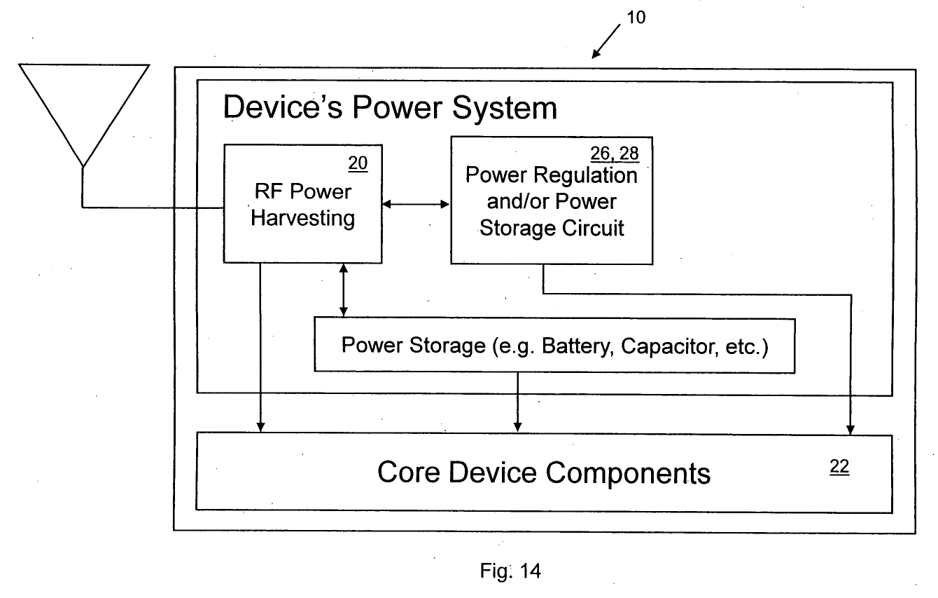

The RF Power Harvesting Block is used to convert the energy captured by the antenna into usable power such as DC voltage. This block may include antenna matching, rectifying circuitry, voltage transforming circuitry, and/or other performance optimizing circuitry. The rectifying circuitry may include a diode(s), a transistor(s), or some other rectifying device or combination. Examples of the rectifying circuitry include but are not limited to half-wave, full-wave, and voltage doubling circuits. The RF power harvesting block is connected to an antenna that may or may not be used as the communications antenna for the core device 22 components. The output of the RF Power Harvesting Block is a DC voltage or current. The RF Power Harvesting Block may accept feedback (or input) from other circuitry or blocks, which may be used to control the harvesting circuitry to improve the performance or vary the output. This feedback may include but is not limited to a DC voltage or a clock from the Core device 22 Components. U.S. Pat. No. 6,615,074 (FIGS. 8, 9, 12a, 12b, 13, 14), incorporated by reference, herein, shows numerous examples of RF power harvesting circuits that can be used to implement the block and function described.

Power Regulation and/or Power Storage Circuit 28 Block

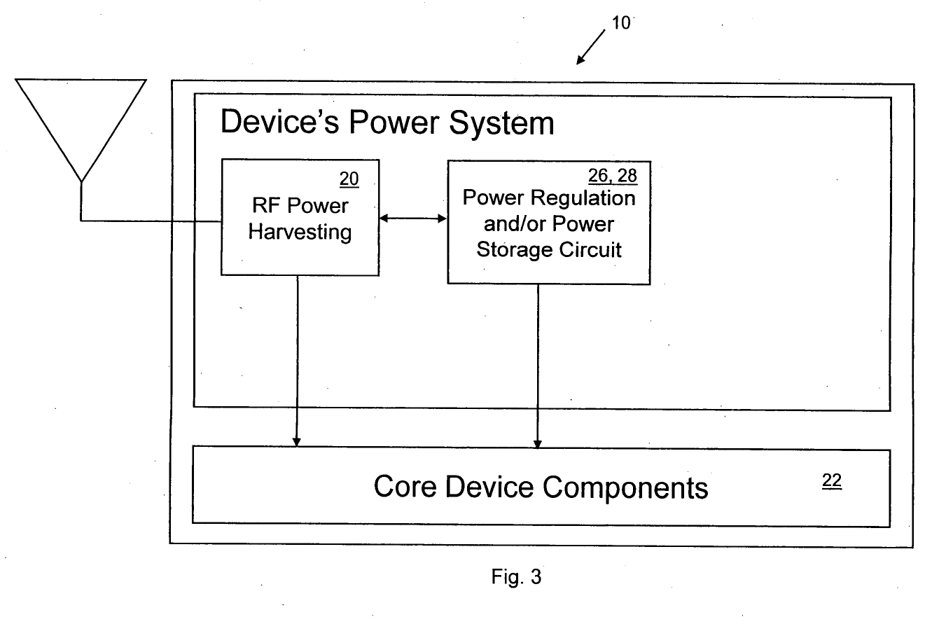

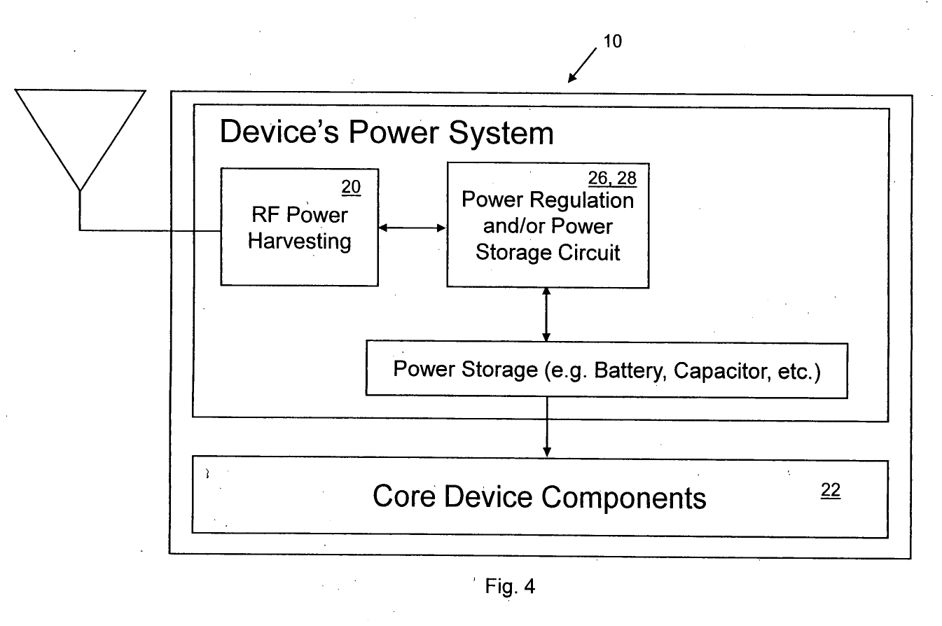

It may be necessary to regulate the converted power (hold the power at a constant level) for specific devices. The devices that would need this block require a fairly constant voltage or current. Deviations from the required values may cause the device to not perform within its specifications. The regulation can be implemented in many different ways. The block can be as simple as using a Zener diode, or as complicated as using an integrated circuit such as a linear voltage regulator 26 or switching regulator 26 to hold the voltage at a constant level. Certain devices have a more tolerable power requirement. For these devices, the regulation stage may be excluded. This block may also include, with or without the regulation, a storage device such as a capacitor, a battery, or some other device able to store charge. The output from the Power Regulation and/or Power Storage circuit 28 Block may be used as feedback to other blocks within the Device's Power System or to the Alternative power source 24 if they require a regulated supply voltage or stored power. U.S. Pat. No. 6,894,467 (FIGS. 1, 3), Linear Voltage Regulator, incorporated by reference, herein, is an example of a practical application of implementing the regulation described in the block. U.S. Pat. No. 6,297,618 (FIGS. 1-4), Power storage device and method of measuring voltage of storage battery, incorporated by reference, herein, is an example of a practical application of implementing the storage described in the block.

Power Storage Charger 30 Block

The Power Storage Charger 30 Block may be needed if the storage component requires a special charging mechanism such as pulse charging or trickle charging. This block controls how the captured and converted power is supplied to the storage device. U.S. Pat. No. 6,836,095 (FIGS. 1-3), Battery Charging Method and Apparatus, incorporated by reference herein, is an example of a practical application of implementing the special charging mechanism described in the block.

Power Storage Block

If a device has intermittent power requirements, it may be necessary to store the captured power for use at a later time. The power can be stored in the Power Storage block, which could include a battery, a capacitor, and/or another type of power storage component. Storage components include but are not limited to batteries (rechargeable and non-rechargeable), capacitors, inductors, fuel cells, and other storage elements. The output from the Power Storage Block may be used as feedback to other blocks within the Device's Power System or to the Alternative power source 24 if they require a dedicated and predictable supply voltage. U.S. Pat. No. 6,297,618 (FIGS. 1-4), Power Storage Device and Method of Measuring Voltage of Storage Battery, incorporated by reference herein, is an example of a practical application of implementing the storage described in the block. U.S. Pat. No. 6,835,501, Alkaline Rechargeable Battery, incorporated by reference herein, is also an example of a practical application of implementing the storage described in the block.

Core Device 22 Components Block

The Core Device 22 Components Block is the device that is receiving power from the system. This block may be but is not limited to the devices listed in the subsequent pages of this document. It may be advantageous for the Core Device 22 Components to communicate with any of the blocks that are supplying power to it. This communication can include but is not limited to a feedback control signal such as a clock or an ON/OFF command. As an example, the device may want to turn off the Alternative Power Sources 24 block if it is receiving sufficient power from the RF Power Harvesting block.

Alternative Power Sources 24 Block

RF energy harvesting also has the ability to be augmented by other types of power harvesting, storage components, or dedicated sources (e.g. power line). The Alternative Power Sources 24 Block shows how this type of system could be implemented. The augmenting power harvesting technologies include but are not limited to solar, light (visible and non-visible), piezoelectric, vibration, acoustic, thermal, microgenerators, wind, and other environmental elements. This block can work independently or have communication with other blocks. U.S. Pat. No. 6,784,358, Solar Cell Structure Utilizing an Amorphous Silicon Discrete By-Pass Diode, incorporated by reference herein, is an example of a practical application of implementing an alternative power source 24 described by the block. U.S. Pat. No. 6,858,970, Multi-Frequency Piezoelectric Energy Harvester, incorporated by reference herein, is also an example of a practical application of implementing an alternative power source 24 described by the block.

Power Regulation, Storage and/or Storage Charging Block

The Power Regulation, Storage and/or Storage Charging block contains all the combinations of the Power Regulation and/or Power Storage circuit 28, Power Storage Charger 30, and Power Storage block. This block is used in the later figures to reduce the number of figures needed to show how the blocks can interconnect.

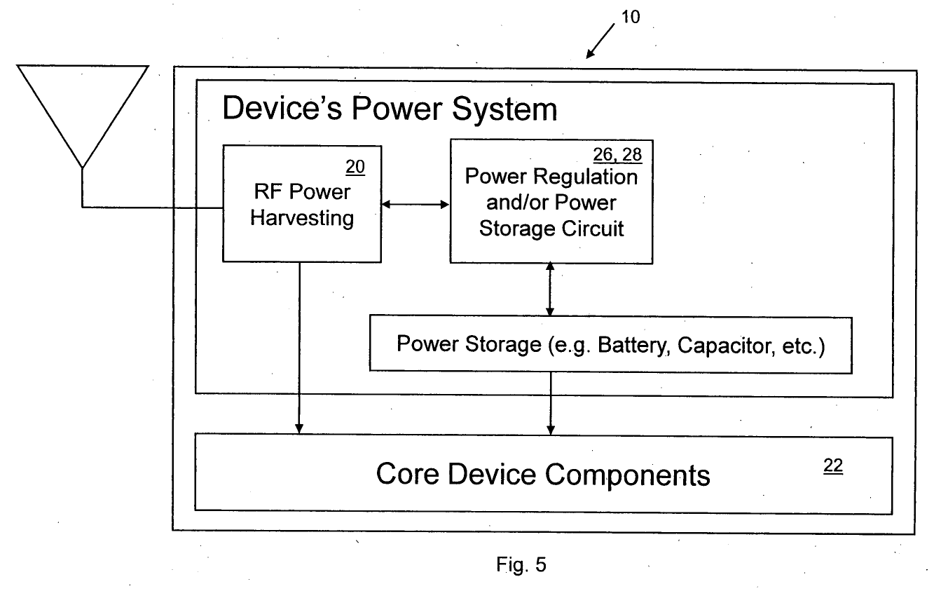

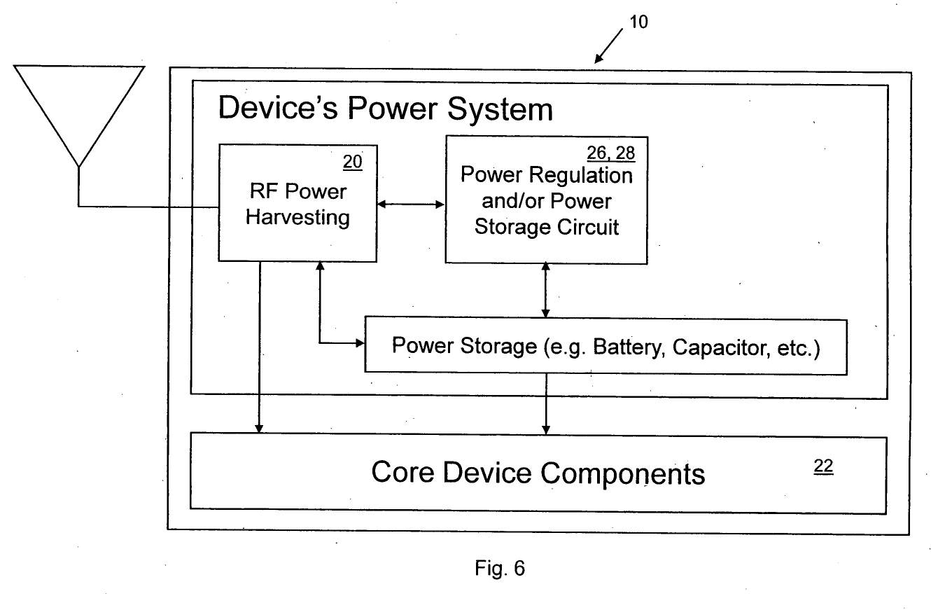

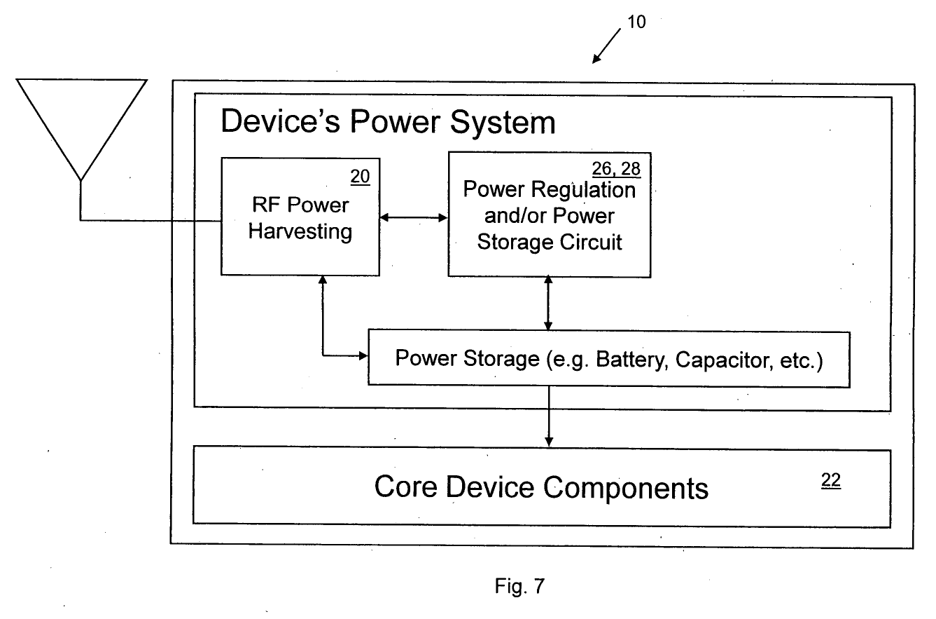

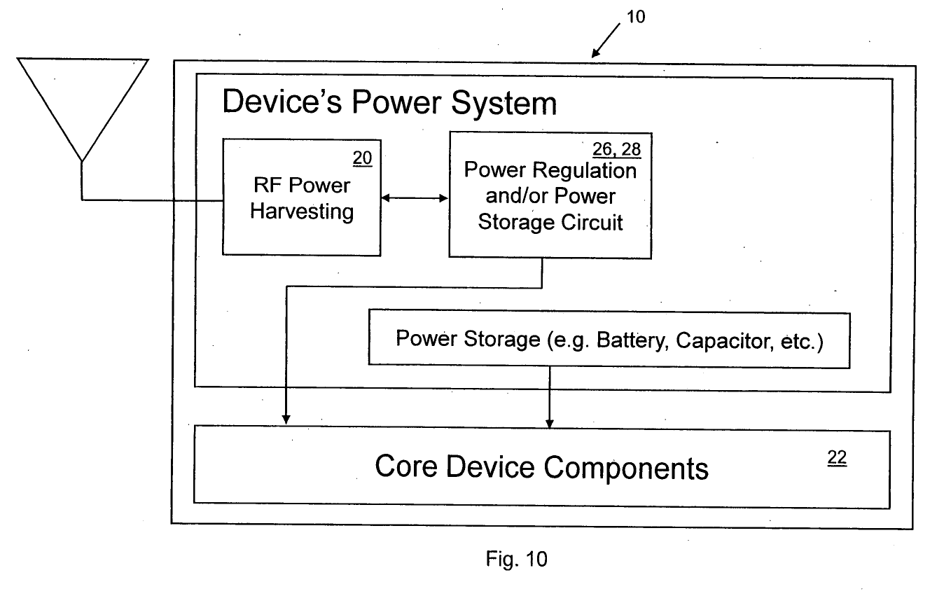

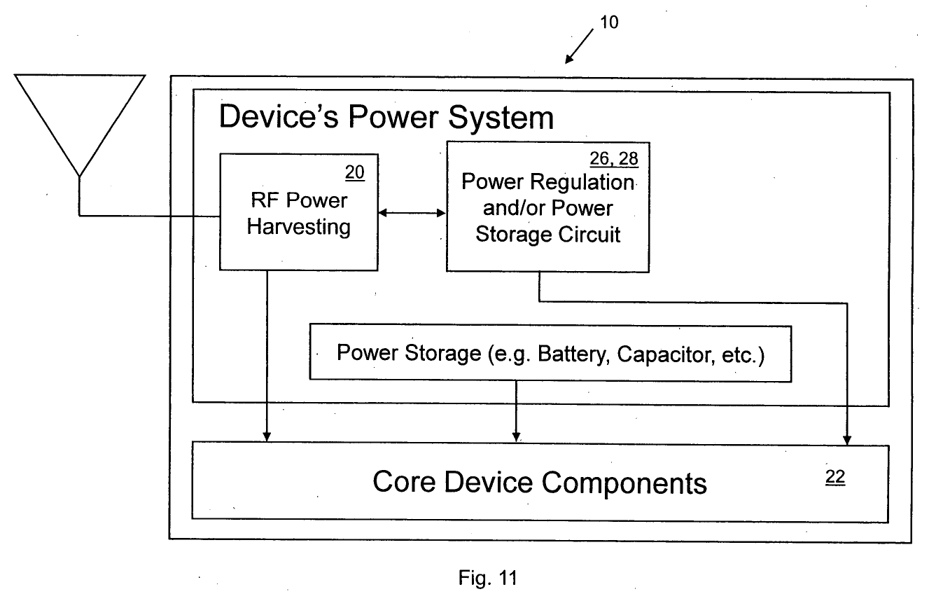

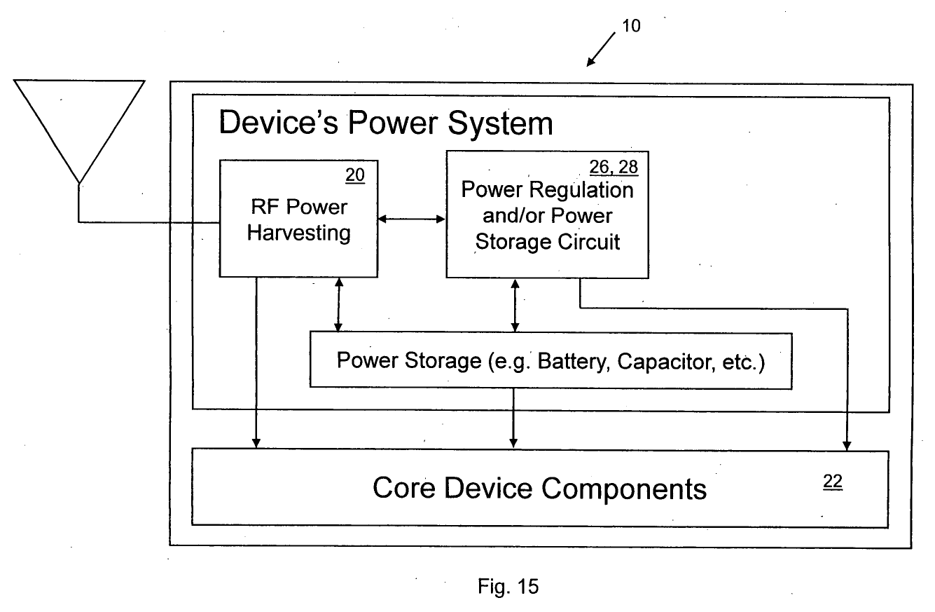

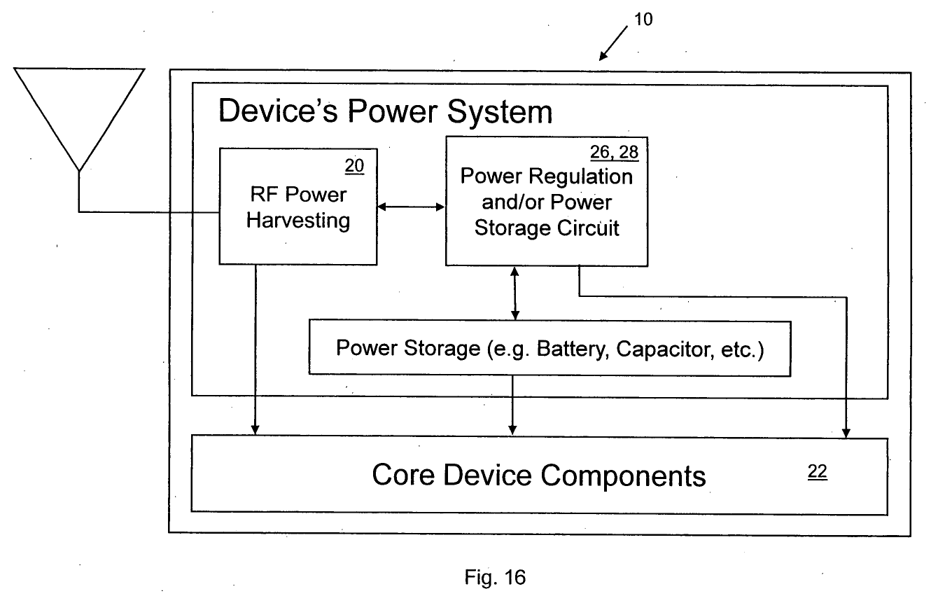

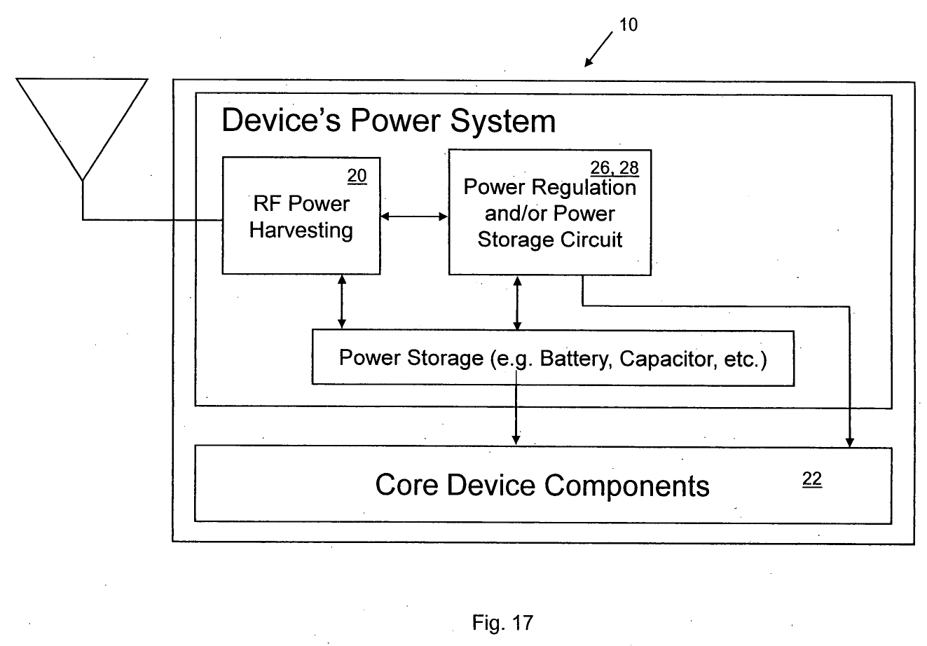

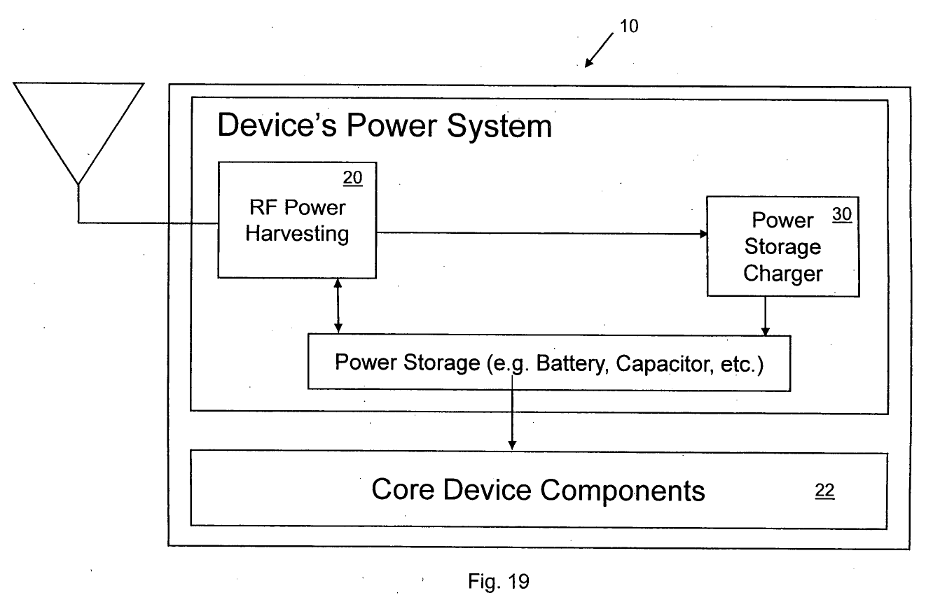

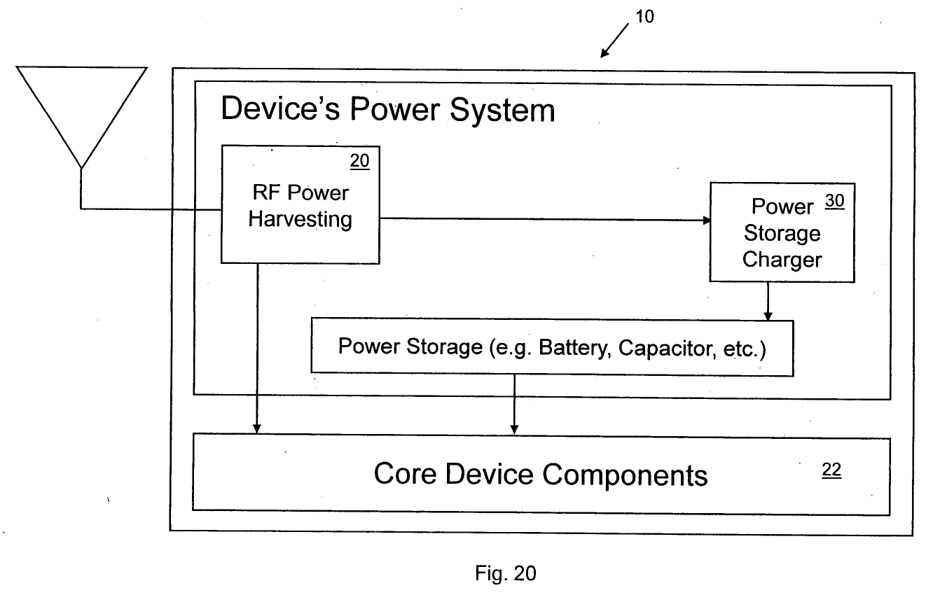

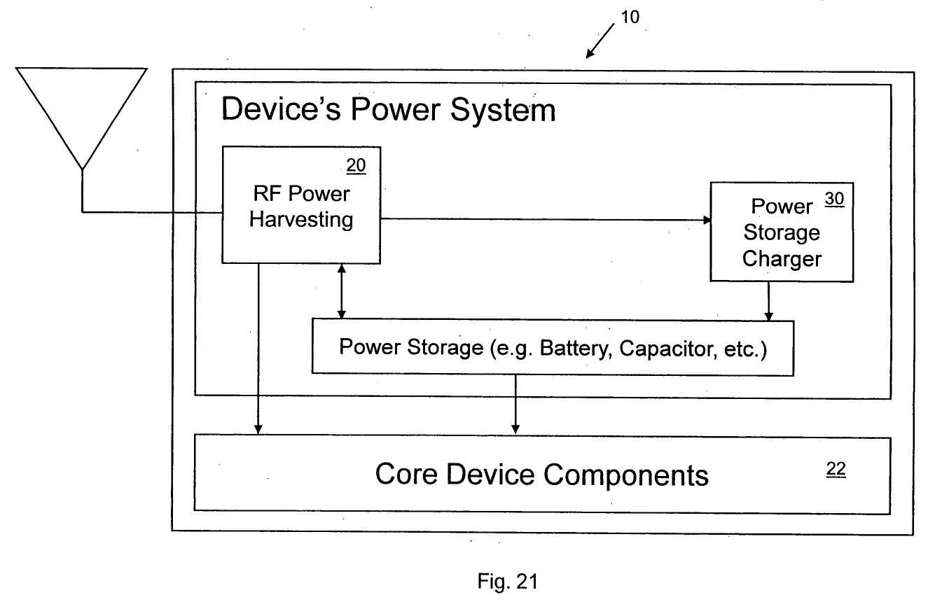

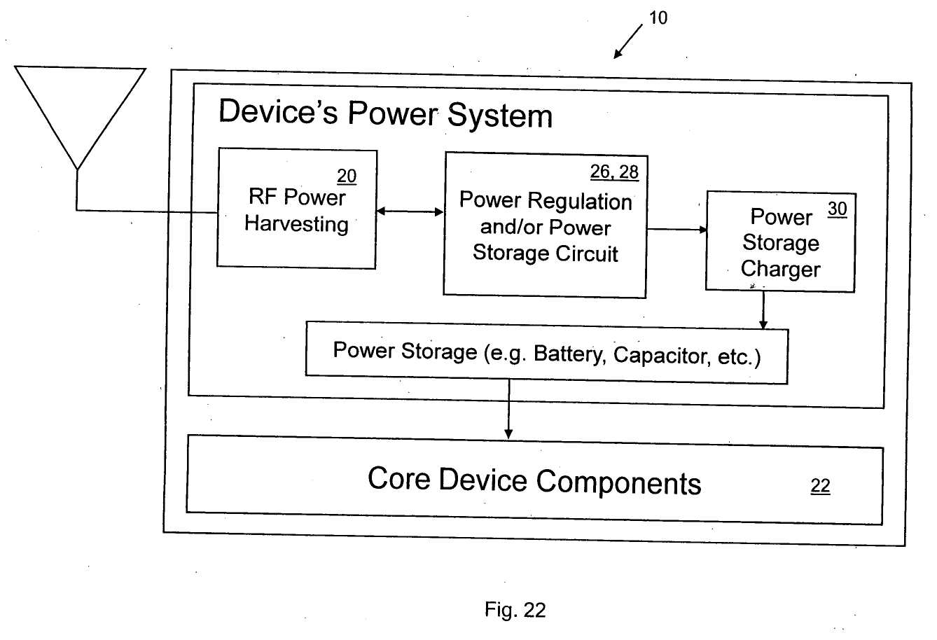

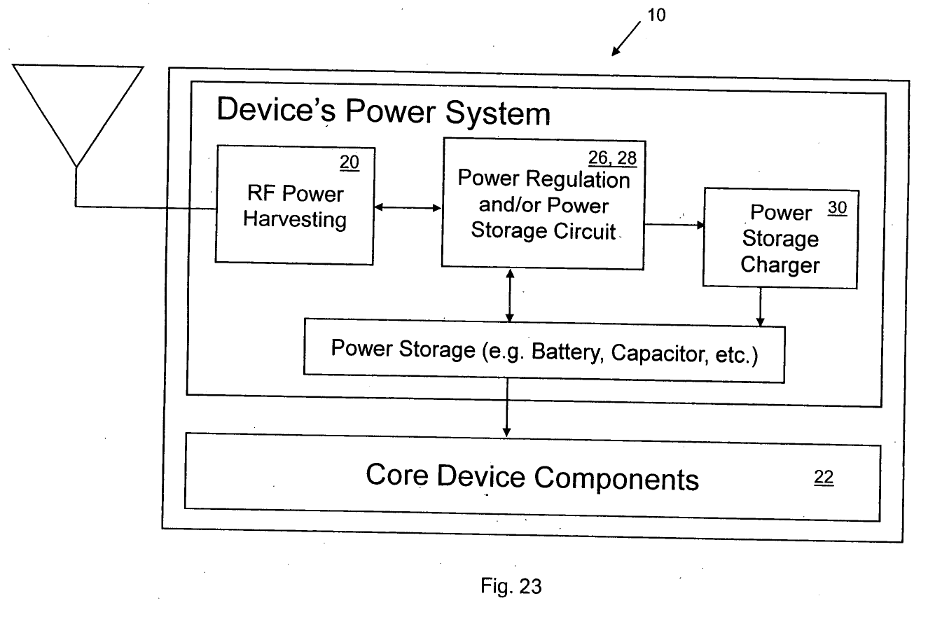

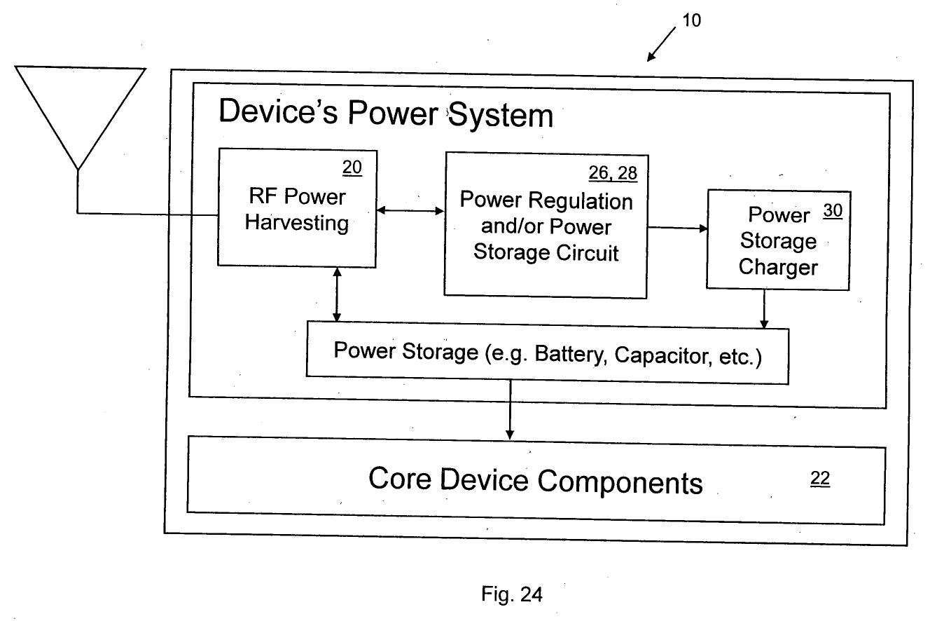

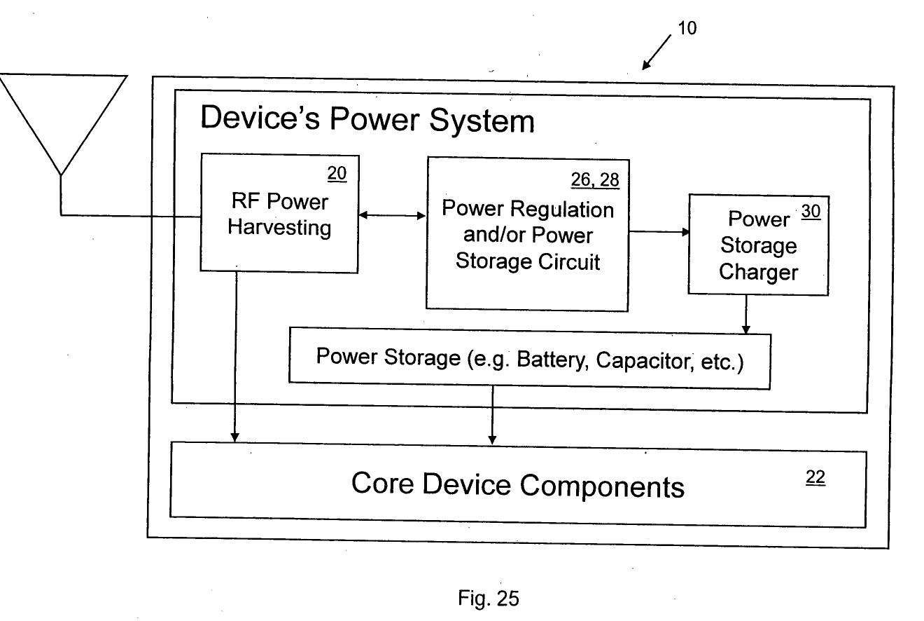

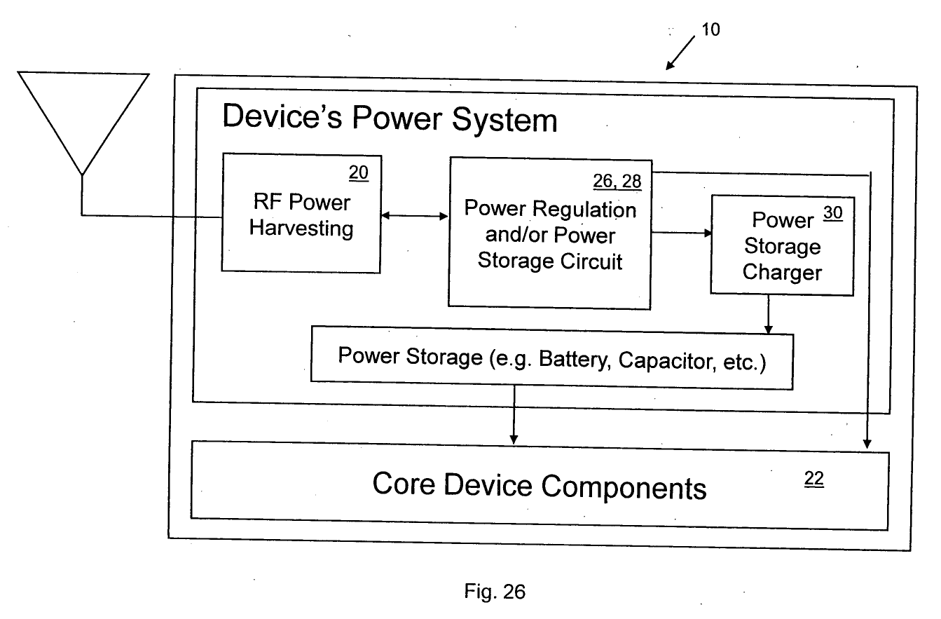

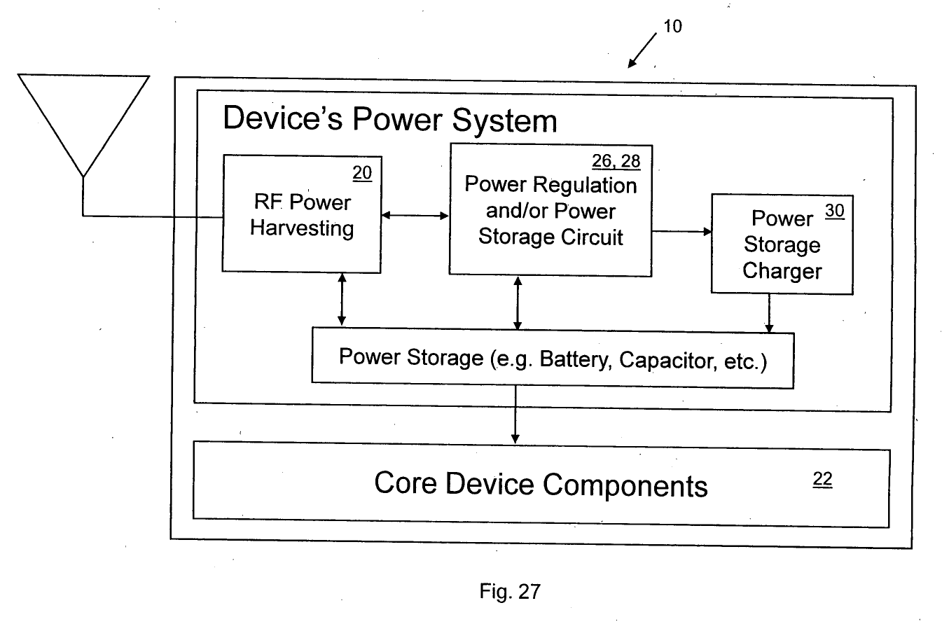

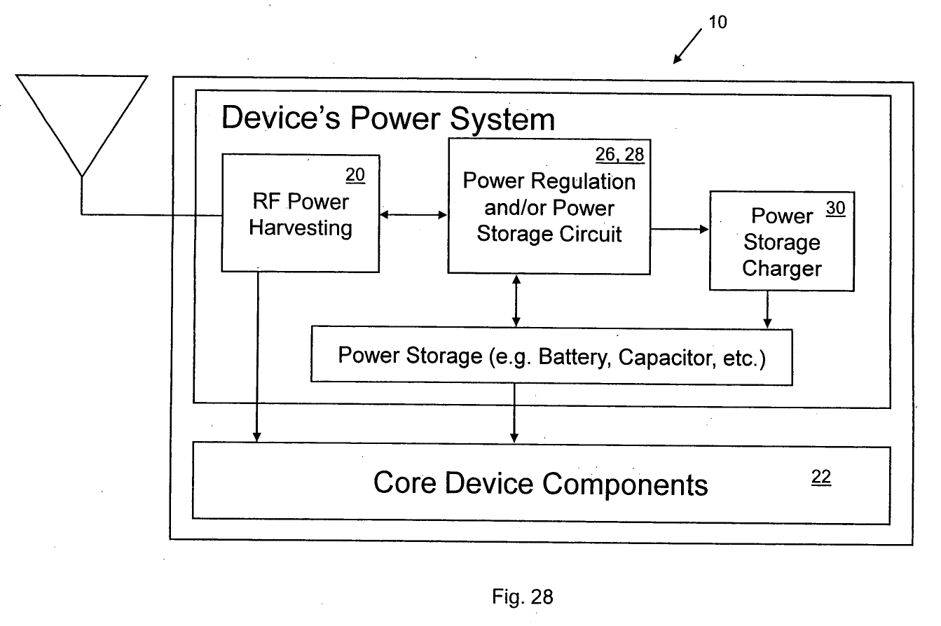

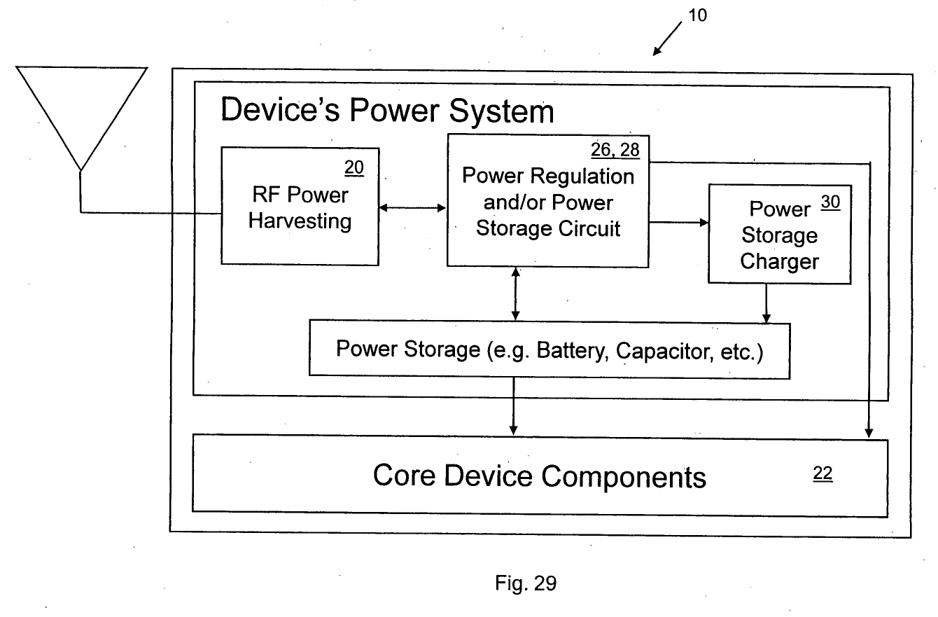

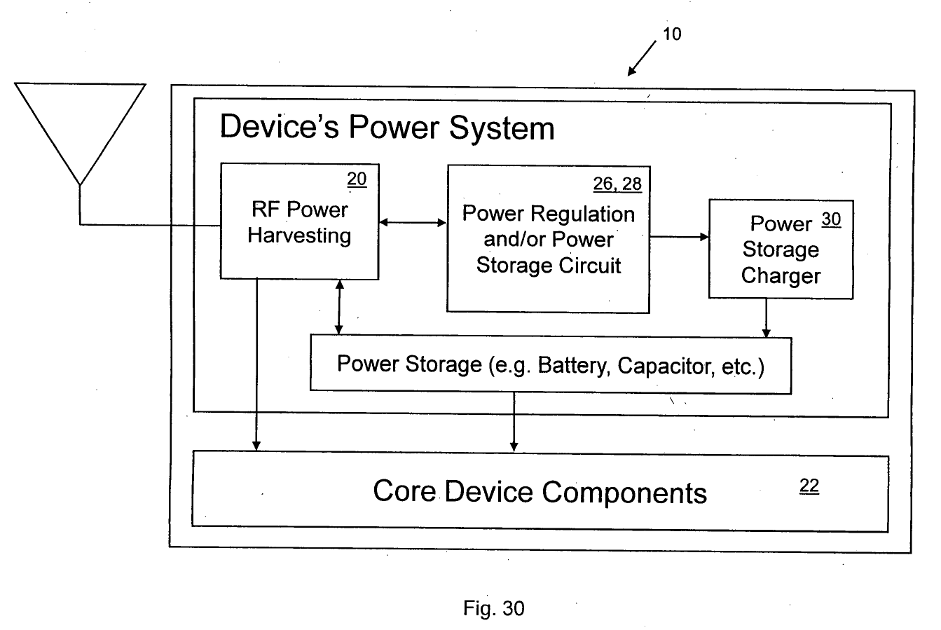

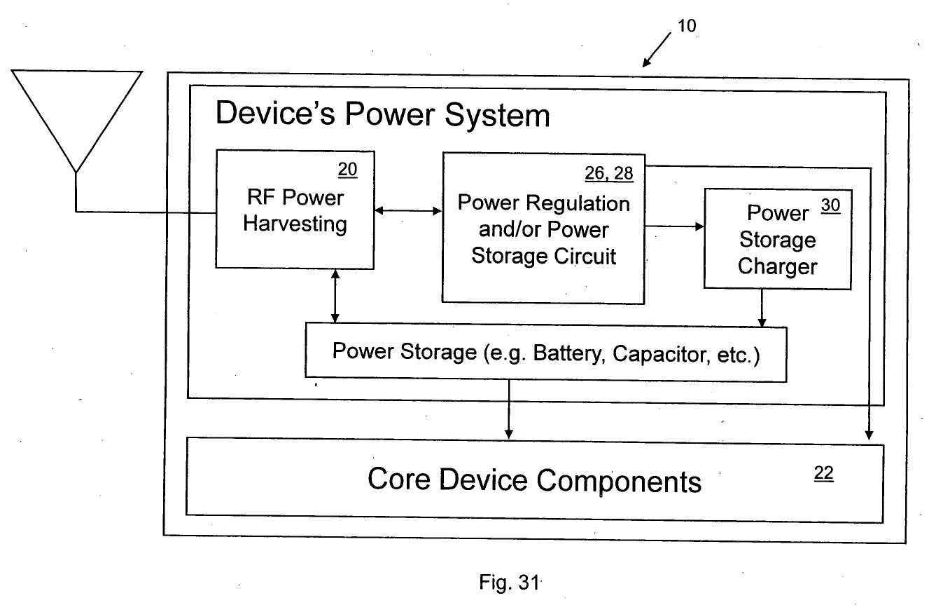

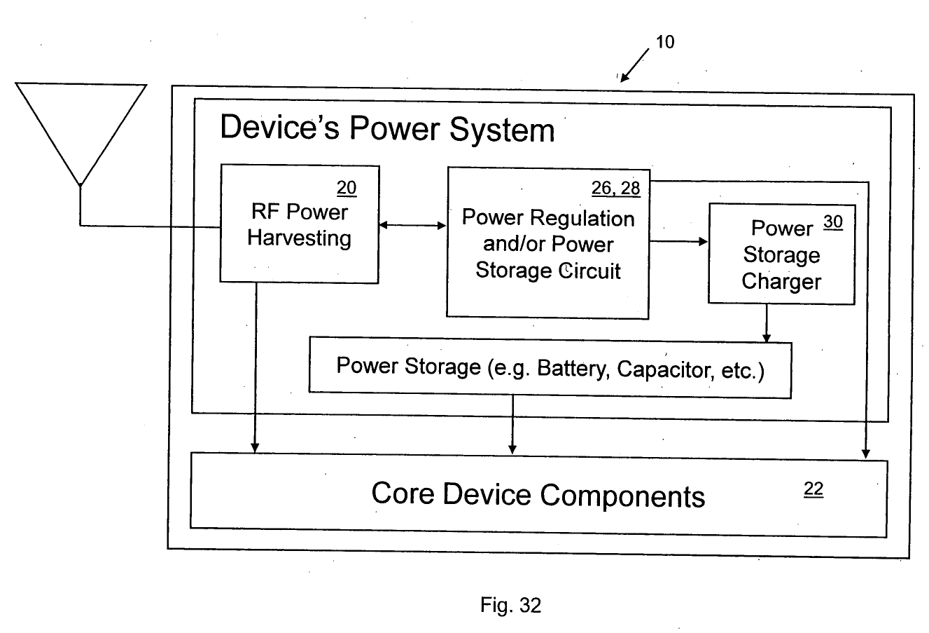

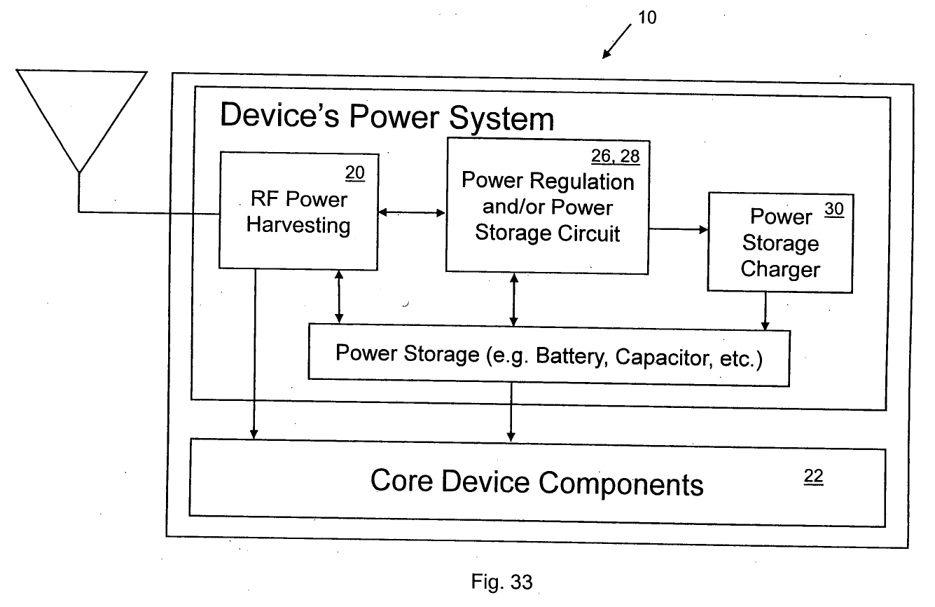

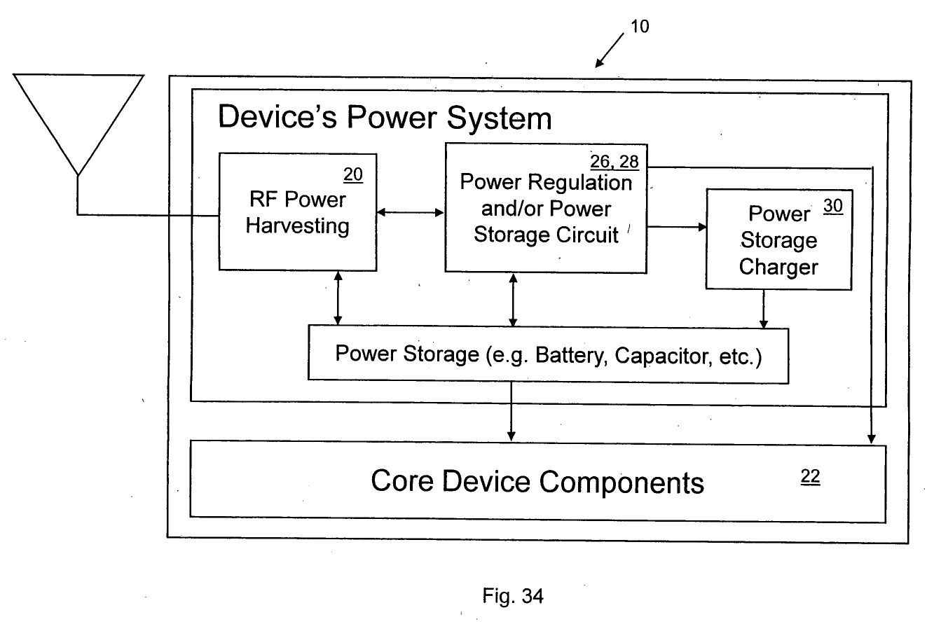

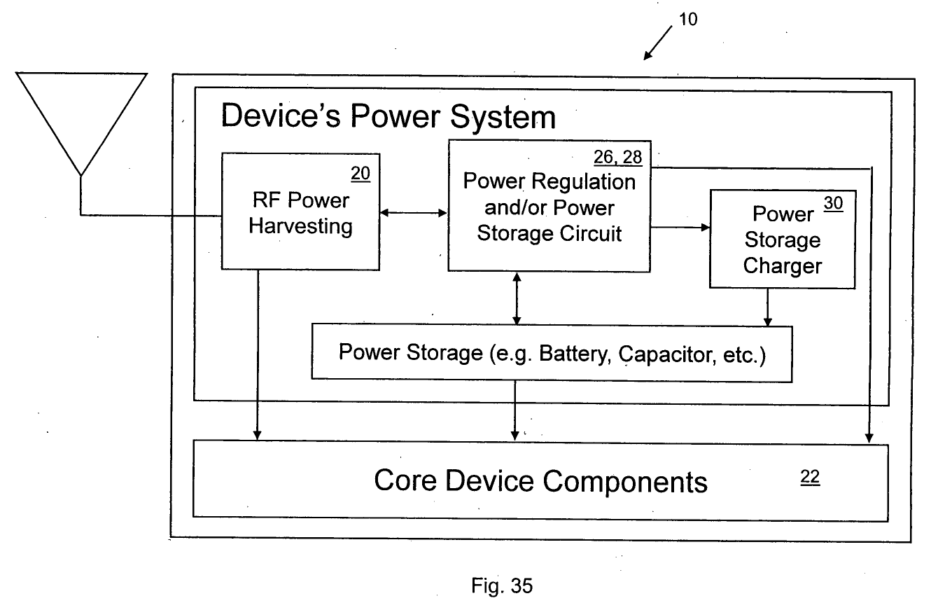

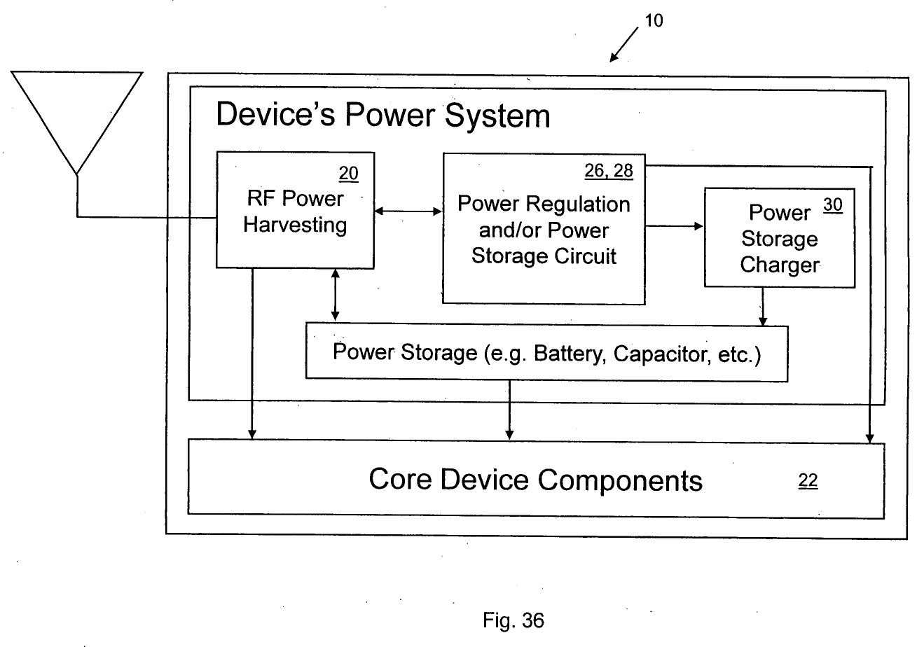

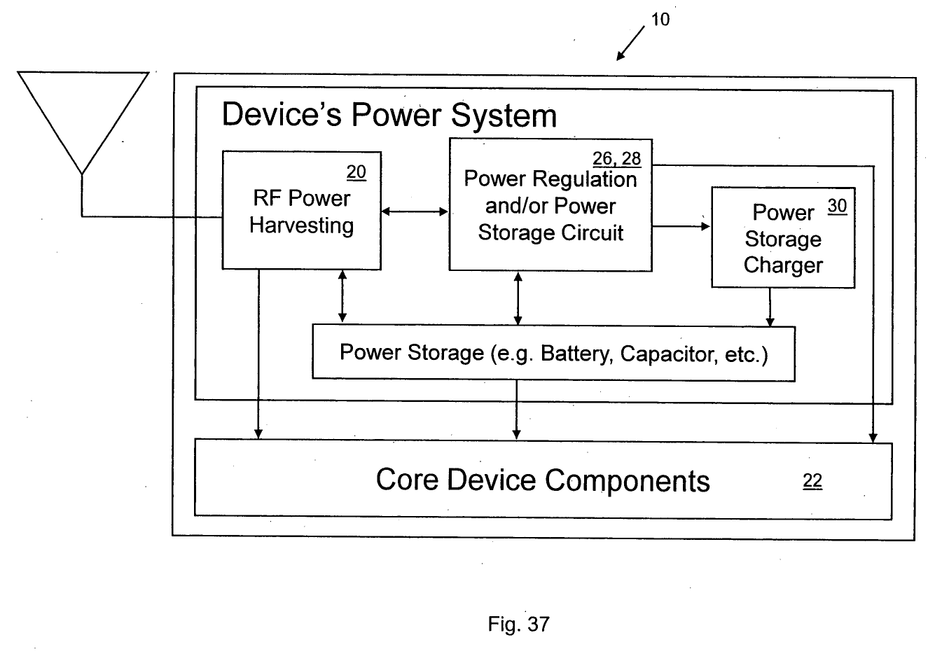

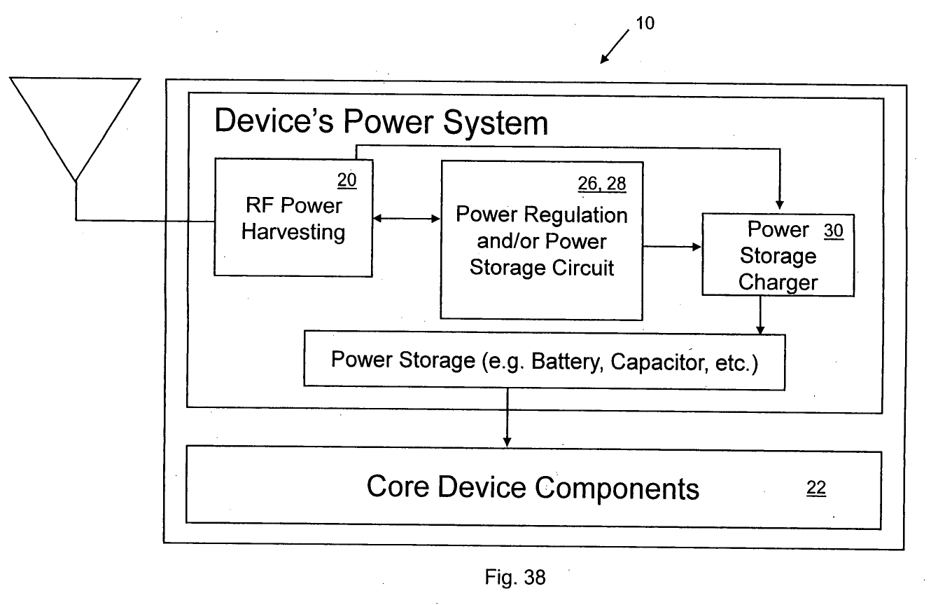

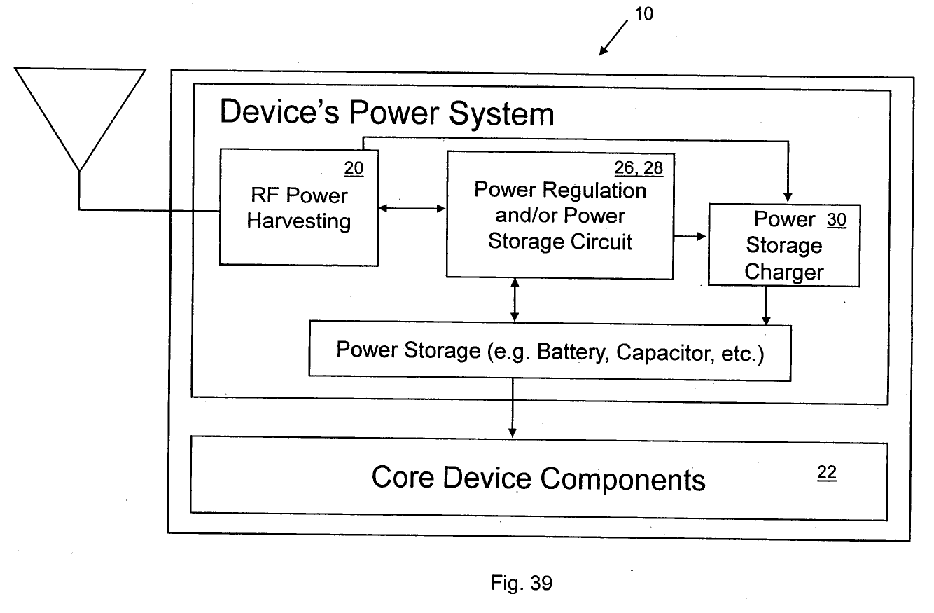

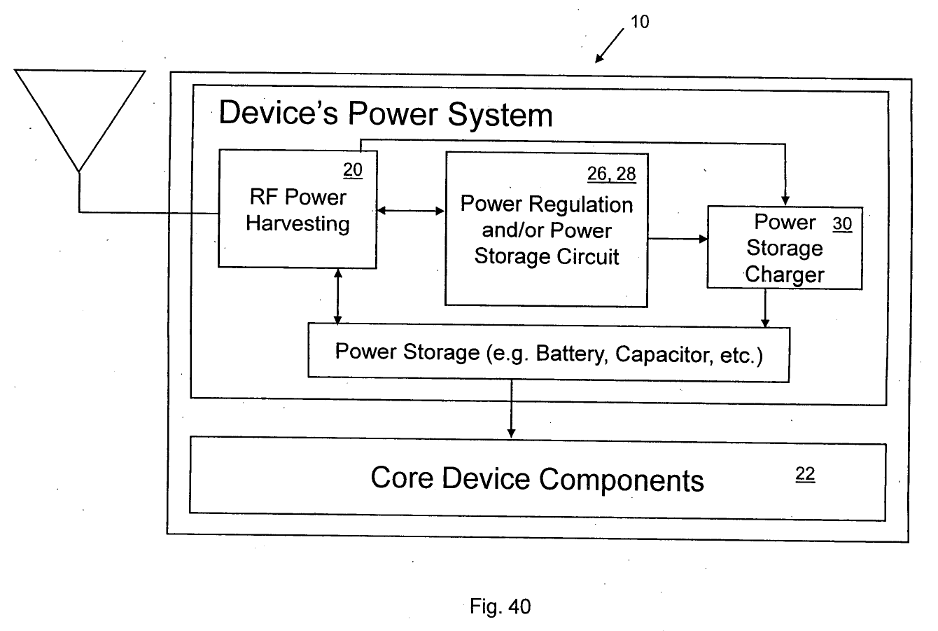

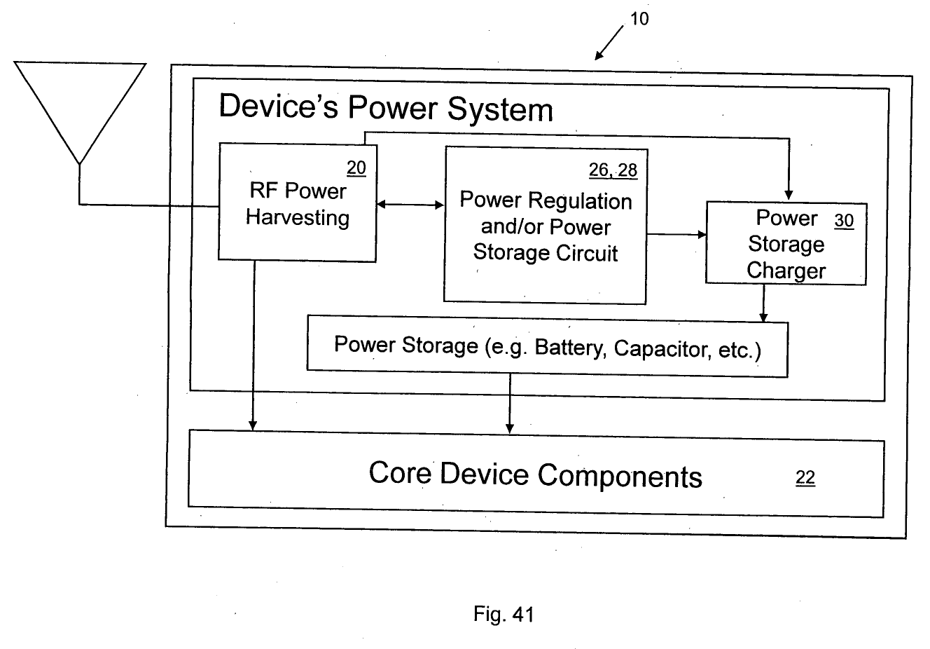

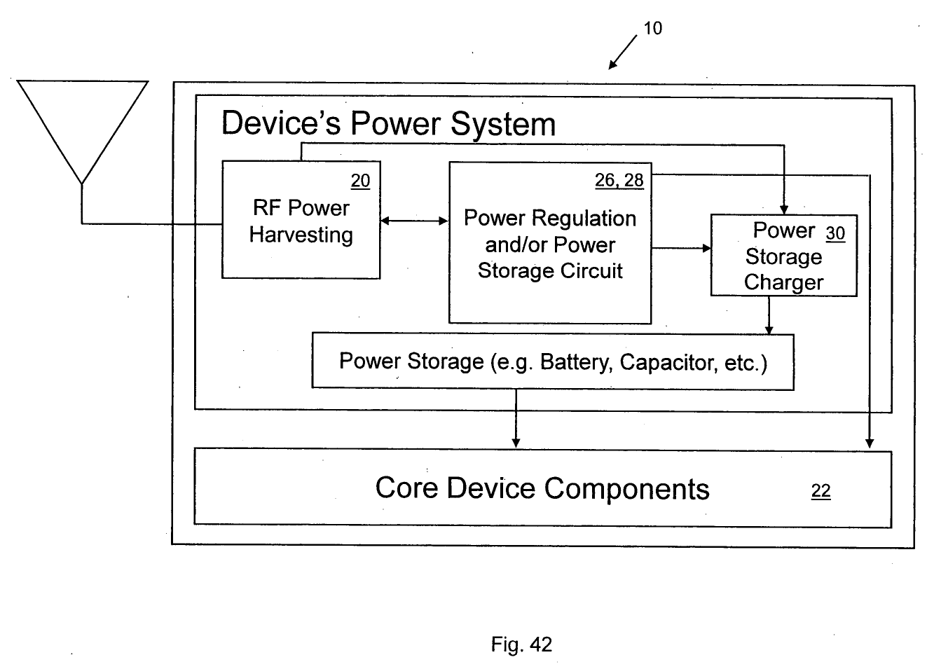

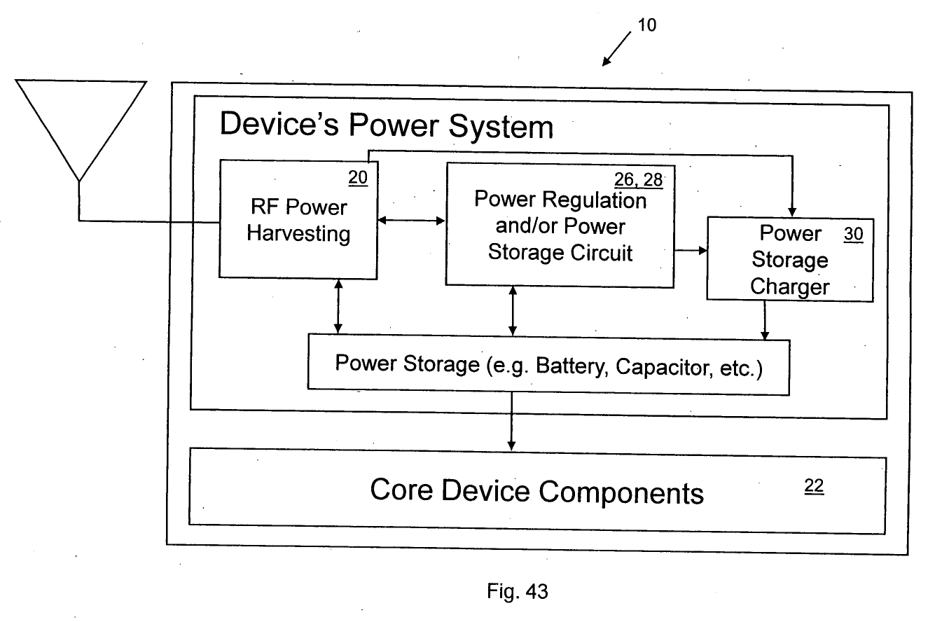

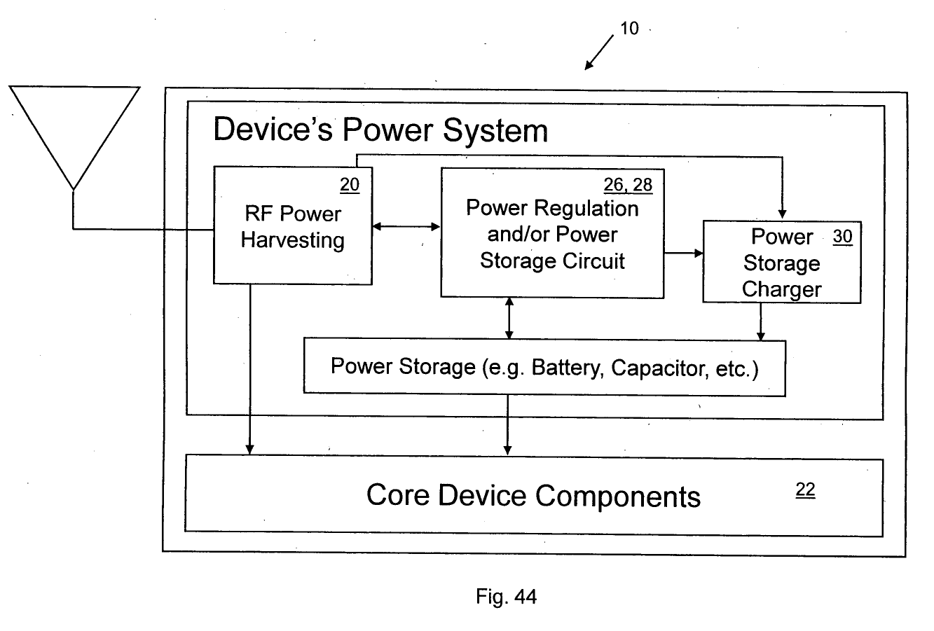

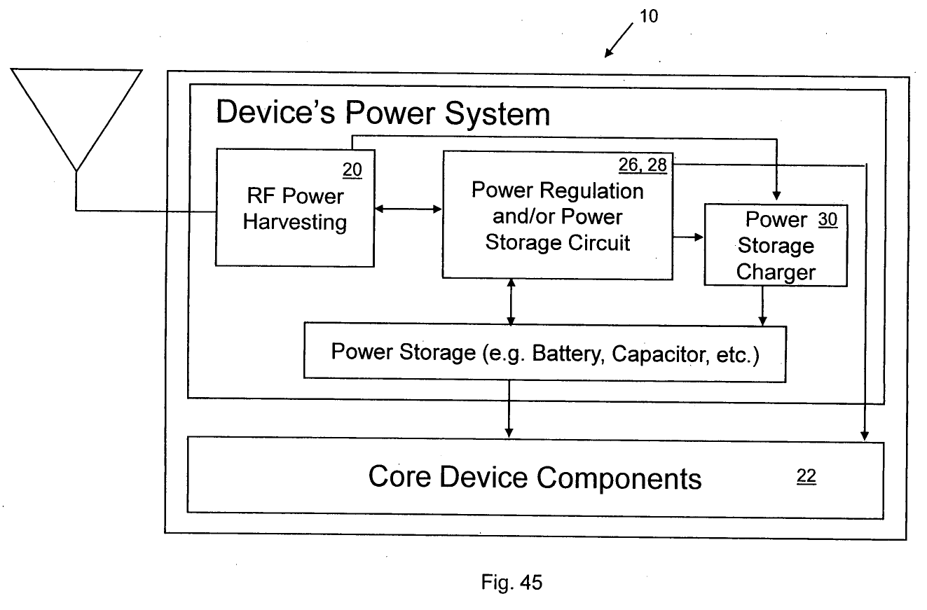

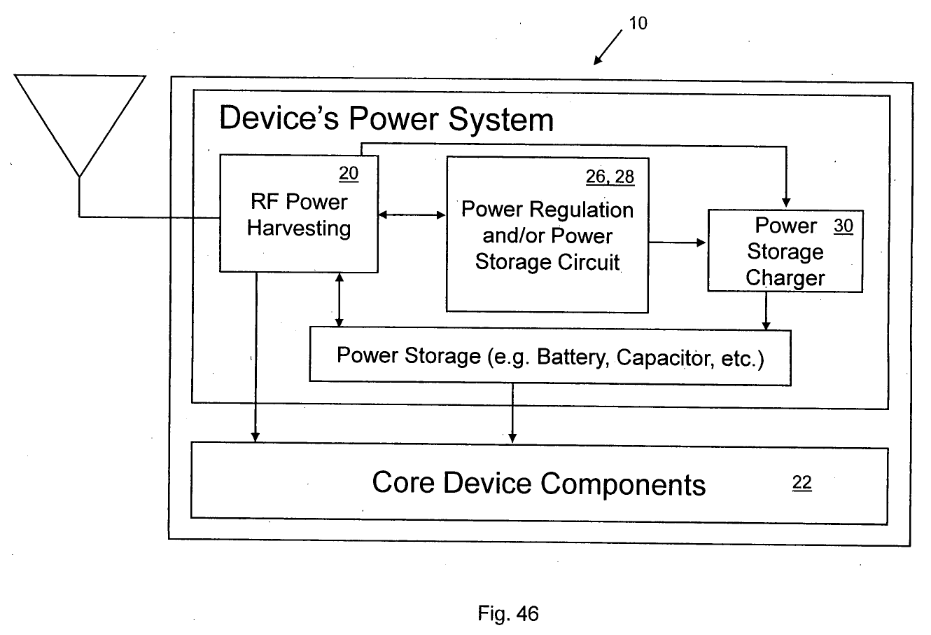

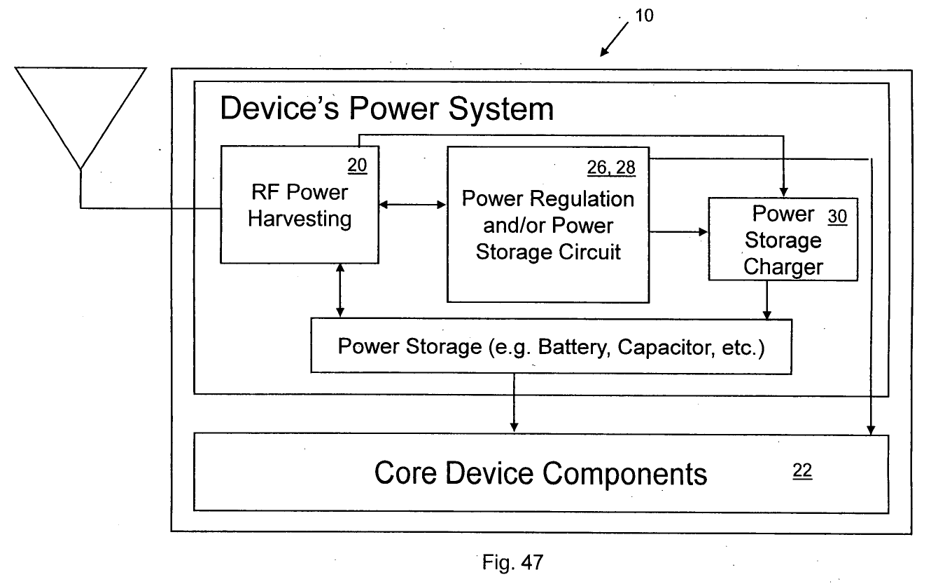

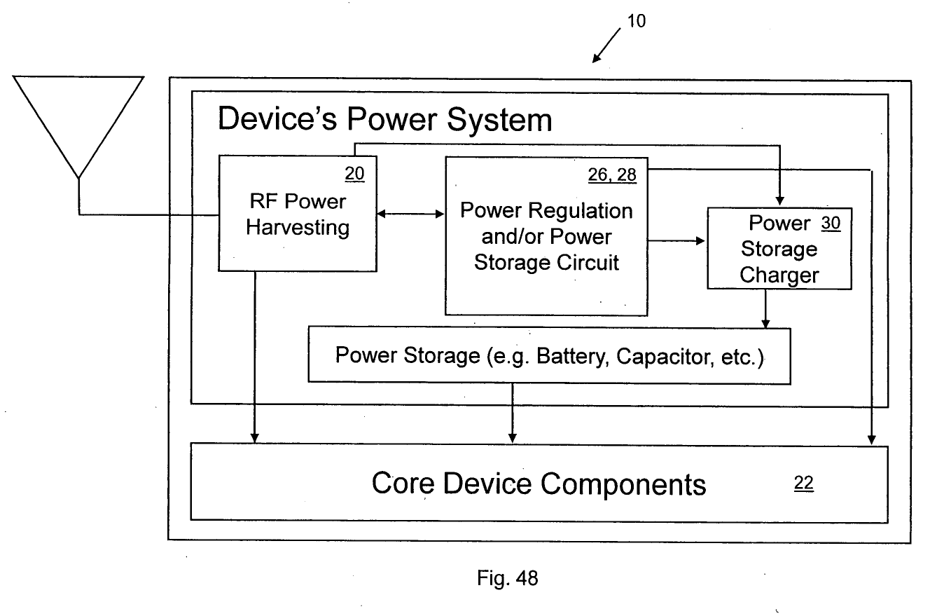

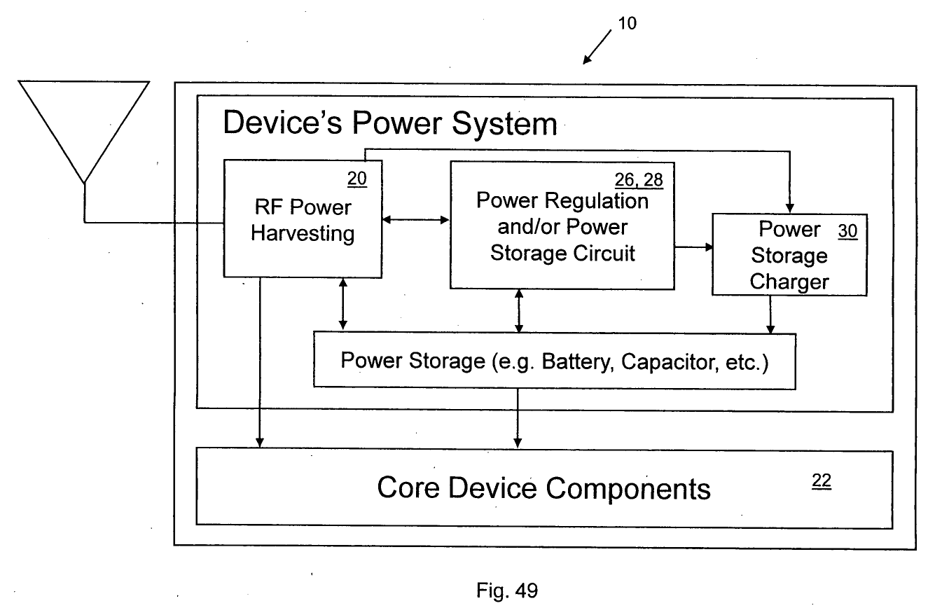

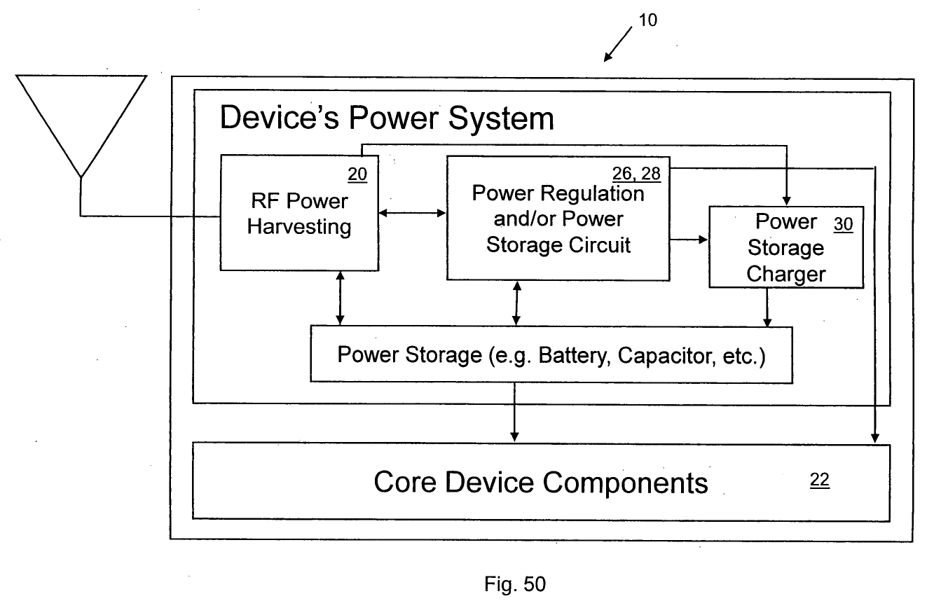

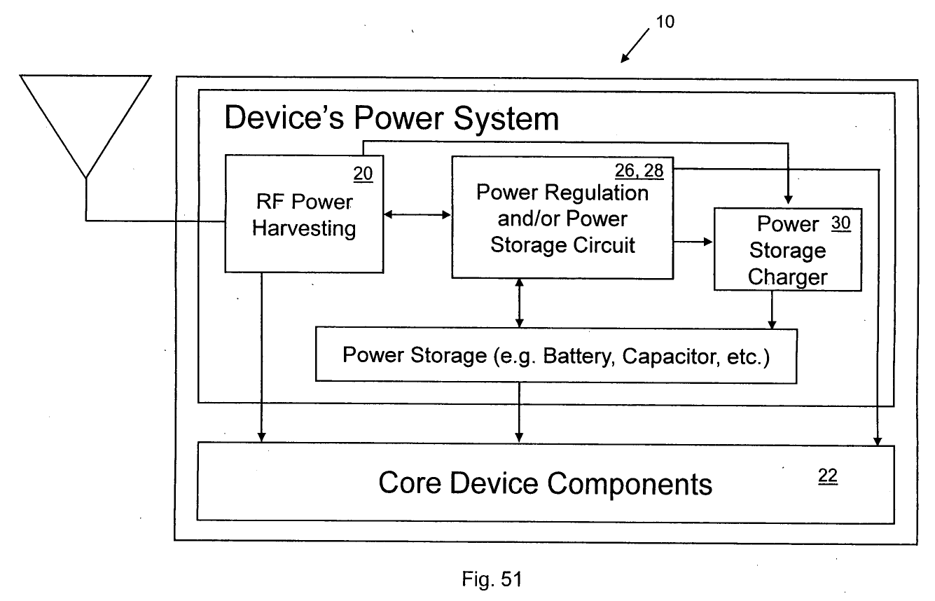

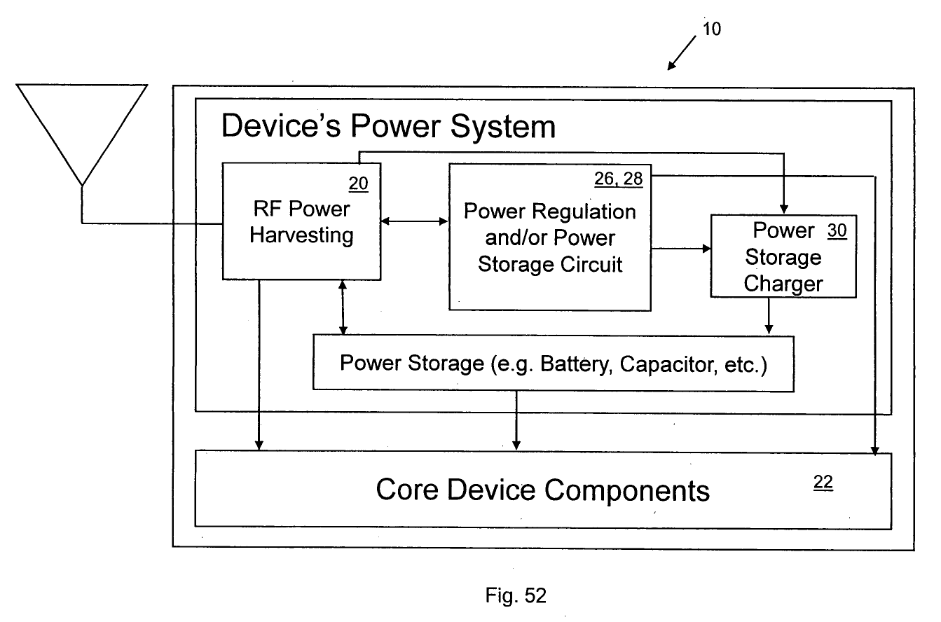

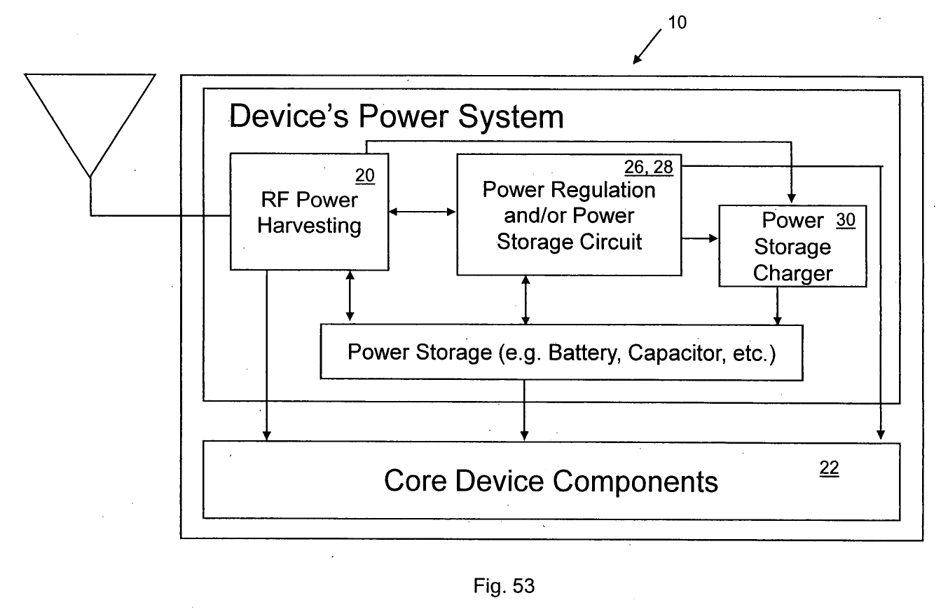

The disclosed invention is the application for retrieving radio frequency (RF) energy by an antenna, converting that energy into direct current (DC) power, regulating that energy using an optimized circuit, storing that energy in an optimized component, and/or supplying the power for specific devices. FIGS. 1-53 show how the system could be implemented.

Retrieval of RF Energy

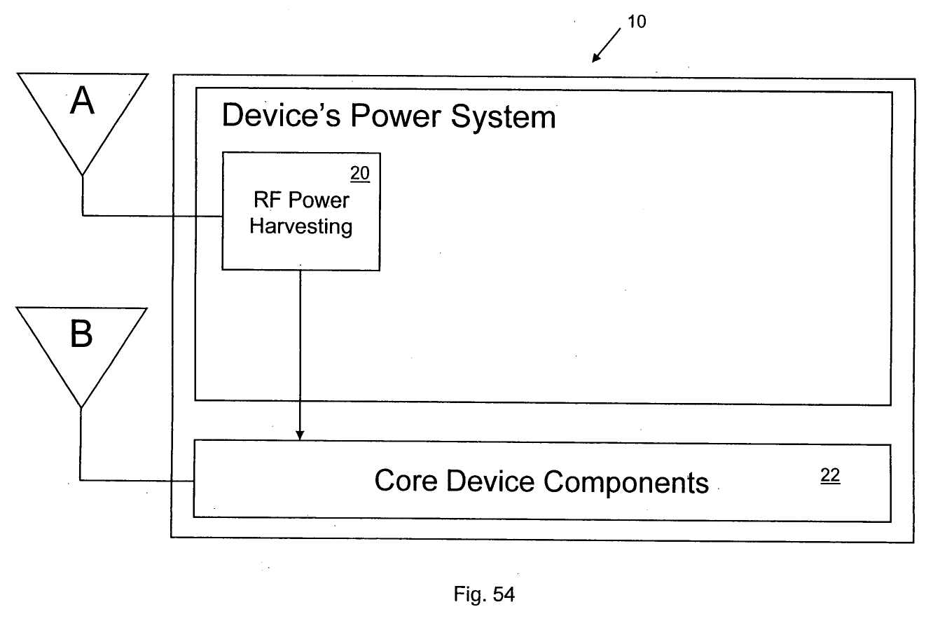

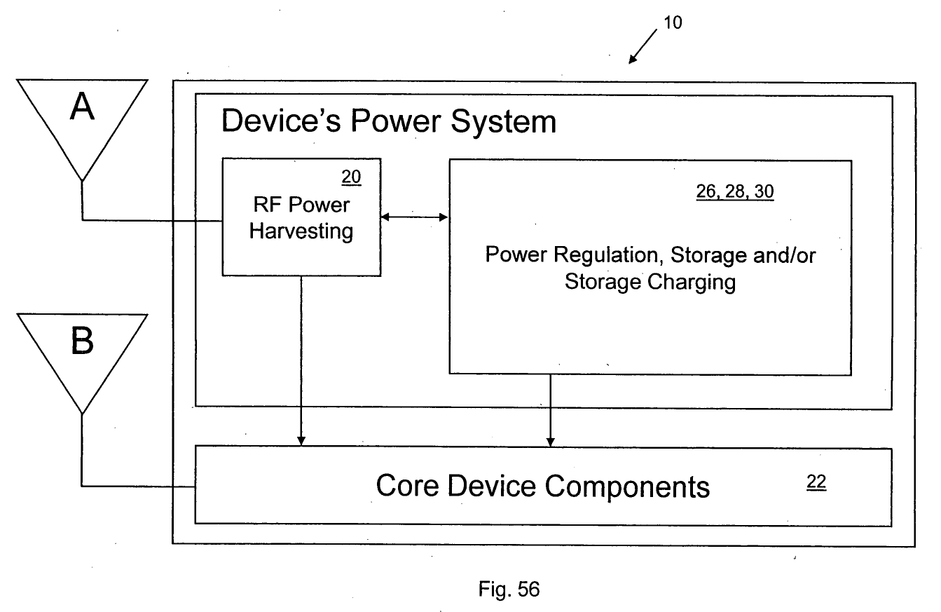

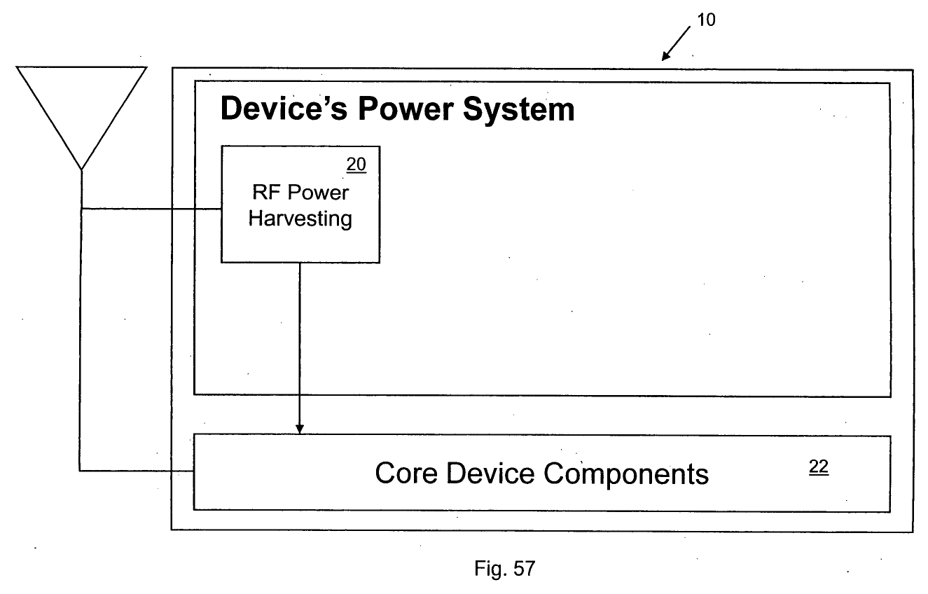

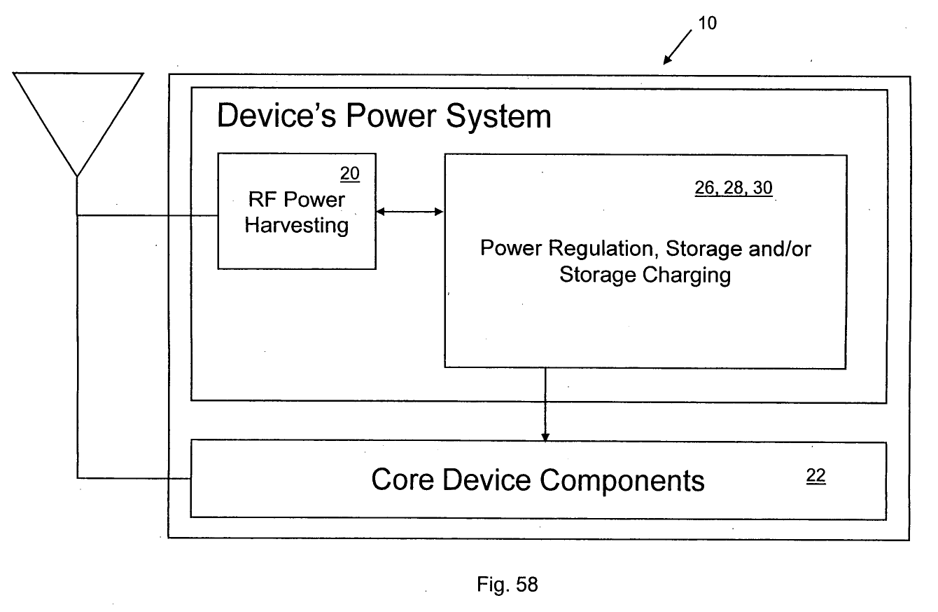

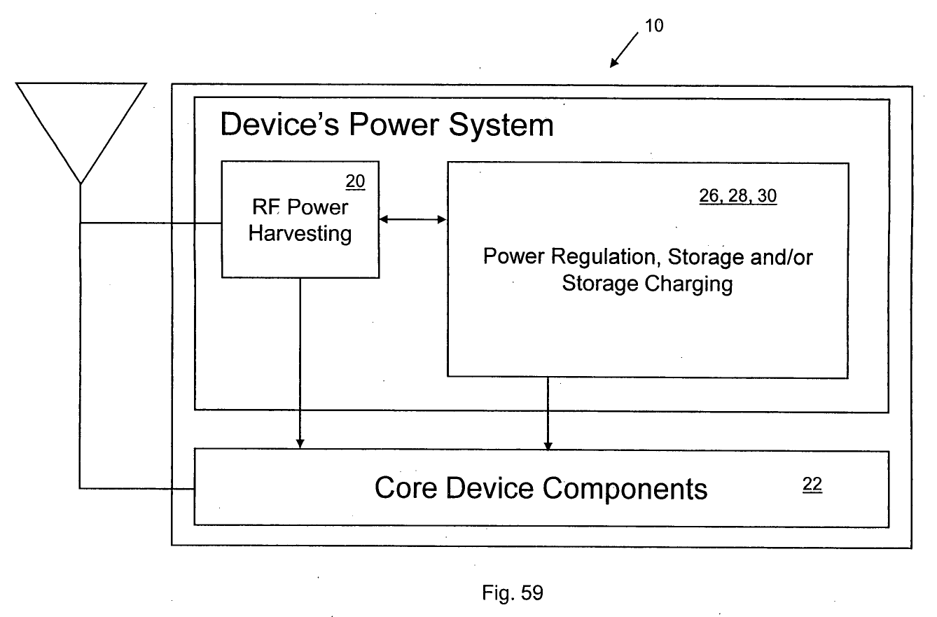

The RF energy is retrieved from the environment by the use of an antenna. The antenna can be shared or standalone with respect to an antenna used for the device's wireless communication. FIGS. 54-56 show a device that has an antenna A for use by the RF harvesting apparatus 10 and an antenna B used for wireless one-way or two-way communication. FIGS. 57-59 show a device where the antenna is shared by the both the device's communication module and RF harvesting apparatus 10. In terms of form factor, the antenna used by the apparatus 10 can be a separate component or integrated directly into the form factor of the device. The antenna is able to capture two types of available RF energy. The first type of energy exists as ambient RF energy. This type of RF surrounds us in our day-to-day lives and is usually generated to carry one way or two-way combinations of voice, video and data communications. The sources that the antenna can harvest from include medium-frequency AM radio broadcast, very-high-frequency (VHF) FM radio broadcast and television broadcast, ultra-high-frequency (UHF) broadcast, cellular base stations, wireless data access points, super-high-frequency (SHF) frequencies, and the industrial, scientific, and medical (ISM) bands. These sources cover transmission frequencies from 300 kHz to 30 GHz.

The second type of energy available is directed RF energy. This type of RF energy is directed from a transmitter specifically designed to deliver RF energy for harvesting by the antenna. The transmitter can be configured as a standalone device or integrated into an existing device.

Conversion of the Energy into DC

The RF energy captured by the antenna must be converted into a useful form of energy for the specific device. This conversion is shown in block form in all FIGS. (1-88) as the RF Power Harvesting Block. The most common form of useable energy is DC energy. To perform this conversion, the block includes circuitry to rectify the captured alternating current (AC) energy to create DC energy. The rectification in this block can be done with a diode(s), a transistor(s), or some other rectifying device or combination.

Regulation of the Energy

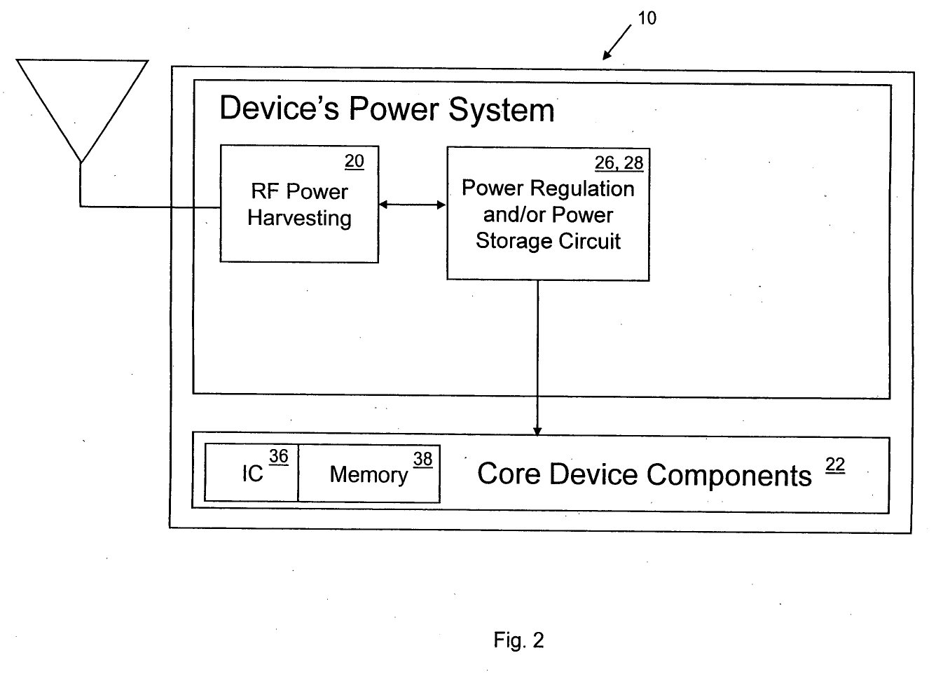

It may be necessary to regulate the converted power (hold the power at a constant level) for specific devices. FIGS. 2-7, 10-17, and 22-53 show how this regulation can be added to the circuit using a Power Regulation and/or Power Storage block. The devices that would need this block require a fairly constant voltage or current. Deviations from the required values may cause the device to not perform within its specifications. The regulation can be implemented in many different ways. The block can be as simple as using a Zener diode, or as complicated as using an integrated circuit such as a linear voltage regulator 26 or a switching regulator 26 to hold the voltage at a constant level. Certain devices have a more tolerable power requirement. For these devices, the regulation stage may be excluded.

Storage of the Energy

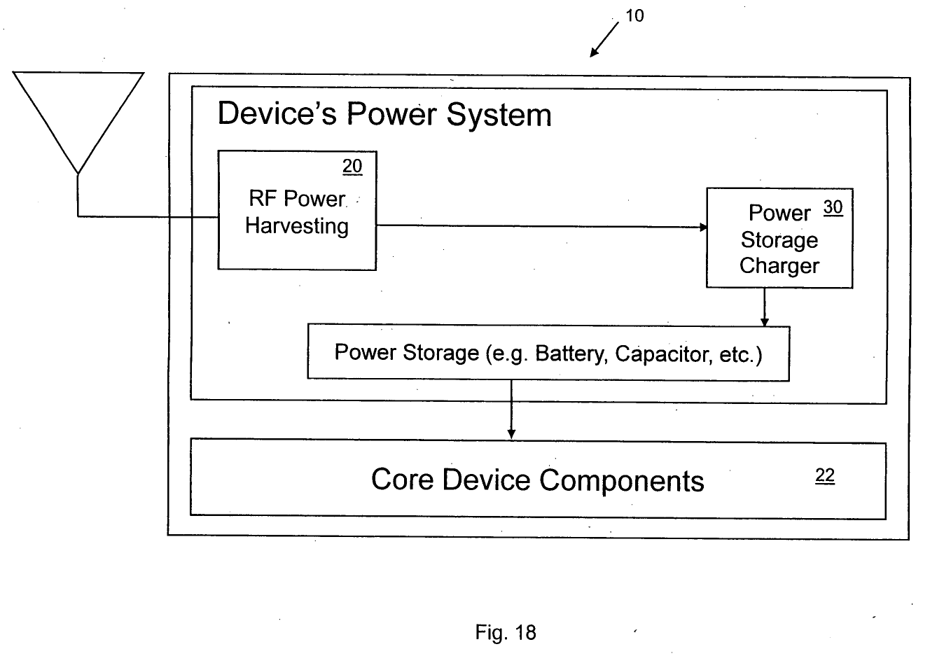

If a device has intermittent power requirements, such as the devices exampled by FIGS. 2-53, it may be necessary to store the captured power for use at a later time. The power can be stored in the Power Storage block or the Power Regulation and/or Power Storage block. Storage devices can include but are not limited to a battery, a capacitor, or another type of power storage component. In certain applications, it may be necessary to include additional circuitry that controls how the power is transferred to the storage device. The Power Storage Charger 30 block is shown in FIGS. 18-53. This may be needed if the storage component requires a special charging mechanism such as pulse charging or trickle charging. Storage components include but are not limited to batteries (rechargeable and non-rechargeable), capacitors, inductors, fuel cells, and other storage elements. There are devices that will not require storage. These devices can run directly off of the converted power. These devices also may or may not require regulation of the captured power.

Supplying the Power

The captured DC power, which may or may not be regulated and/or stored, is supplied to the device, which is represented by the Core Device 22 Components block in the figures. This may be a single connection or it may supply multiple parts of the device with power.

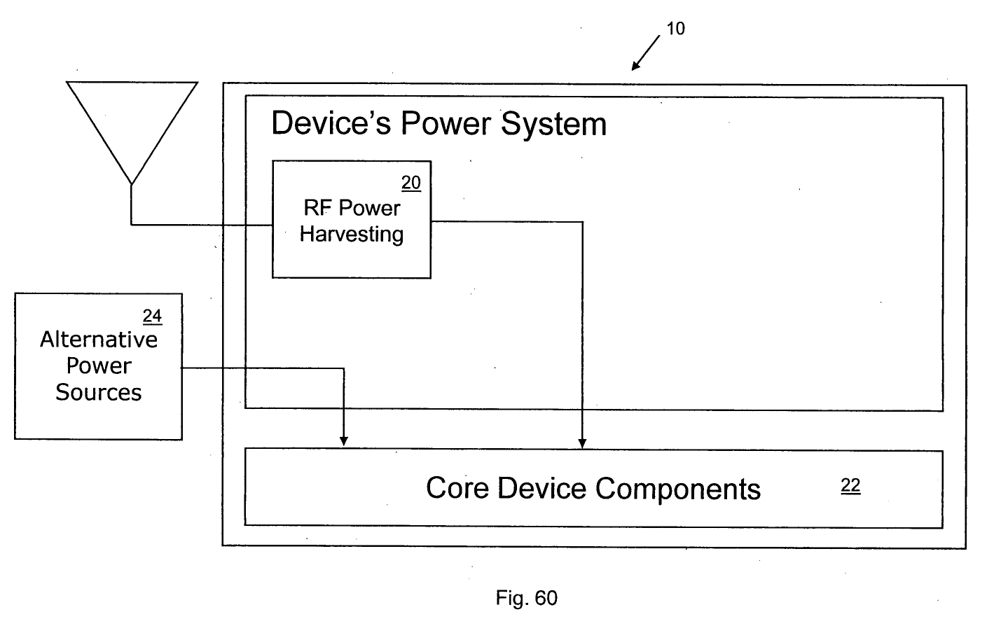

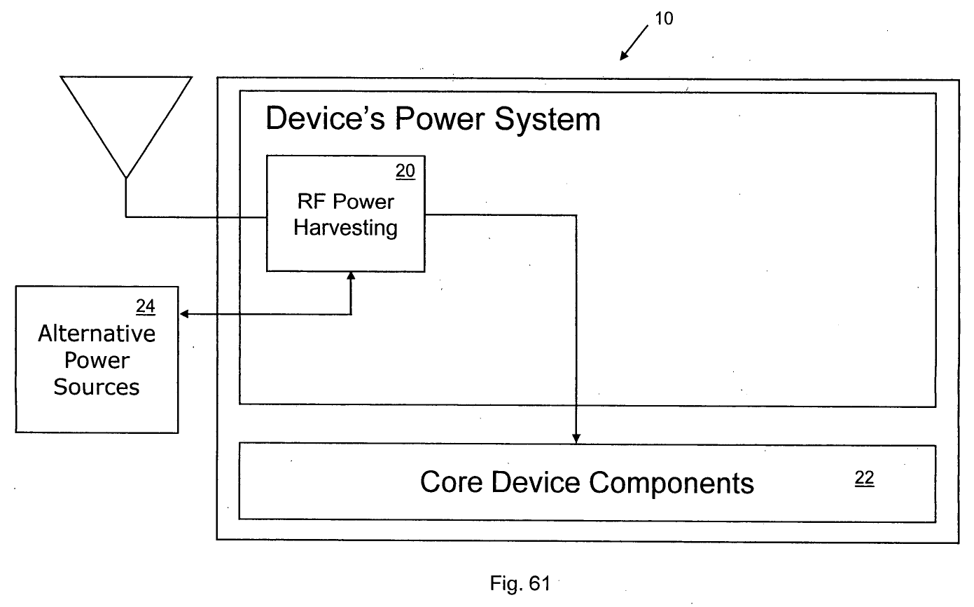

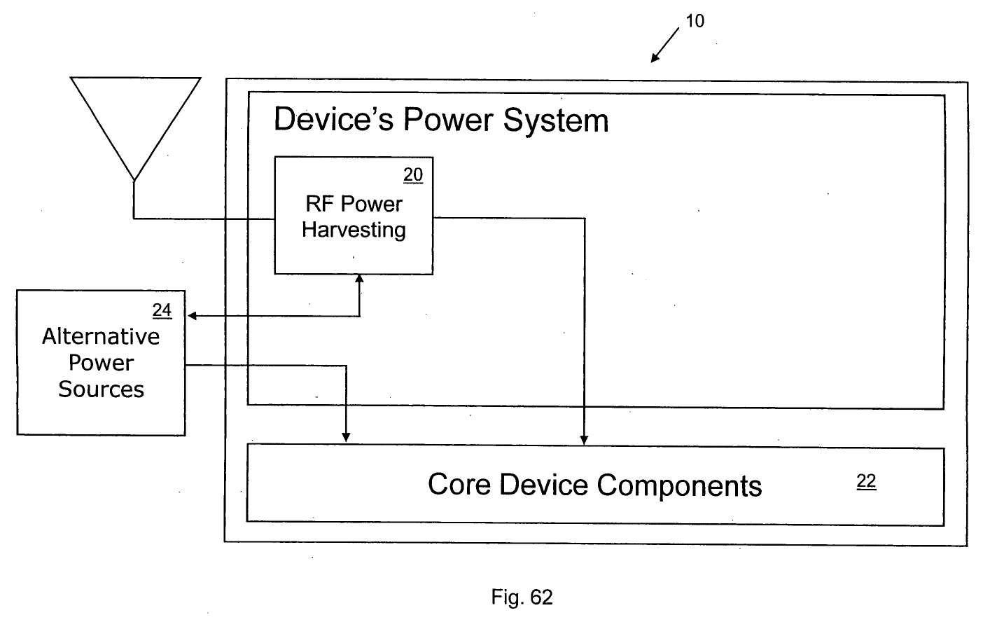

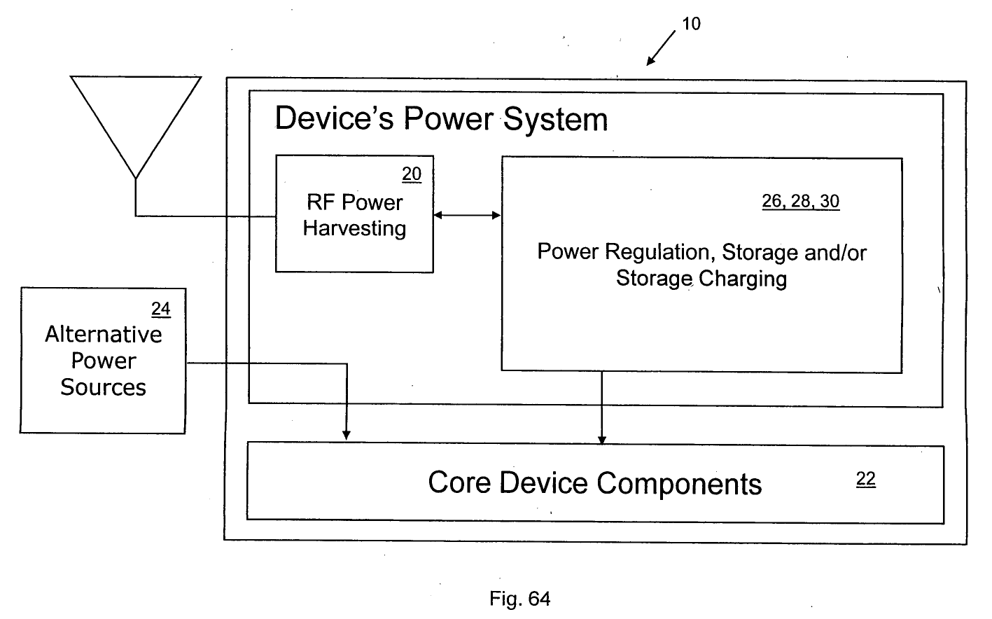

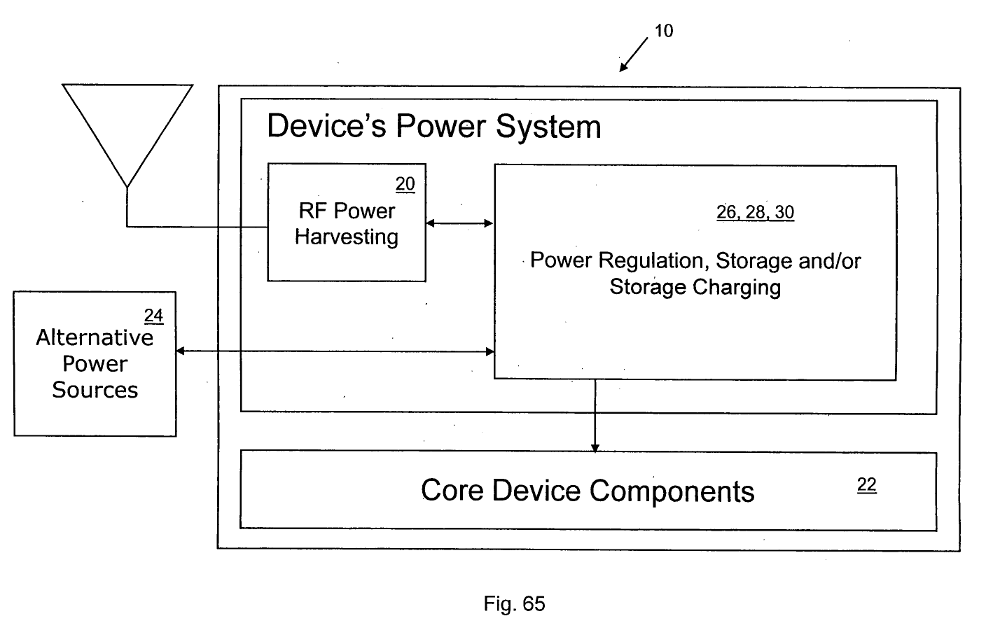

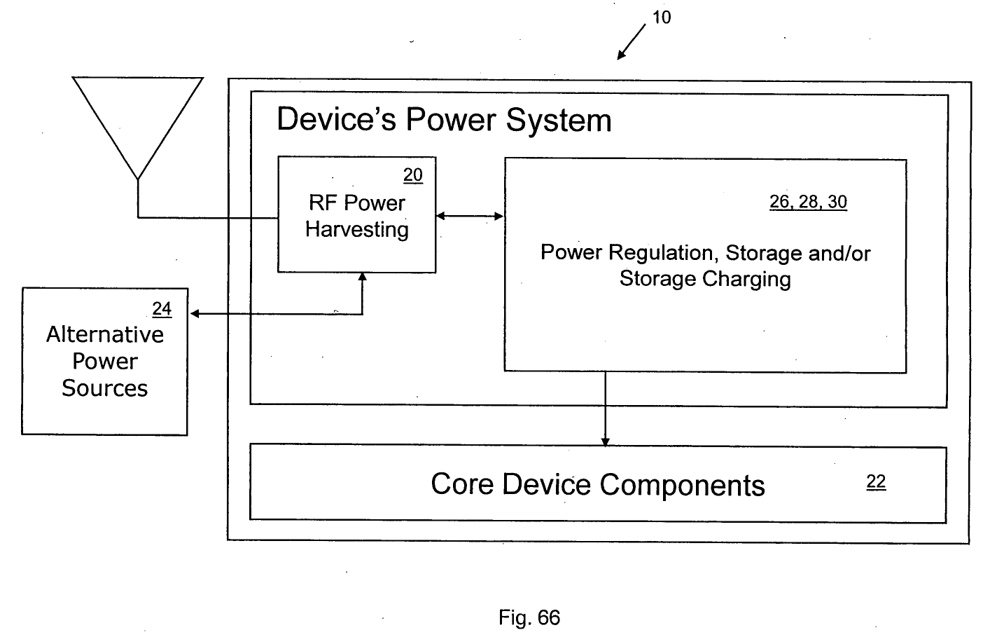

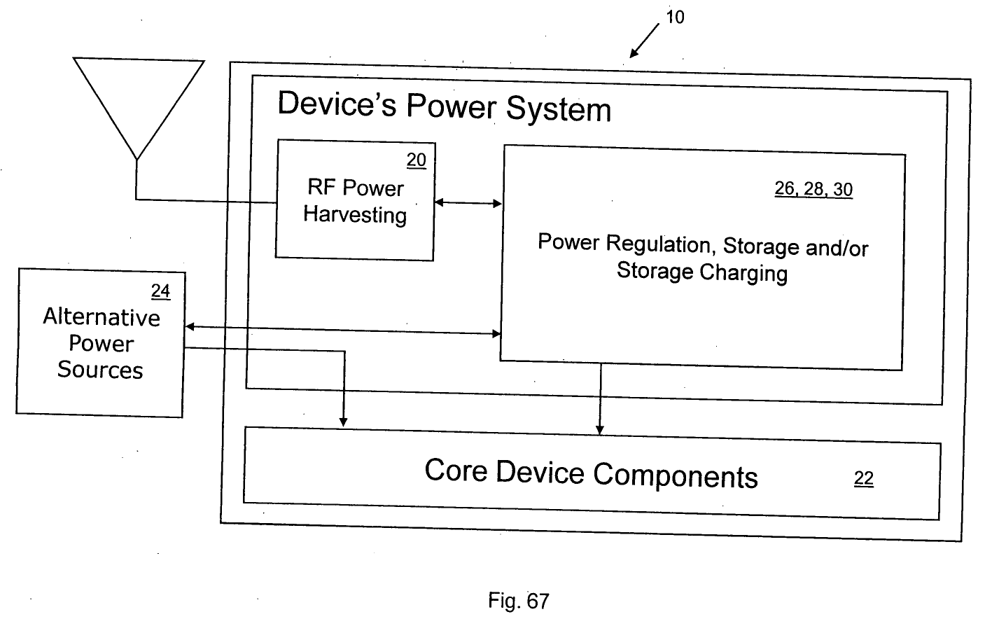

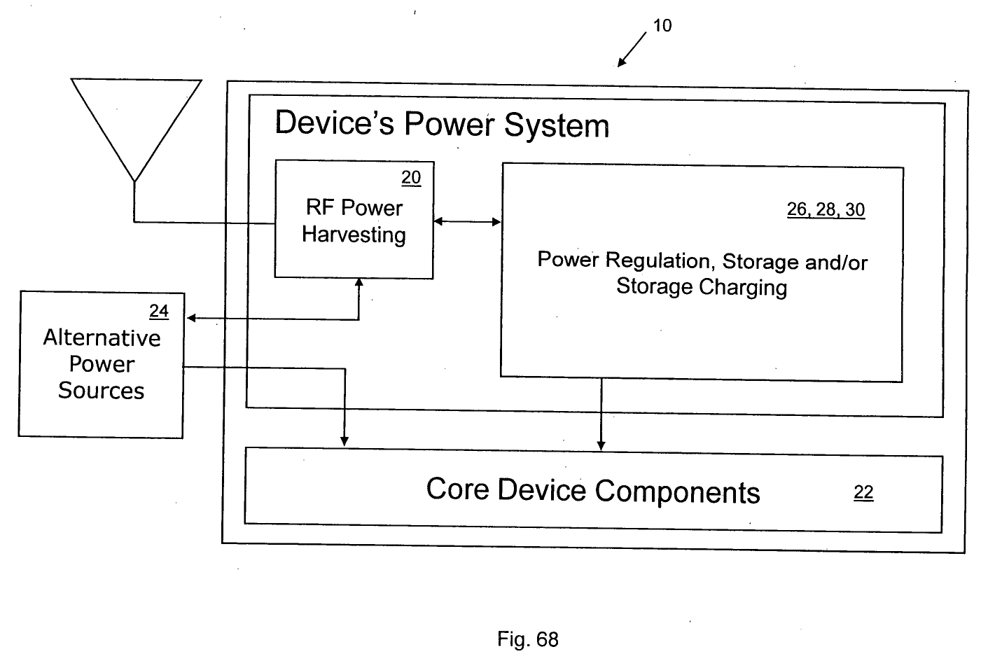

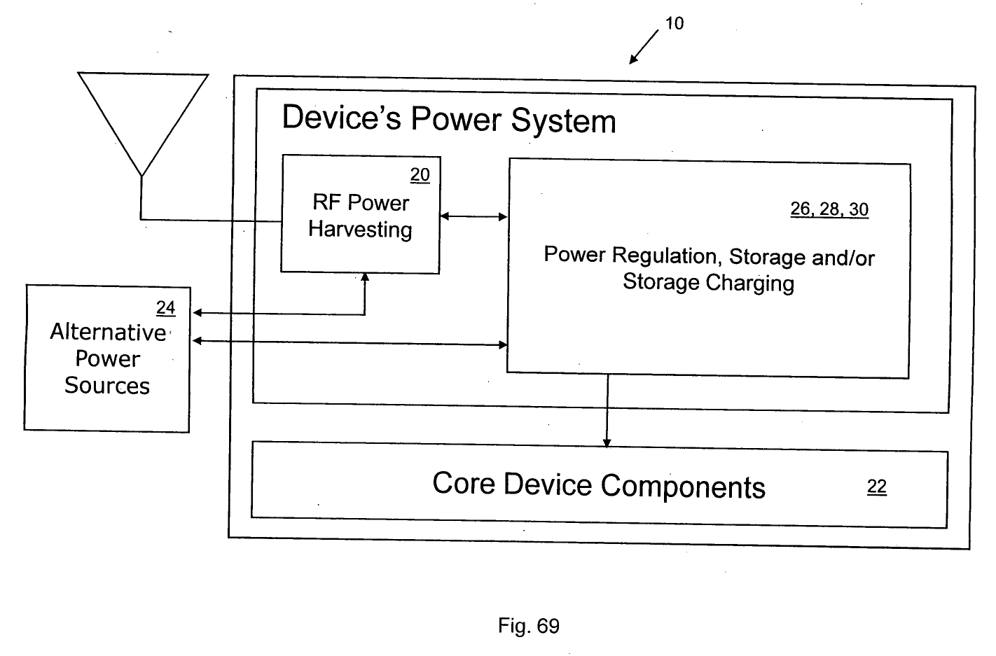

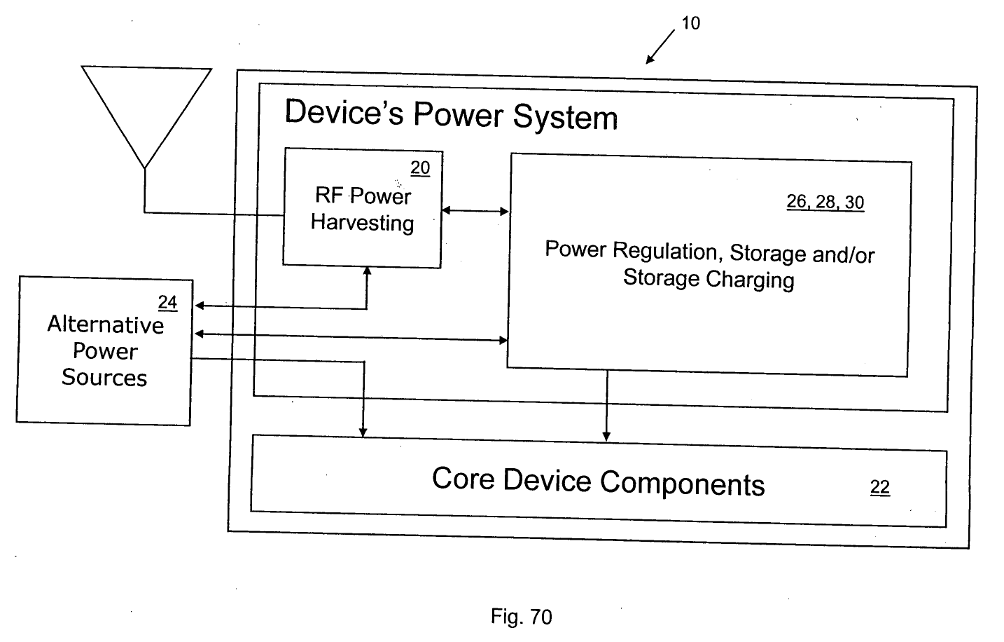

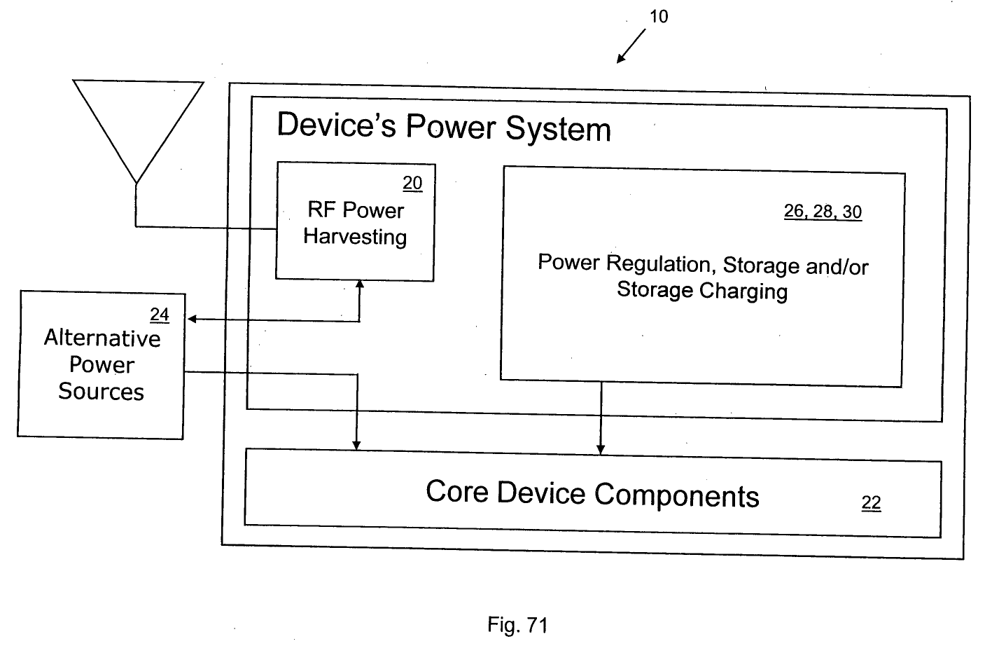

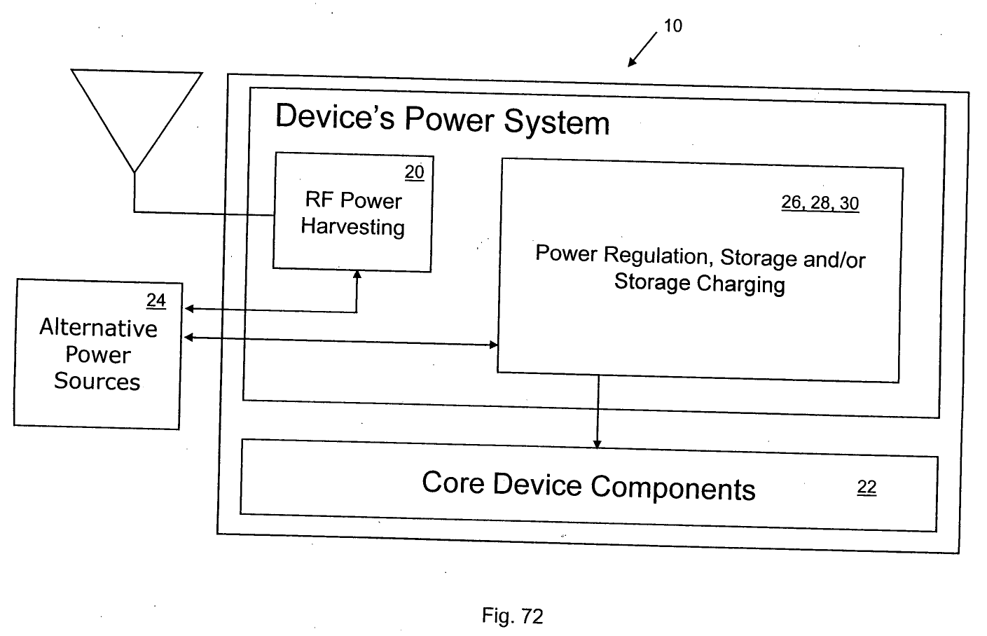

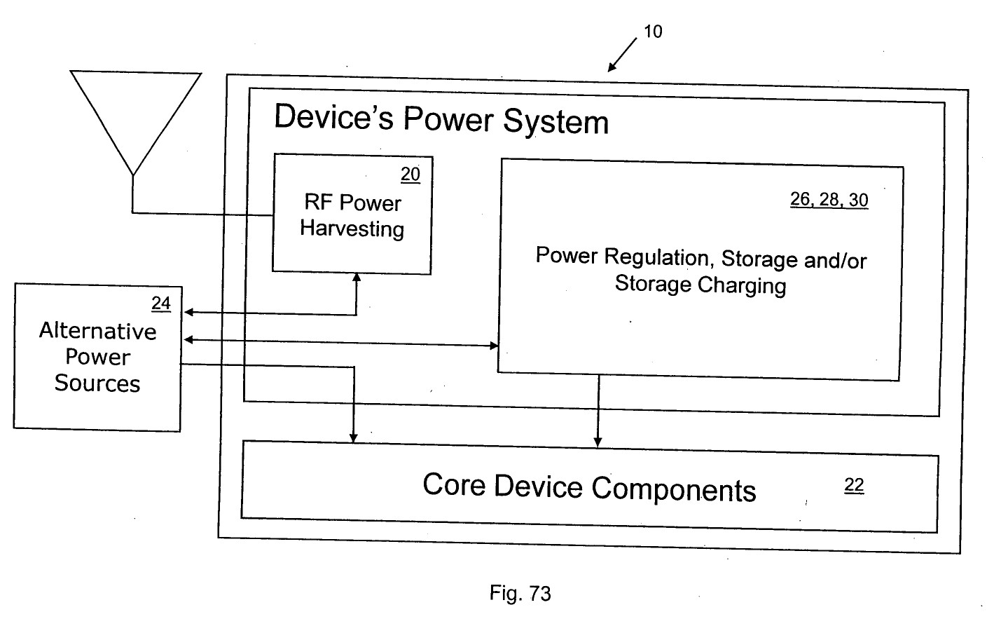

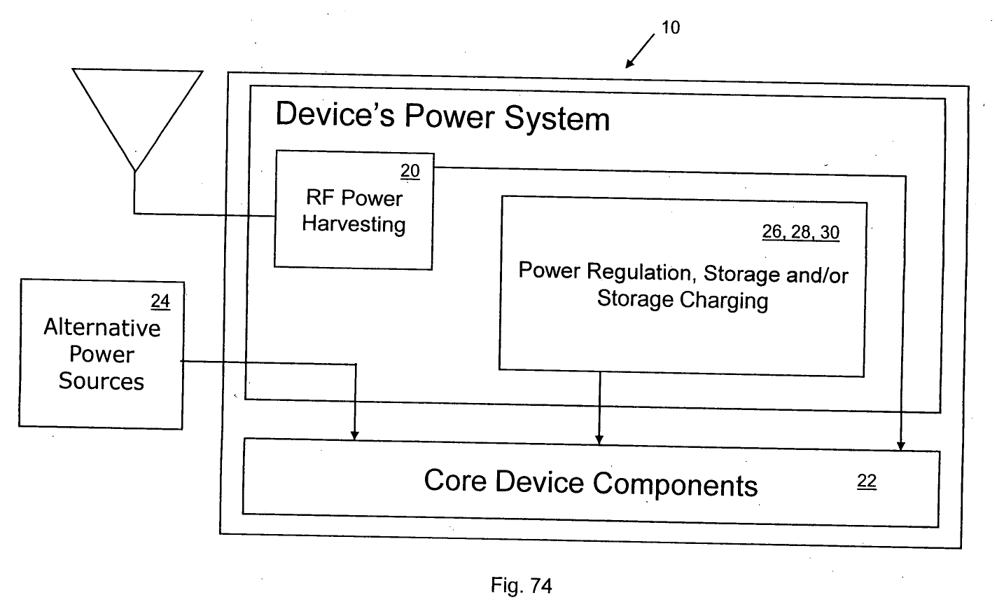

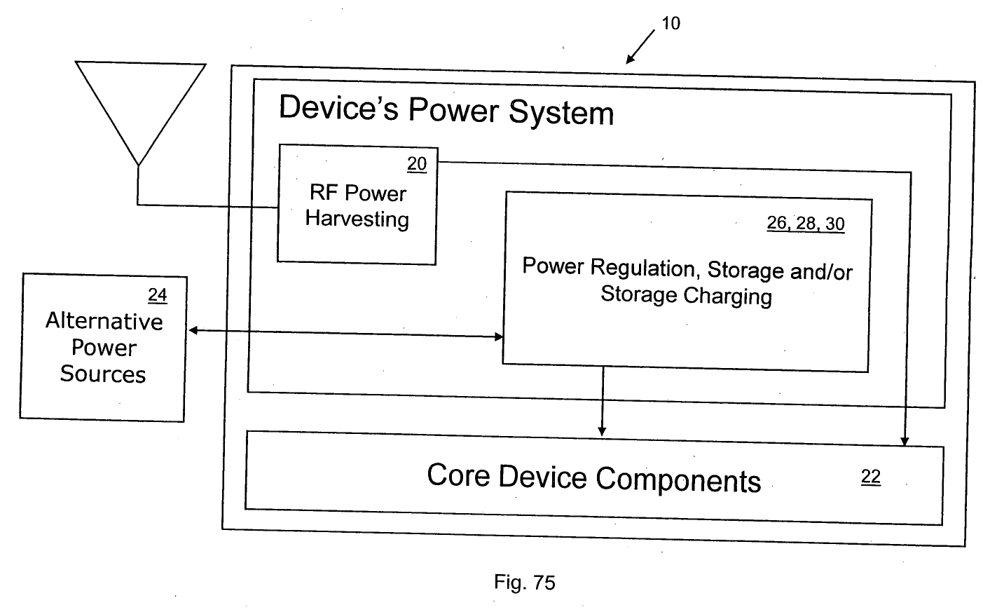

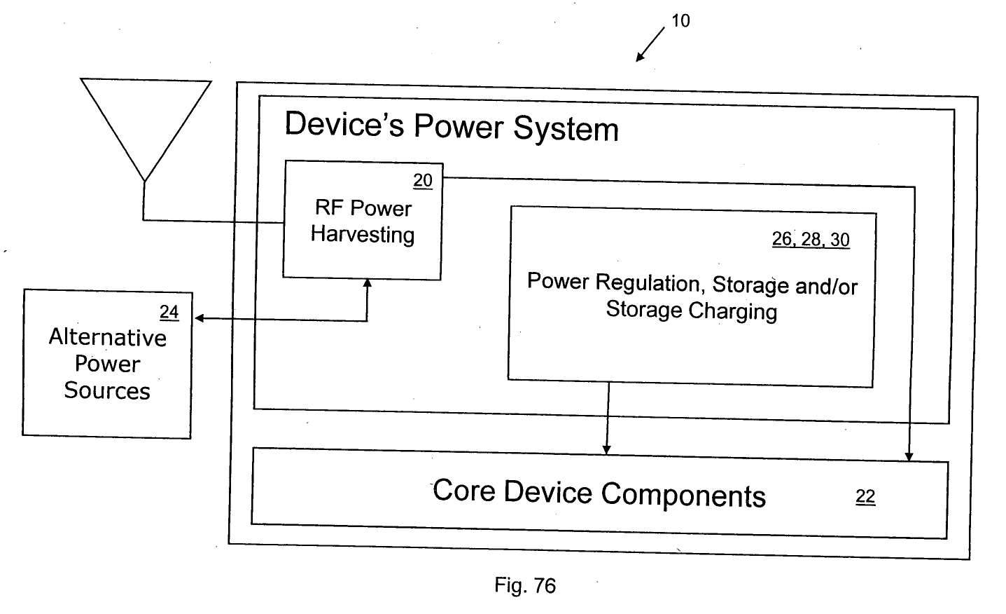

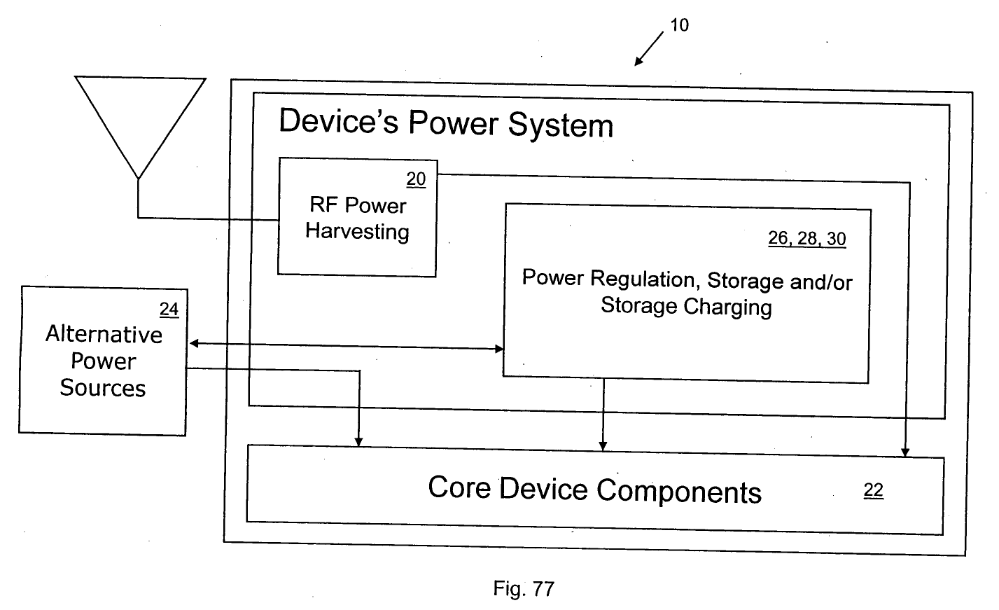

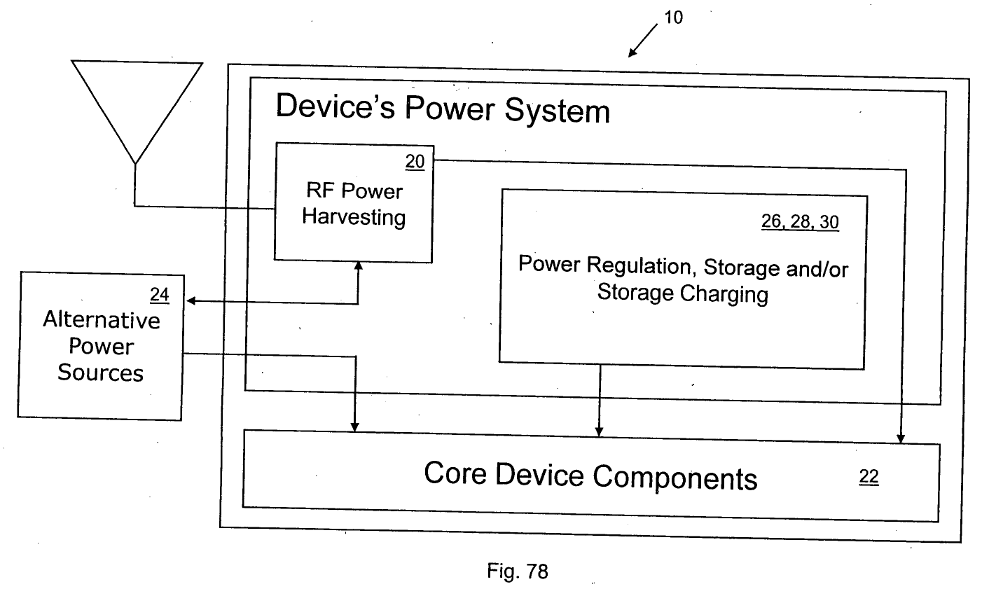

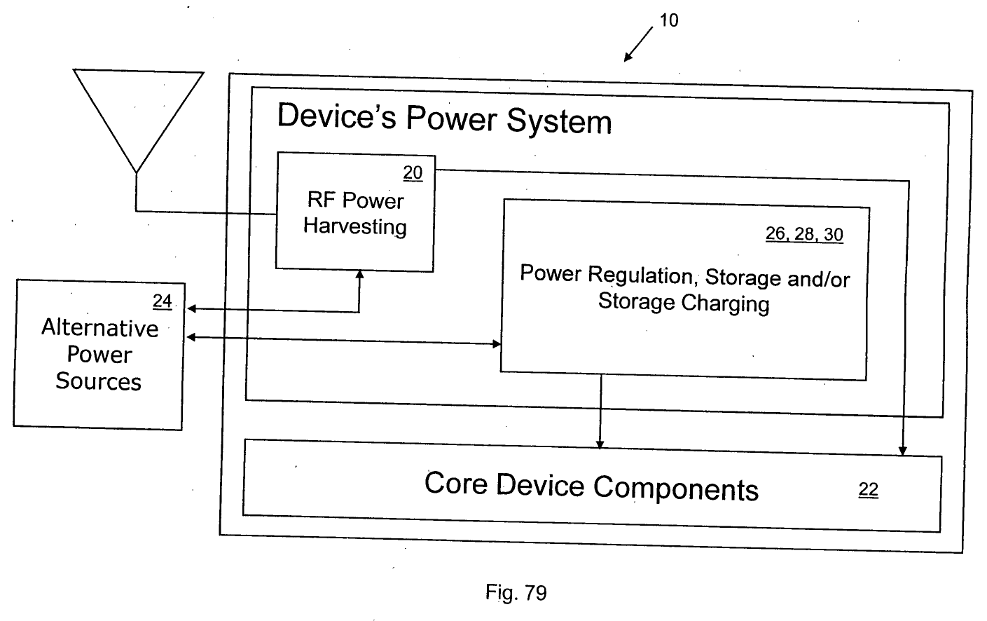

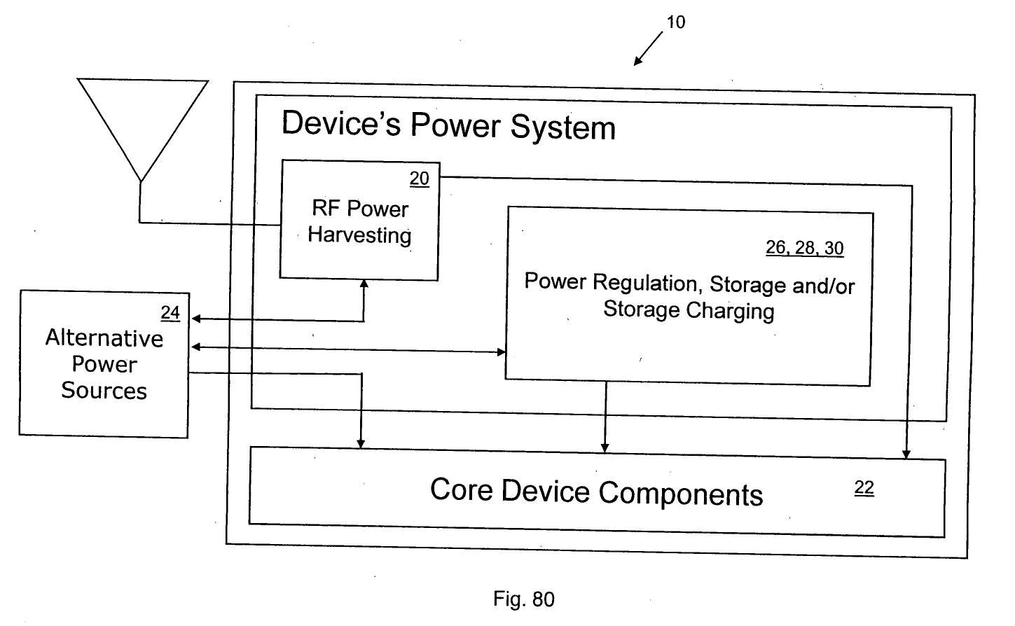

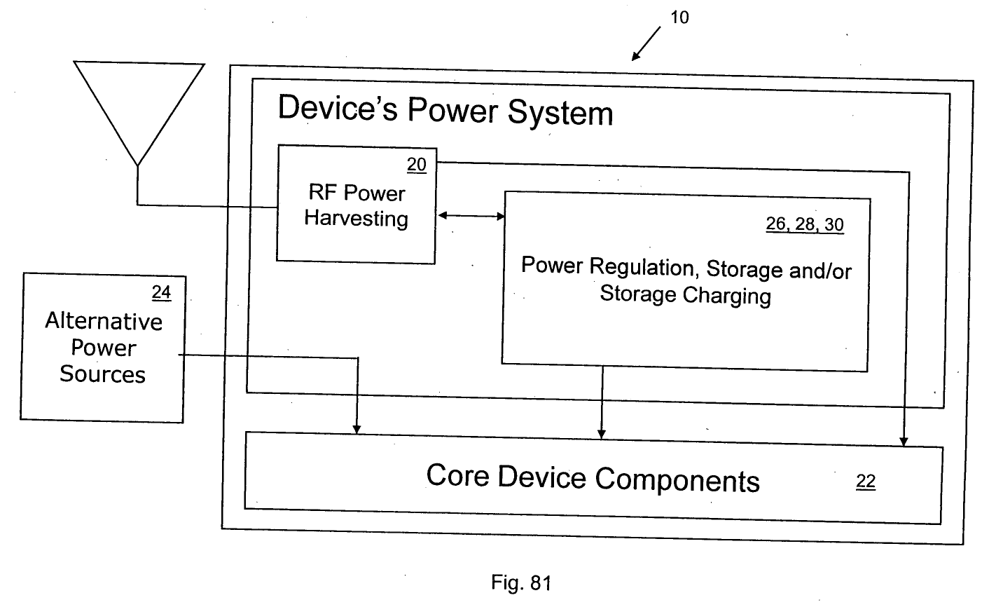

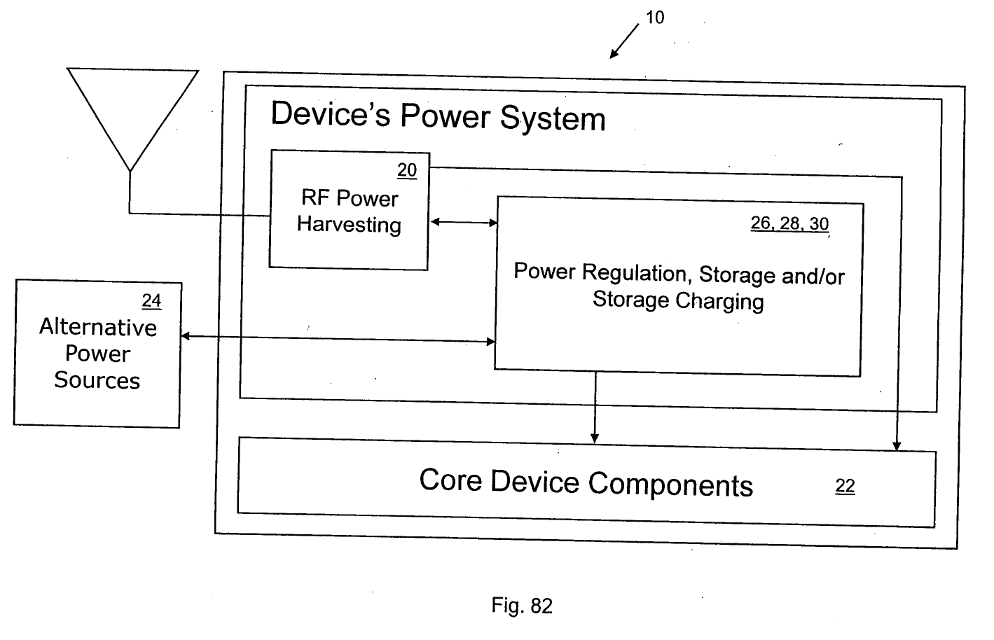

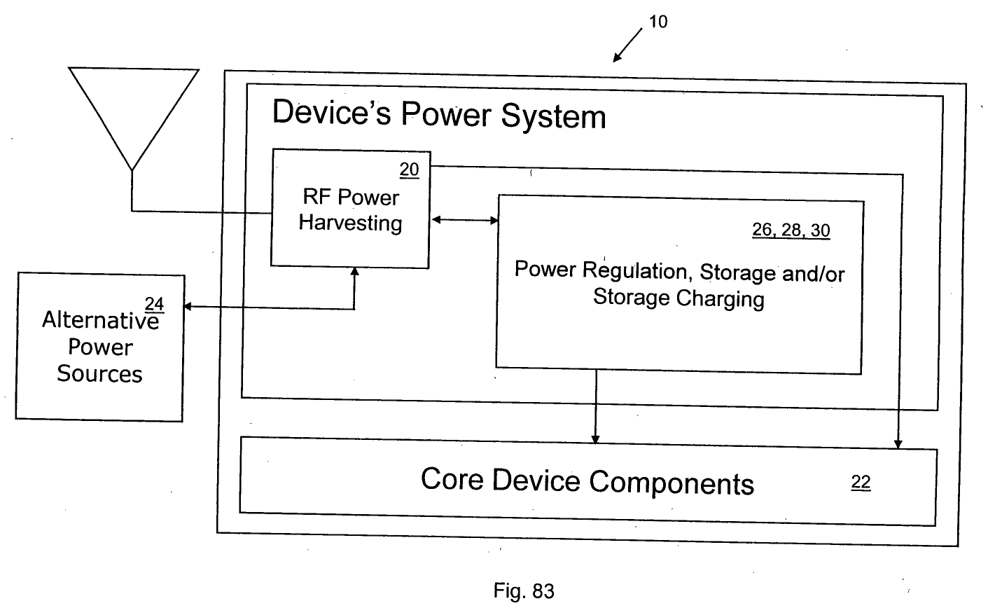

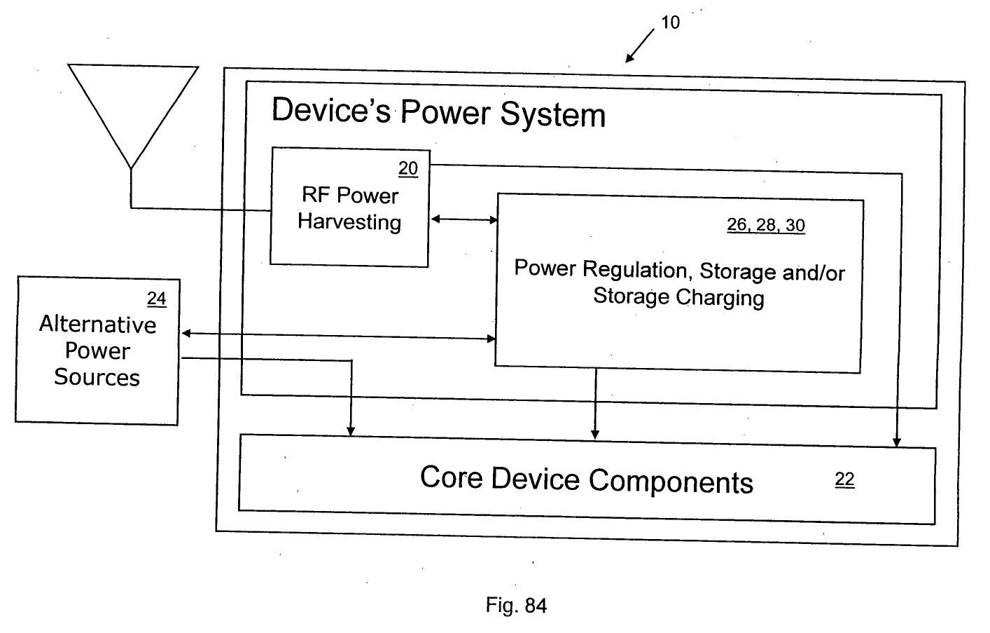

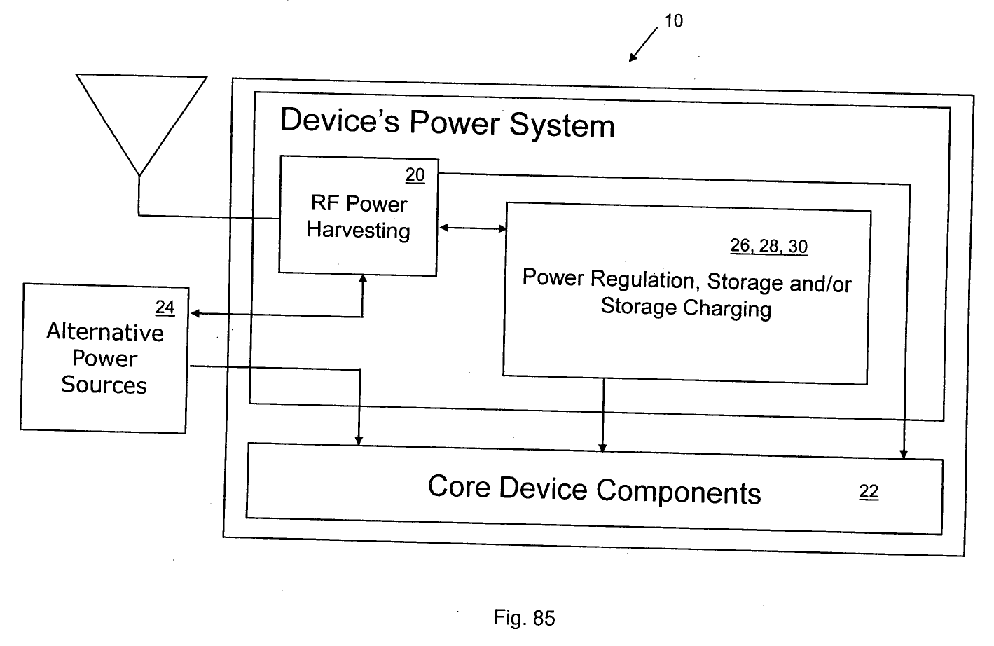

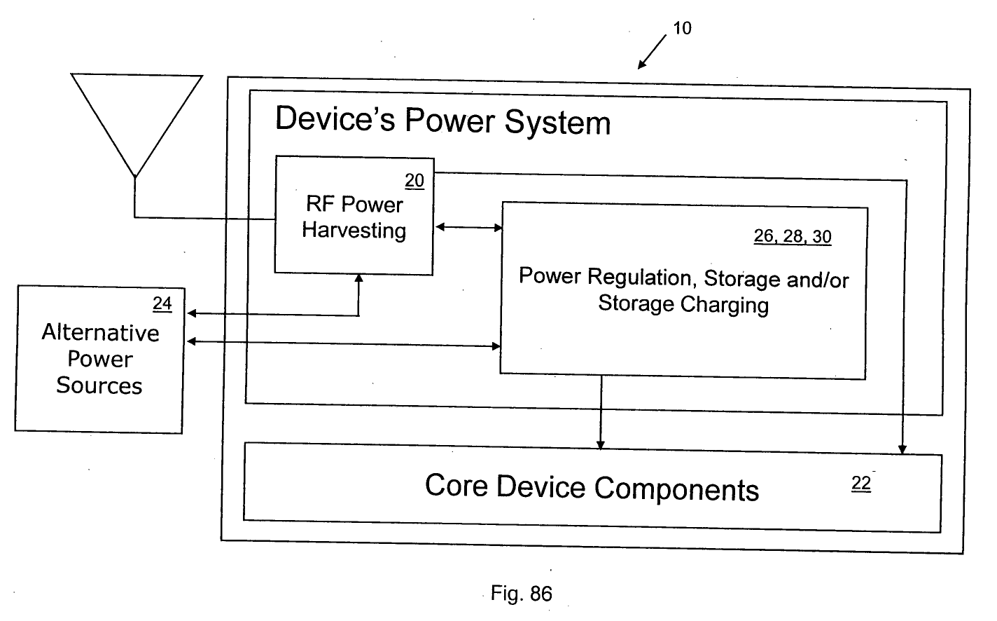

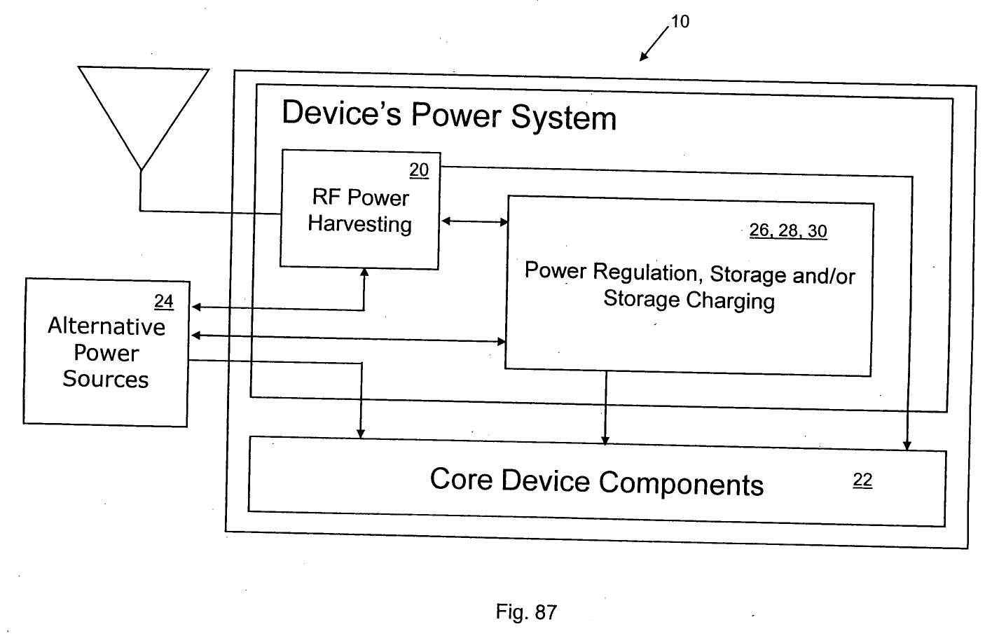

RF energy harvesting also has the ability to be augmented by other types of power harvesting or storage components. Other power harvesting technologies include but are not limited to solar, light (visible and non-visible), piezoelectric, vibration, acoustic, thermal, microgenerators, wind, and other environmental elements. Storage components include but are not limited to batteries (rechargeable and non-rechargeable), capacitors, inductors, fuel cells, and other storage elements. FIGS. 60-88 show how the alternative power can be connected to an RF energy harvesting system. These figure show how the RF energy harvesting components and the alternative power source 24 (or sources) can work independently or have communication with each other. The antenna configurations shown in FIGS. 54-59 are still applicable with the addition of an alternative power source(s) 24. These antenna configurations can be applied to FIGS. 60-88.

RF energy harvesting also has the ability to provide a backup to devices on-grid (tethered) or with reliable power sources, which can be used in case the primary power source is lost. As an example, it may be mandated by regulations that a sensor has auxiliary power in case the primary supply is lost. It could be possible to use a rechargeable battery that obtains its charge from the primary supply when in operation. However, if the primary supply is lost for a time greater than the life of the rechargeable battery, the specification of uninterrupted power is not met. RF energy could be used to supply power to the described device while the primary supply is not available. The primary supply could include but is not limited to an on-grid connection, a generator, a battery, or other reliable power supply.

RF energy harvesting with or without alternative source augmentation is applicable to provide electric power directly or indirectly to a range of electronic components contained in any specific electrical or electronic device and includes but is not limited to:
Passive electronic components, active electronic components
Resistors, fixed resistors, variable resistors, thermistors, thyristor, thermocouple
Capacitors, Electrolytic Capacitors, Tantalum Capacitors, Ceramic Capacitors, Multilayer Ceramic Capacitors, Polystyrene Film Capacitors, Electric Double Layer Capacitors (Super Capacitors), Polyester Film Capacitors, Polypropylene Capacitors, Mica Capacitors, Metallized Polyester Film Capacitors, Variable Capacitors
Diodes, Voltage regulation diodes, light-emitting diodes, organic light-emitting diodes, Variable capacitance diodes, Rectification diodes, Switching diodes, Regulation Diodes, Diode bridges, Schottky barrier diodes, tunnel diodes, PIN diodes, Zener diodes, Avalanche diodes, TVSs
Integrated circuits, microcontroller unit (MCU), microprocessor unit (MPU), logic circuits, memory, printed circuits, circuit boards, printed wiring boards
Transistors, MOSFETs, FETs, BJTs, JFETs, IGBTs, Relays, Antennas, semiconductors, conductors, inductors, relays, diacs, triacs, SCRs, MOVs
Fuses, circuit breakers
Batteries, Non-rechargeable batteries, rechargeable batteries, coin cell batteries, button cell batteries, alkaline batteries, lithium batteries, lithium ion batteries, lithium polymer batteries, NIMH batteries, NICAD batteries, Lead acid batteries, Zinc air batteries, Manganese Lithium batteries, Niobium Titanium Lithium batteries, Vanadium Pentoxide Lithium batteries, Carbon Zinc batteries, Zinc Chloride batteries, Lithium Thionyl Chloride batteries, Manganese Dioxide batteries, Lithium Poly-Carbonmonofluoride batteries, Lithium Manganese Dioxide batteries, Lithium Chloride batteries, Lead Acid Calcium batteries, Lead Acid Tin batteries, Oxy Nickel batteries, Silver Oxide batteries, Magnesium batteries
Inductors, Coils, High Frequency Coils, Toroidal Coils, Transformers, switches, chokes
Motors, DC motors, stepper motor, AC motors, Fans
Crystals, Oscillators, Clocks, Timers
Displays, LCDs, LED displays

RF energy harvesting with or without alternative source augmentation is applicable across a range of markets and specific devices and includes but is not limited to:

Consumer Electronics
Electronic equipment, wired devices, battery powered devices, wireless communication devices, cell phones, telephones, phones, cordless phones, portable phones, Bluetooth devices, Bluetooth headsets, hands-free headsets, headsets, headphones, Wireless headsets, radios, AM/FM radios, shortwave radios, weather radios, Two-way radios, portable radio, lights, lanterns, portable lights, flashlights, nightlights, spotlights, search lights, calculators, graphing calculators, desk calculators, clocks, alarm clocks, wall clocks, desk clocks, travel clocks, watches, wristwatches, pocket watches, stop watches, timers, voice recorders, Dictaphones, laser pointers, power tools, cordless power tools, electronic razors, electric razors, handheld games, gaming systems, game controllers, wireless game controllers, remote controls, battery chargers, computers, portable computers, keyless entry, toys, toy guns, toy laser guns, games, microphones, musical instruments, musical effects processors, musical instrument tuners, metronomes, electronic chord charts, door openers, garage door openers, PDA, Cameras, Video recorders, Multi-meter, electronic test equipment, hand-held electronics, portable electronics, wireless pens, sound generators, noise generators, language translators, electric toothbrushes, portable televisions, pagers, transceivers, toy vehicles, remote control vehicles, toy planes, remote control planes, pet containment systems, invisible fence pet sensors, memory backup, base station battery backups, appliance battery backups, uninterrupted power supplies, GPS devices, memory retention power supplies, metal detectors, stud finders, metal stud finders, stun guns, tazers, wearable devices, baby monitors, intercoms, doorbells, wireless doorbells, electronic office supplies, electronic staplers, radar jammers, radar detectors, digital scales, microfilm cassettes, video head testers, compasses, noise canceling headphones, air samplers, depth finders, barometers, weather measurement instruments, data transfer devices, automatic distress signaling unit, Wireless audio speakers, Satellite radios, Police scanners, Car navigation systems (GPS devices), Decorative lights, Christmas lights, garden lights, lawn lights, ornamental lights, porch lights
   Multi-media players: MP3, DVD, analog music players, CD players, tape players, digital music players, digital video players, minidisc
   Computer: keyboards, mice, peripherals, computer equipment, electronic computers, computer storage, computer terminals
Building/Industrial Automation
   Sensors: Position, elevator, temperature, fire, accelerometers, level, gas level, fluid level, light level, flow, gas flow, fluid flow, light flow, plasma flow, pressure, gas pressure, fluid pressure, motion, light, infrared light, ultraviolet light, X-rays, cosmic rays, visible light, gamma rays, chemical, stress, strain, depth, electrical characteristics, voltage, current, viscosity, acoustical, sound, listening, thickness, density, surface quality, volume, physical, mass, weight, force, conductivity, distance, orientation, vibration, radioactivity, field strength, electric field strength, magnetic field strength, occupancy, smoke detector, carbon monoxide detector, radon detector, air quality, humidity, glass breakage, break beam detector
   Controls: Position, elevator, temperature, fire, accelerometers, level, gas level, fluid level, light level, flow, gas flow, fluid flow, light flow, plasma flow, pressure, gas pressure, fluid pressure, motion, light, infrared light, ultraviolet light, X-rays, cosmic rays, visible light, gamma rays, chemical, stress, strain, depth, electrical characteristics, voltage, current, viscosity, acoustical, sound, listening, thickness, density, surface quality, volume, physical, mass, weight, force, conductivity, distance, orientation, vibration, radioactivity, field strength, electric field strength, magnetic field strength, occupancy, smoke detector, carbon monoxide detector, radon detector, air quality, humidity
   Devices: Thermostats, light switches, door locks, smart-card door locks, lighting, emergency lighting, motion lighting, safety lighting, highway lighting, construction lighting, sign lighting, roadway sign lighting, construction sign lighting, automatic flushing units, automatic soap dispenser, automatic paper towel dispenser, automatic faucets, automatic door sensors, identification reader, fingerprint reader, credit card readers, card readers, valve actuators, gauges, analog gauges, digital gauges, fire extinguishers, wireless switches, remotely operated inspection equipment, gas/oil pipeline monitoring systems, robotic pipeline inspection gauges, “auto-reclosers” for electric power lines, sonar buoys, telemetry systems, electronic record tracking systems, robbery tracking devices, interrogators, programmers, emergency exit alarms, alarms, flood alarms, gas alarms, electronic entry systems, security keypads, silo transducers, data recorders, signal tracers, anti-static strap testers, radiosonde weather balloons, utilities load controllers, profilometers, noise cancellation equipment, infrared beacons
Military/Government
   Tracking tags: Weapons, vehicle, soldier, gear/assets, staff, general population, security access badges
   Sensors: Proximity, intrusion, environmental, chemical/biological
   Equipment: Battery charger, surveillance, card readers, identification reader, fingerprint reader, retinal scanners, satellites, rockets, space vehicles, search and rescue transponders (SARTs), emergency position-indicating rescue beacons (EPIRBs), emergency locator transmitters (ELTs), military radios, electronic toll collection systems, postal tracking systems, communications, thermal imaging, night vision, training targets, field medical equipment, house arrest monitors, laser tags, electronic parking meters, multiple integrated laser engagement system, munitions and mines, ship sensors
Utility
   Gas consumption meters, water consumption meters, and electric consumption meters
Logistics & Supply Chain Management
   Radio-frequency identification devices (RFID), RFID readers
   Tracking: Asset tags, cargo container location beacons, transponders, transceivers
   Devices: Smart price tags, smart shelving, handheld barcode scanner, barcode scanners, credit card readers, card readers, retail signage, hotel door locks
Homeland Security
   Sensors: Occupancy, proximity, environmental, chemical/biological, motion, position
   Metal detector wand
Medical
Implantable: cochlear implants, neural stimulators, pace makers, medication administration, defibrillator
   Body function monitors: pressure, temperature, respiration, blood oxygenation, insulin, hearing aid, pulse, EKG, heart, Holter,
   Tracking tags: Patient, baby identification, assets, supplies, staff, medication, instruments
   Devices: Home healthcare equipment, ambulatory infusion pumps, blood analyzers, biofeedback systems, bone growth stimulators, thermometers, digital thermometers, stimulators, galvanic stimulators, muscle stimulators, pediatric scales
Agriculture—livestock tracking and asset tracking.
   Tracking: livestock, asset, wildlife tracking devices
   Equipment: cattle prods
Automotive
   Automotive antennas, Automotive Audio Systems, Automotive Lighting, Automotive Video Systems, Computers, Processors, Controls, Switches, Electric Motors, Actuators, Ignition Systems, Starter Systems, Injection Systems, Powertrain Electronics, Radar Detectors, Proximity Detectors, Safety Systems, Security Systems, Sensors, Regulators, Distributors, Vehicle Control, Wiper Systems, Washer Systems, Radio, Video Systems, Entertainment Systems, Navigation Systems, GPS systems, Power Mirror Systems, Emission control systems
Appliances
   Monitoring systems and control systems for major and small appliances including washing machines, dryers, refrigerators, freezers, coolers, air conditioners, humidifiers, dehumidifiers, air purifiers, air filters, fans, furnaces, water heaters, boilers, space heaters, sowing machines, ice makers, microwave ovens, convection ovens, ovens, toaster ovens, ranges, range hoods, cooktops, stoves, stovetops, crock pots, hot plates, dishwashers, garbage disposals, can openers, vacuum cleaners, blenders, mixers, food processors, irons, coffee makers, toasters, grills, hair dryers, electric tooth brushes, electric razors, electric drills, electric screwdrivers, chainsaws, lawnmowers, push mowers, riding mowers, trimmers, brush cutters, pruners, edgers, vending machines
Ventilation, Heating, Air-Conditioning, and Commercial Refrigeration Equipment
   Monitoring systems, control systems
Engine, Turbine, and Power Transmission Equipment
Monitoring systems, control systems
Other General Purpose Machinery Manufacturing
   Monitoring systems, control systems
Telecommunications
   Monitoring systems, control systems
   Portable
Aircraft
   Monitoring systems, control systems, actuator systems, sensors

It should be noted that devices within a specific category may be applicable across multiple areas even if they are not specifically listed. (e.g. temperature sensors apply to Industrial and Building Automation).

To retrofit or redesign the devices listed, it is possible to implement the described systems in numerous ways. It may be advantageous to leave the device design as is including the existing power supply. As an example, a device may use non-rechargeable batteries to operate. The device will most likely have a protection circuit to prevent damage if the batteries are installed incorrectly. The protection mechanism is commonly a diode inline with the positive terminal of the battery. In this case, the RF Power Harvesting Source with or without an Alternative power source 24 could be inserted, with an antenna, into the device. The power generated by the RF Power Harvesting Source (and alternative power source 24, if applicable) could be connected to the device after the protection mechanism described to avoid potential charging of a non-rechargeable battery.

Another way to configure the system is to replace the non-rechargeable batteries with rechargeable batteries. In this instance, the output from the RF Power Harvesting Source (and alternative power source 24) could be connected to either side of the protections device. If the connection is before the protection mechanism, the system will recharge the battery and supply power to the device. If the connection is after the protection mechanism, the system will supply power to the device and battery will supply any extra power needed that could not be supplied by the system. It should be noted that the protection device in this case is unneeded for proper operation. Its only function would be to protect the batteries from being installed incorrectly. An antenna could be contained inside or placed on the outside of the device.

Another configuration of the system is to remove the existing batteries and install the RF Power Harvesting Source (and alternative power source 24) in the enclosure provided for the batteries. An antenna could be contained inside or placed on the outside of the device.

Yet another method of configuring the system would be to reduce the number of batteries and replace them with the RF Power Harvesting Source (and alternative power source 24). In this case, the output from the system would be connected to the batteries in series or parallel depending on the original battery configuration. An antenna could be contained inside or placed on the outside of the device.

An additional option, would be to completely redesign the product and integrate the require circuitry and storage components into the device. This method is probably the most advantageous because it can fully take advantage of the benefits offered by the RF Power Harvesting Source (and alternative power source 24). An antenna could be contained inside or placed on the outside of the device.

If the RF Power Harvesting Source (and alternative power source 24) is used as a backup to the primary power supply, a switch could be implemented into the system in order to switch the RF Power Harvesting Source (and alternative power source 24) in when the primary source is lost. In this case, an antenna could be contained inside or placed on the outside of the device.

To show the flexibility of RF energy harvesting, several products were retrofitted to include RF energy harvesting circuitry. These products include a wireless keyboard, a wall clock, and a desk calculator.

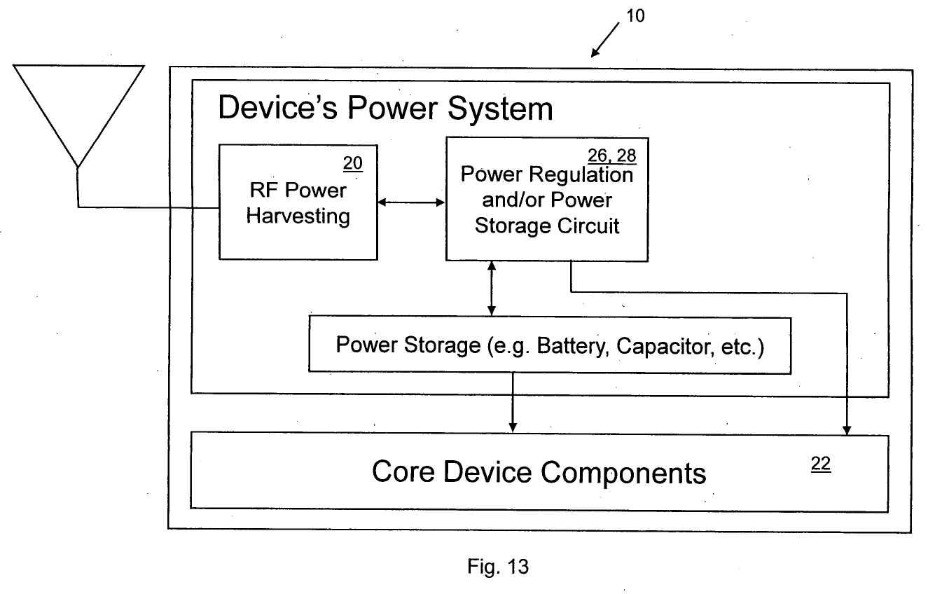

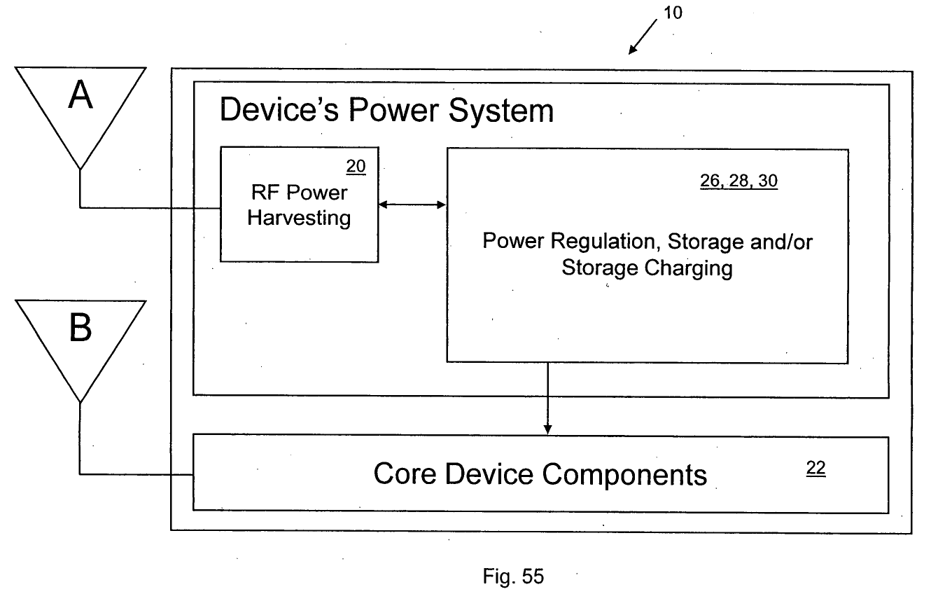

The wireless keyboard is an example of recharging and augmenting a battery to supply power to a device. This system is shown in FIG. 13. The output from the regulation circuitry recharges the battery and supplies power to the keyboard. The battery is also used to supply power to the keyboard. The keyboard also includes a separate antenna for receiving power and for data communications. The antenna configuration can be seen in FIG. 55.

The wall clock is an example of a direct powering system. The wall clock was retrofitted to include energy harvesting circuitry and the internal AA battery was removed. This system is shown in FIG. 2. The wall clock did not need regulation but did require a capacitor for storage to supply the pulse of power to move the second hand.

The calculator is an example of using RF energy harvesting with another energy harvesting technology. The calculator had an internal 1.5V coin cell battery and a small solar panel. The internal battery was removed, however, the solar panel was left intact. This system is shown in FIG. 60. In this system, the calculator can receive power from both the solar panel and the RF energy harvesting circuitry to eliminate the need for a battery.

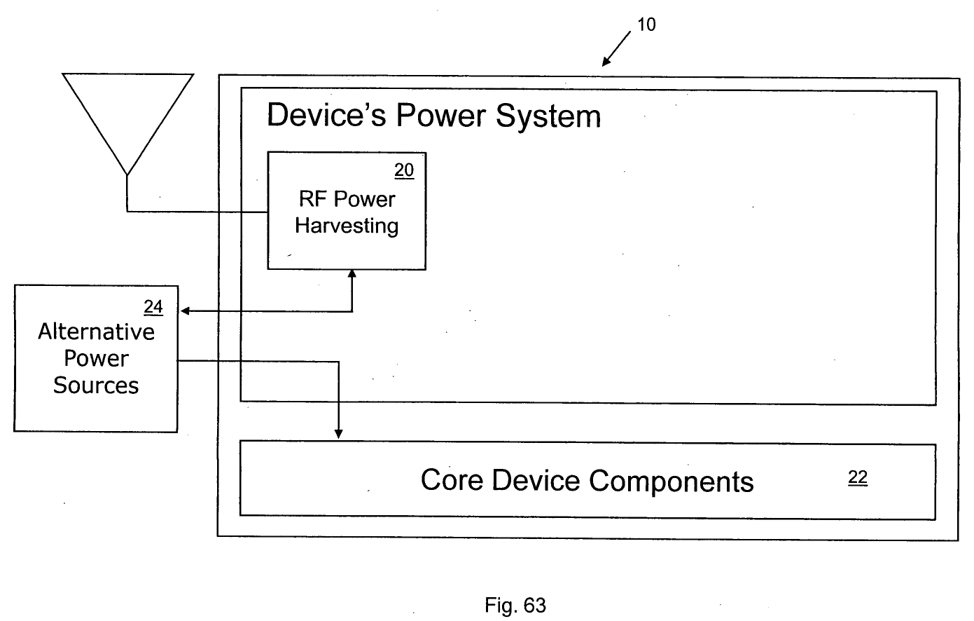

As an additional example, an RF energy harvesting circuit similar to the ones shown in U.S. Pat. No. 6,615,074 (FIGS. 8, 9, 12a, 12b, 13, 14), incorporated by reference, herein, was connected in series with a 0.5V solar cell. Individually, the solar cell was able to provide 0.480V to a 10 kilo-ohm resistor, which was being used to simulate the Core Device 22 Components. This corresponds to 23 microwatts. The RF power harvesting circuit by itself was able to provide 2.093V across the 10 kilo-ohm resistor when being supplied by 1 milliwatt of RF power. This corresponds to 438 microwatts. The two circuit outputs were then combined in series by connecting the output from the RF energy harvesting circuit to the ground of the solar cell. The output of the solar cell was then connected to the resistor. The other end of the resistor was connected to the ground of the RF energy harvesting circuit. The voltage across the resistor with the circuits connected, as shown in FIG. 63, was 2.445V. This corresponds to 598 microwatts. As can be seen, the combination of the two technologies produces a result higher than the addition of the individual powers. From this, it can be determined that the two technologies can cooperate in a way that produces favorable results. In the example given, the solar cell produces current to supply the load and helps to bias the RF rectifying diodes, which allows the RF energy harvesting circuit to operate a higher efficiency. The solar cell also changes the impedance seen by the RF energy harvesting circuit, which produces a beneficial result. To be more specific, when examining the power output of the individual circuit (solar and RF power harvesting), the sum of the power captured by the individual circuits was 23 uW+438 uW=461 uW. However, when the two circuits are combined and are allowed to work in conjunction with one another, the output power becomes 598 uW. This results shows that combining the two power-harvesting technologies produces a 30 percent increase in the output power for this example. This same technique can be applied to multiple energy harvesting technologies to produce even greater output power. The equations for this example are shown below.

Individual Circuits

P_{I}=P₁+P₂+ . . . +P_{N}

Combined Circuits

P_{C}>P_{I}=P₁+P₂+ . . . +P_{N}

where P_{I} is the sum of the individual output powers
P_{C} is the output of the combined circuit
P₁ is the output power from the first power harvesting technology
P₂ is the output power from the second power harvesting technology
P_{N} is the output power from the Nth power harvesting technology
N is the number of power harvesting technologies or circuits

The present invention pertains to a device 36 for receiving wireless power. The device 36 comprises a point of reception, wherein the point of reception is positionable in at least a first position 40 and a second position 42.

The present invention pertains to a method for receiving wireless power. The method comprises the steps of positioning a point of reception in contact with a housing 46 to a first position 40. There is the step of receiving wireless power at the point of reception and providing it to a power harvester 20 in the housing 46. There is the step of converting the wireless power to usable DC with the power harvester 20. There is the step of providing the usable DC to core components 48 in the housing 46. There is the step of using the DC by the core components 48. There is the step of repositioning the point of reception to a second position 42. There is the step of receiving wireless power at the point of reception at the second position 42 and providing it to the power harvester 20. There is the step of converting the wireless power received by the point of reception in the second position 42 to usable DC with the power harvester 20. There is the step of providing the usable DC to the core component in the housing 46. There is the step of using the DC by the core components 48.

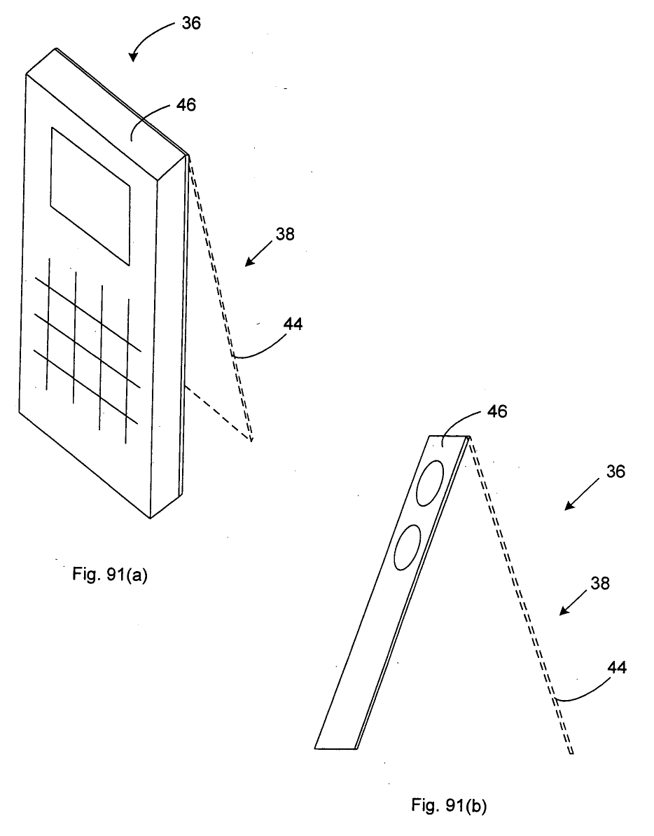

Another example of a product that was retrofitted to include RF energy harvesting circuitry was a cell phone. The cell phone is an example of recharging and augmenting a battery to supply power to a device. This system is shown in FIGS. 91-96.

The cell phone is one example from a family of similar products, including, personal digital assistants, MP3 players, etc. Any of these devices may be configured to receive wireless power with or without communications data. The device includes a point of reception which receives the wireless power. For example, the point of reception may be an antenna. The point of reception is connected to the power harvester.

The point of reception is positionable in at least two positions: a first position and a second position. The first and second positions are designed such that in the first position, the cell phone is in normal operation and in the second position, the cell phone is capable of efficiently being charged/recharged.

The first and second positions may also be designed such that reception at each position may vary depending on the location of the device. Preferably, either the first position or the second position of the point of reception will provide better reception of the wireless power for a given location of the device (e.g., for charging and use, or for optimal charging).

Some or all of the positions may be applicable to a given embodiment of a cell phone or other device. In other words, various permutations of positions for the point of reception may be desirable and designed into the device. Additionally, the positions may be “infinite” in that the point of reception may be positioned anywhere desired as allowed by the particular design. Any mechanism for attaching the point of reception to the device is contemplated as is dictated by the particular application. For example, the mechanism may be a hinge (single pin, dual pin), a ball and socket joint, etc.

The device may include a stop mechanism configured to assist in positioning the point of reception in a desired position. The stop mechanism may be integral with the housing, the point of reception, or both. As an example, the point of reception may be an antenna that is contained in an antenna housing, for example, a plastic housing. The antenna housing may have a ridge that fits into one or more notches formed on the housing or device as the antenna housing moves with respect to the notched part of the housing or the device.

The point of reception may be designed into the device or connectable to the communications port of the device.

The device may include a communications antenna. The point of reception and the communications antenna may be co-located in an area of the device.

The device may have a single antenna configured to act as both a point of reception for wireless power and a communications antenna. A filter separates the received wireless power and the received communications data. A rectifier (i.e., the power harvester) converts the wireless power to a form usable by the device, such as DC.

The device may be configured such that the device automatically determines when it needs to be charged. At such time, the device sends a message to a wireless power transmitter indicating that the device needs to be charged by having the wireless power transmitter send wireless power to the device. The message may be sent using any means capable of indicating that the device needs to be charged, such as RF or infrared. The wireless power transmitter receives the message and begins to send wireless power to the device.

The wireless power transmitter may or may not stop sending power depending on the application. When the device is fully charged, the device may send a message to the wireless power transmitter to indicate that it no longer needs power. The wireless power transmitter may stop sending wireless power or continue to send a lower power level to supply operation current or to keep the battery or batteries charged while they are being drained by active, sleep, or leakage currents. Alternatively, the wireless power transmitter may send wireless power for a predetermined amount of time. If multiple devices are present, the wireless power transmitter may continue to send power even if one device has fully charged.

The wireless power transmitter may require periodic indications from the device that the device is still present in order to continue sending power. This would help to avoid sending power if the device is moved mid-way through charging, that is, if no device is present to receive the wireless power.

The device may indicate power requirements or battery size to set wireless power transmitter output power level. If multiple devices are present, the highest power level may be chosen.

If multiple wireless power transmitters are involved, the wireless power transmitters may communicate with each other to coordinate power transfer.

The device may send charging status information to the wireless power transmitter or other data device, such as a computer.

The device preferably includes a housing having a front, a back, a side, and an end. The point of reception is connected to the housing.

The point of reception may be pivotally connected to the housing, for example, at the end or the side of the housing. For example, referring to FIG. 91, a cell phone may have an antenna that pivots from a first position substantially juxtaposed to the housing of the cell phone to a second position at an angle to the housing. In the second position, the antenna may be used to support the cell phone in an upright position, as shown.

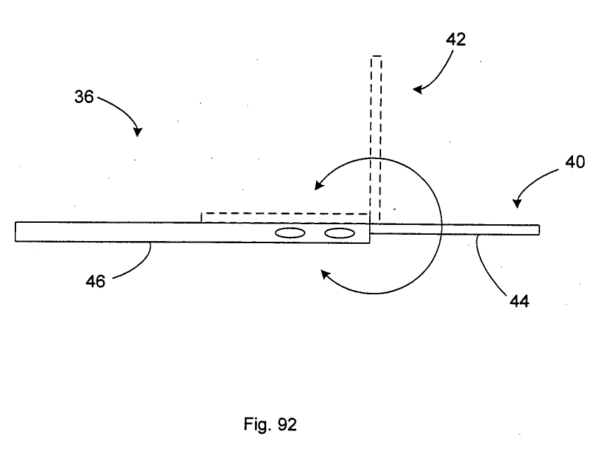

Expanding on the example shown in FIG. 91 and referring to FIG. 92, the antenna may pivot to a third position substantially extending parallel from the back of the housing. The antenna may further pivot to a fourth position substantially at a right angle to the front of the housing. The antenna may further rotate to a fifth position substantially juxtaposed to the front of the housing (for example, to protect a screen and other elements of the device).

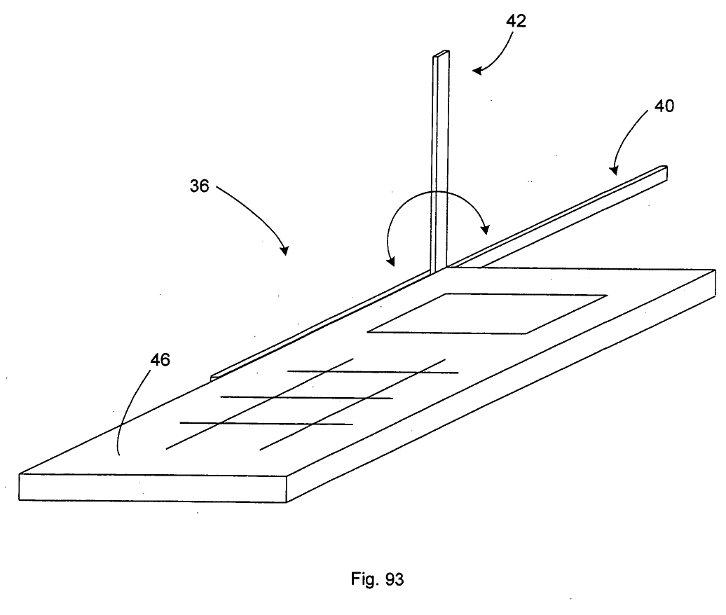

For another example, referring to FIG. 93, the antenna may pivot from a first position substantially juxtaposed to the side of the housing to a second position substantially at a right angle to the side of the housing. The antenna may further rotate to a third position substantially extending parallel to the side of the housing.

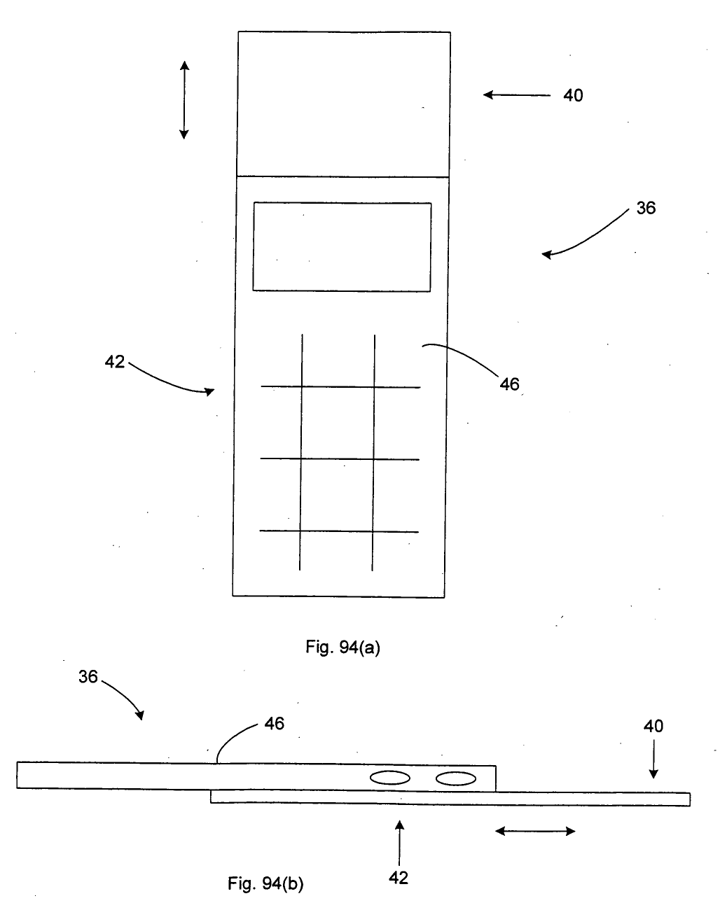

The point of reception may be slideably connected to the housing, for example, at the back, the side, or the front of the housing. For example, referring to FIG. 94, the cell phone may have an antenna that slides from a first position substantially juxtaposed to the back of the housing to a second position substantially extending from the back of the housing. Similarly, the antenna may be slideably juxtaposed to the front of the housing (not shown).

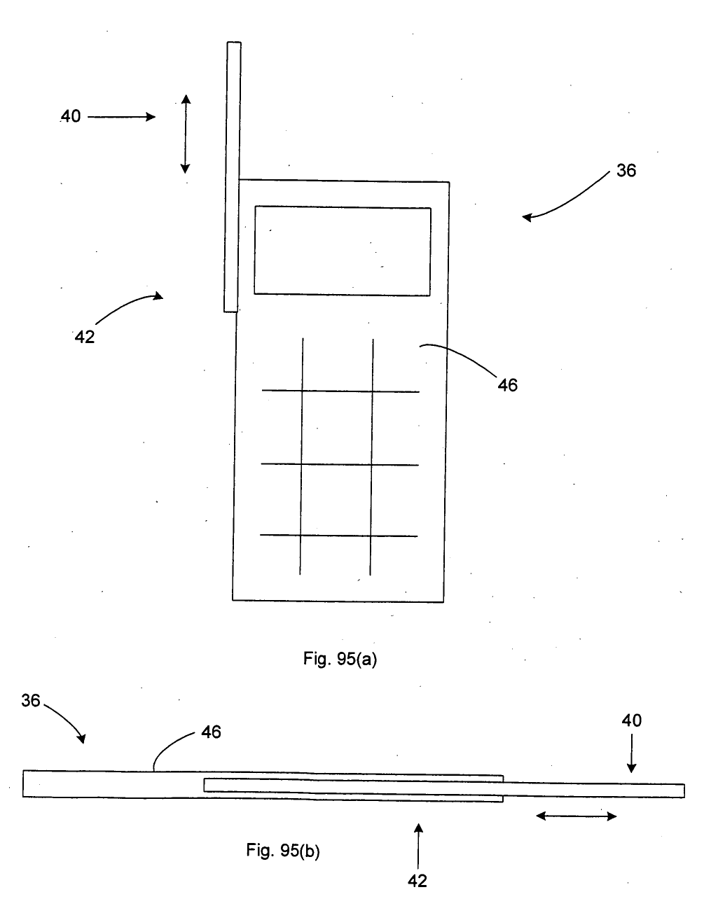

For another example, referring to FIG. 95, the antenna may slide from a first position substantially juxtaposed to the side of the housing to a second position substantially extending parallel from the side of the housing.

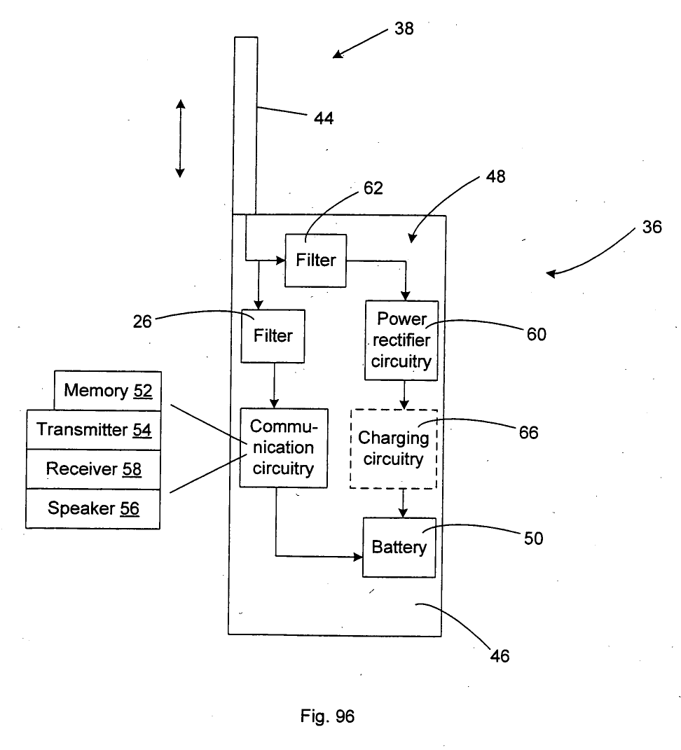

The point of reception may be retractably connected to the housing, for example, at the end of the housing. For example, referring to FIG. 96, the point of reception may be co-located or integral with a communications antenna, where the antenna(s) is retracted into the housing in the first position and pulls out of the housing into the second position.

Filters are used to separate the incoming power and communications signals and to route the separated signals to the appropriate circuitry. A first filter may be designed to pass the frequency(ies) of the power signal while having a high impedance for the frequency(ies) of the communications signal. A second filter may be designed to pass the frequency(ies) of the communications signal while having a high impedance for the frequency(ies) of the power signal. The output of the first filter may be supplied to the power rectification circuitry that converts the power to a usable form, such as DC. The output of the power rectification circuitry may or may not be connected to charging circuitry. The charging circuitry monitors and/or regulates the voltage and/or current supplied to the battery to ensure proper charging.

The point of reception may be rotatably connected to the housing, for example, at the end or the side of the housing. For example, a cell phone may have an antenna that rotates from a first position substantially extending parallel to the back of the housing of the cell phone to a second position substantially extending parallel to the back of the housing, but where a face of the antenna is in a different position than the face when in the first position.

It should be noted that any of the previous embodiments of the cell phone may include an indicator to inform the user of the charging status. The indicator may also inform the user of the amount of wireless power being received. The indicator could then not only be used to position the device to achieve the desired charging rate, but also to position the antenna to achieve the desired charging rate. Examples of indicators include LEDs, LCDs, or other indicating components.

It should be noted that any of the previous embodiments of the cell phone may have the point of reception achieved by a user (for example, manually sliding the point of reception with respect to the housing) or automatically (for example, via spring loading).

A cell phone charger/recharger was designed to retrofit the SLVR cell phone from Motorola. The device was constructed as shown in FIGS. 91(a) and (b). The back cover (housing) of the cell phone was removed and replaced with a specially designed cover (housing) that included a hinge at the top just below the lens of the camera portion of the phone.

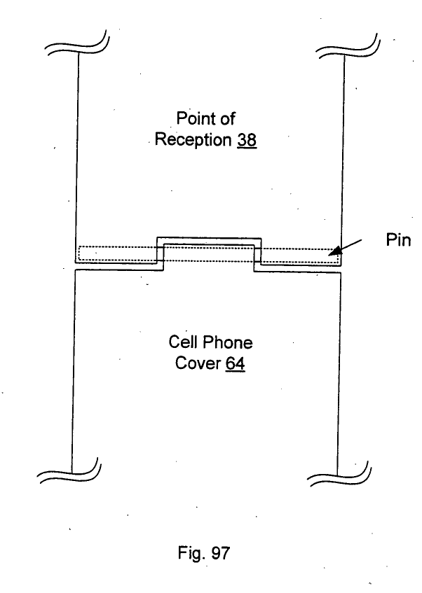

The point of reception was designed to angle away from the cell phone using a pin hinge (FIG. 97) in order to maximize the power transfer for the application. When angled away from the cell phone, the point of reception (implemented in this example as a patch antenna designed on Rogers 4003 material) acted as an antenna and as a support for the phone. The patch antenna was probe fed with the rectification circuitry being located near the middle of the antenna behind the ground plane. The patch antenna was designed to receive the maximum amount of energy when vertically polarized and the back of the cell phone point toward the source.

The rectification circuitry used was disclosed in U.S. patent application Ser. No. 11/584,983 filed Oct. 23, 2006, incorporated herein by reference. The output of the rectifier was connected to a charging circuit used to ensure that the battery contained within the cell phone was not over charged in terms of voltage or current.

The charging circuit was also connected to an indicator to show the user that the phone was charging. The indicator could also be used to show the charging status such as fully charged. The retrofitted cell phone used an LED as the indicator to show whether or not the cell phone was charging.

The output of the charging circuit was connected to the battery of the cell phone using a flexible printed circuit board (flex PCB), although a ribbon cable or other similar mechanism may be used. The flex PCB was thin enough to run under the back cover of the cell phone from the battery to a small notch where the flex PCB exited the cell phone and was connected to the charging circuit on the back of the antenna.

The antenna, rectifier, and charging circuit were encased in a plastic enclosure. The enclosure was connected to the hinge that also connected to the specially designed back cover. The hinge was designed to be resistive in order to allow the user to increase the angle between the phone and the antenna to a desired position without the need for a stopping mechanism, such as grooves.

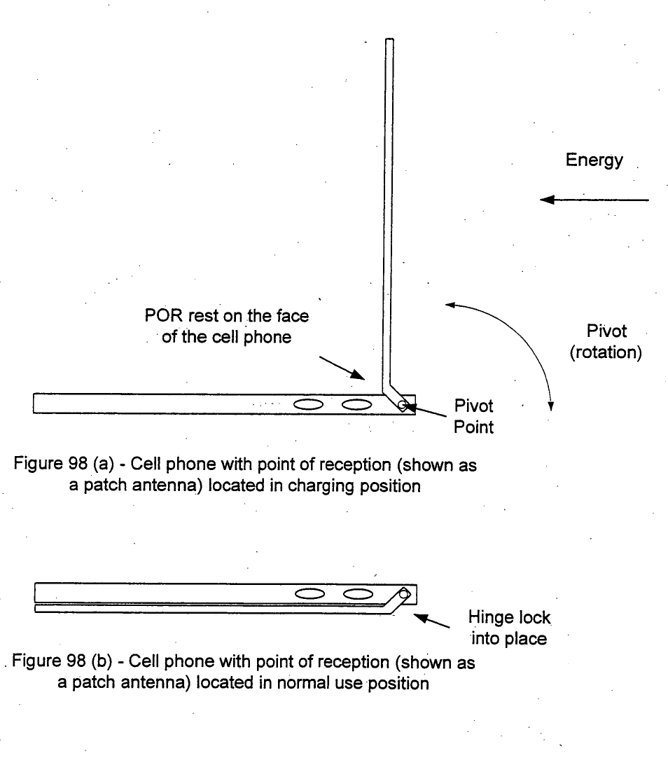

A cell phone charger/recharger was also designed as described in the previous example, but using the design shown in FIG. 92. The point of reception (implemented using a patch antenna designed on Rogers 4003 material) was designed to be positioned by the user on the back of the cell phone during normal cell phone use and located perpendicular to the front (face) of the cell phone for recharging as shown in FIG. 98.

The patch antenna was probe fed with the rectification circuitry being located near the middle of the antenna behind the ground plane. The patch antenna was designed to receive the maximum amount of energy when vertically polarized and positioned perpendicular to the face of the phone with the top of the phone pointed toward the source.

The rectification circuitry used was disclosed in U.S. patent application Ser. No. 11/584,983 filed Oct. 23, 2006, incorporated by reference herein. The output of the rectifier was connected to a charging circuit used to ensure that the battery contained within the cell phone was not over charged in terms of voltage or current.

The charging circuit was also connected to an indicator to show the user that the phone was charging. The indicator could also be used to show the charging status such as fully charged. The retrofitted cell phone used an LED as the indicator to show whether or not the cell phone was charging.

The output of the charging circuit was connected to the battery of the cell phone using a flexible printed circuit board (flex PCB) although a ribbon cable or similar mechanism could be used. The flex PCB was thin enough to run under the back cover of the cell phone from the battery to a small notch where the flex PCB exited the cell phone and was connected the charging circuit on the back of the antenna.

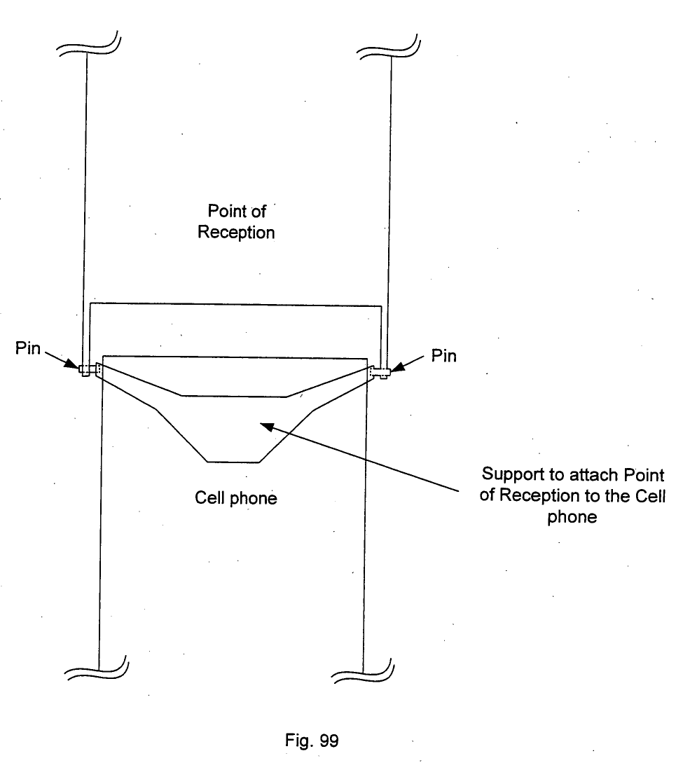

The point of reception was designed to swing from the back of the cell phone to a position perpendicular to the face of the phone using two pin hinges located along the sides of the phone (shown in FIG. 99) in order to maximize the power transfer for the application. If found to be advantageous, the electrical connection from the cell phone battery to the output of the charging circuit could be made through the hinges of the device. As an example, each pin hinge could be made with a metal pin where the right pin was connected to the positive connection of the battery and charging circuit and the left pin was connected to the negative connection of the battery and charging circuit.

It should be noted that in both of the previous examples, the wireless charger/recharger was designed to retrofit an existing cell phone. It is also possible to design the device into the cell phone.

As can be seen by the previous examples, RF energy harvesting can be used alone or in conjunction with alternative power sources 24 to power a wide range of devices. The addition of RF energy harvesting technology to the device allows for increased battery life, increased functionality, or the removal of the primary battery.

For purposes herein the following definition is applicable. A portable electronic device is defined to be less than about 25 pounds and preferably less than about 5 pounds in weight. It can be carried by one person either with or without some type of strap and preferably with only one arm or hand of the person. It has a device or circuitry that is powered by electricity.

Besides the various applications listed above, the RF energy harvesting can be used with any device requiring an antenna, although an antenna is necessarily needed in all embodiments, and includes radios and walkie talkies, besides cell phones, PDAs and MP3 players, to mention but a few of the many possible electronic devices.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A device for receiving wireless power, comprising:
a point of reception, wherein the point of reception is positionable in at least a first position and a second position.

2. The device as described in claim 1, wherein when the device is in a first location, when the point of reception is in the first position, the point of reception receives better reception than when in the second position.

3. The device as described in claim 2, wherein when the device is in a second location, when the point of reception is in the second position, the point of reception receives better reception than when in the first position.

4. The device as described in claim 1, wherein the point of reception is an antenna.

5. The device as described in claim 1, further including a communications antenna.

6. The device as described in claim 5, wherein the point of reception is co-located with the communications antenna.

7. The device as described in claim 1, wherein the point of reception is connected to a communications port of the device.

8. The device as described in claim 1, wherein the device includes a housing.

9. The device as described in claim 8, wherein the point of reception is connected to the housing.

10. The device as described in claim 9, wherein the point of reception is pivotally connected to the housing.

11. The device as described in claim 10, wherein the point of reception is connected to an end of the housing.

12. The device as described in claim 10, wherein the point of reception is connected to a side of the housing.

13. The device as described in claim 9, wherein the point of reception is slideably connected to the housing.

14. The device as described in claim 13, wherein the point of reception is connected to a back of the housing.

15. The device as described in claim 13, wherein the point of reception is connected to a side of the housing.

16. The device as described in claim 9, wherein the point of reception is retractably connected to the housing.

17. The device as described in claim 16, wherein the point of reception is connected to an end of the housing.

18. The device as described in claim 9, further including a stop mechanism configured to position the point of reception.

19. The device as described in claim 9, wherein the point of reception is rotatably connected to the housing.

20. The device as described in claim 1 including a power harvester for converting wireless energy into usable DC, and core components in electrical communication with the power harvester to receive the DC to power the core components.

21. The device as described in claim 20, further including an alternative power source connected to the core components to power the core components in conjunction with the power harvester.

22. The device as described in claim 20, further including a power regulator and/or power storage circuit connected to the power harvester.

23. The device as described in claim 20, further including a power storage charger connected to the power harvester.

24. The device as described in claim 20, further including power storage connected to the power harvester.

25. The device as described in claim 20, wherein the core components include a memory connected to an integrated circuit and to the power harvester to power memory.

26. The device as described in claim 20 wherein the core components includes a transmitter.

27. The device as described in claim 26 wherein the core components include a speaker.

28. The device as described in claim 27 wherein the core components include a receiver for receiving spoken words and converting the words into signals to be transmitted by the transmitter.

29. A device for receiving wireless power and communications data, comprising:
an antenna configured to receive wireless power and communications data;
a filter to separate the wireless power and the communications data; and
a rectifier to convert the wireless power into a usable form.

30. A method for receiving wireless power comprising the steps of:
positioning a point of reception in contact with a housing to a first position;
receiving wireless power at the point of reception and providing it to a power harvester in the housing;
converting the wireless power to usable DC with the power harvester;
providing the usable DC to core components in the housing;
using the DC by the core components;
repositioning the point of reception to a second position;
receiving wireless power at the point of reception at the second position and providing it to the power harvester;
converting the wireless power received by the point of reception in the second position to usable DC with the power harvester;
providing the usable DC to the core components in the housing; and
using the DC by the core components.
